(19) United States
(12) Patent Application Publication
(10) Pub. No.: US 2024/0058818 A1
(43) Pub. Date: Feb. 22, 2024

(54) CHEMICAL PROCESSING SYSTEM AND INSTRUMENT

(71) Applicant: INVIVOSCRIBE INC., San Diego, CA (US)

(72) Inventors: Jeffrey Edward MILLER, Del Mar, CA (US); Martin Anthony MOTTRAM, Melbourn (GB); Balazs KISS, Melbourn (GB); Andrew James MALLOY, Melbourn (GB); Paul Malcolm CRISP, Melbourn (GB); Peter Lee CROSSLEY, Melbourn (GB); Lauren Victoria Elizabeth LAING, Melbourn (GB); Alexander Robert MACLACHLAN, Melbourn (GB)

(21) Appl. No.: 18/269,253

(22) PCT Filed: Dec. 23, 2021
(86) PCT No.: PCT/US2021/065044

§ 371 Date: Jun. 22, 2023

Related U.S. Application Data
(60) Provisional application No. 63/130,450, filed on Dec. 24, 2020.
(60) Provisional application No. 63/241,167, filed on Sep. 7, 2021.
(60) Provisional application No. 63/292,314, filed on Dec. 21, 2021.

(51) Int. Cl. B01L 3/00

(52) U.S. Cl. CPC B01L 3/50273; B01L 3/523; B01L 3/527; B01L 2200/0605; B01L 2200/146; B01L 2300/1827; B01L 2400/0487

(57) ABSTRACT

Described embodiments relate to a chemical processing instrument configured to receive one or more sample cartridges, to process one or more corresponding fluid samples. The chemical processing instrument comprises: a reagent dispenser configured to dispense one or more fluid reagents into a reagent vessel via an open top of the reagent vessel; and a pneumatic module configured to connect to a primary pneumatic port of a primary reaction vessel and selectively adjust a pressure within the primary reaction vessel when the lid is closed to draw fluid from the reagent vessel through a primary reagent channel into the primary reaction vessel.

### CROSS-REFERENCE TO RELATED APPLICATIONS

This application claims priority from the following priority applications, the entire contents of which are incorporated herein by reference: U.S. Provisional Patent Application 63/130,450, filed on Dec. 24, 2020; U.S. Provisional Patent Application 63/241,167, filed Sep. 7, 2021; and U.S. Provisional Patent Application 63/292,314, filed Dec. 21, 2021.

### TECHNICAL FIELD

Embodiments generally relate to systems, instruments, methods and computer-readable media for performing operations on samples, such as nucleic acid extraction operations and the like, as well as sample cartridges for use with a chemical processing instrument.

### BACKGROUND

State-of-the-art automated machines and instruments for performing nucleic acid extraction operations and the like tend to be capable of receiving and processing low volumes of sample input, usually less than 1 ml and typically around 200 ul. However, there are times when it is desirable to extract nucleic acid from a much larger input sample in order to output enough genetic material to carry out downstream processing.

Furthermore, in standard high-throughput labs using well plates and large automated liquid handling robots, large volume samples typically need to be aliquoted into smaller volumes for automated processing, which is inefficient for machine usage. A typical machine may have many channels, each able to take a small sample, but aliquoting will lead to fewer patients occupying the run-time of a machine.

A further common issue with known automated machines is contamination. The risk of this is increased wherever a vessel containing patient derived material is open within the machine, a moving pipettor is used and/or whenever materials that have contacted patient derived material are stored within an instrument (e.g., pipette tips)

A further issue with known automated machines is the difficulty in achieving sufficient control of the end-to-end process to ensure highest quality.

Yet a further issue is achieving adequately concentrated and/or quantified nucleic acids from the extraction workflow to be inputted directly into the downstream assay. Applications such as MRD typically require highly concentrated DNA (˜500 ng/μL) which is rarely achieved using the available instrumentation for nucleic acid extraction. In addition, most existing systems aimed at automating cell free DNA (cfDNA) extractions do not select for a certain size of nucleic acid. cfDNA is typically ˜150 bp, and downstream assays are negatively impacted by the presence of genomic DNA (gDNA) contamination in cfDNA samples.

It is desired to address or ameliorate one or more shortcomings or disadvantages associated with prior art to systems, instruments, methods and computer-readable media for performing operations on samples, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a sample cartridge for a chemical processing instrument, the sample cartridge comprising: a primary reaction vessel configured to accommodate a fluid sample for processing and configured to receive a lid for closing an open top of the primary reaction vessel; a reagent vessel configured to receive one or more fluid reagents via an open top of the reagent vessel, the reagent vessel being connected to the primary reaction vessel via a primary reagent channel with a primary reagent valve disposed in the primary reagent channel to control fluid flow through the primary reagent channel; and a primary pneumatic port in fluid communication with the primary reaction vessel and configured to be connected to a pneumatic module to selectively adjust a pressure within the primary reaction vessel when the lid is closed to draw the fluid contents of the reagent vessel into the primary reaction vessel.

The sample cartridge may further comprise a primary pneumatic channel extending between the primary pneumatic port and the primary reaction vessel, wherein an opening of the primary pneumatic channel into the primary reaction vessel is located part way up a sidewall of the primary reaction vessel. The opening of the primary pneumatic port into the primary reaction vessel may be located nearer to the top of the primary reaction vessel than the bottom of the primary reaction vessel. In some embodiments, an opening of the primary reagent channel into the primary reaction vessel is located part way up a sidewall of the primary reaction vessel. In some embodiments, the opening of the primary reagent channel into the primary reaction vessel is located nearer to the top of the primary reaction vessel than to the bottom of the primary reaction vessel.

In some embodiments, the sample cartridge may further comprise a liquid trap configured to restrict the passage of liquids out of the sample cartridge. The liquid trap may be disposed within or at one end of the primary pneumatic channel, for example. The liquid trap may be disposed at or in a base of the sample cartridge. The liquid trap may comprise a gas permeable membrane. The liquid trap may comprise a hydrophobic polymer material which can act as a gas permeable or semi-permeable membrane. The liquid trap may be configured to accommodate a minimum volume of liquid before becoming blocked or overflowing. The minimum liquid capacity volume of the liquid trap may be in the range of 1 μL to 1000 μL, 10 μL to 100 μL, 40 μL to 80 μL, or 50 μL to 60 μL, for example.

In some embodiments, the sample cartridge further comprises an output vessel configured to receive a final output fluid from the primary reaction vessel via a final output channel. The sample cartridge may further comprise an output vessel pneumatic port in communication with the output vessel via an output vessel pneumatic channel and configured to be connected to a pneumatic module to selectively adjust the pressure in the output vessel to draw the final output fluid into the output vessel from the primary reaction vessel via the final output channel. The sample cartridge may further comprise a temporary lid configured to close the output vessel during processing, the temporary lid being connected to and defining openings for the final output channel and output vessel pneumatic channel into the output vessel.

In some embodiments, the sample cartridge further comprises: a quality control vessel configured to receive an aliquot of the output fluid for quality control analysis; a quality control channel extending between the quality control vessel and a quality control junction with the final output channel; and a quality control pneumatic port in fluid communication with the quality control vessel and configured to be connected to a pneumatic module to selectively adjust a pressure within the quality control vessel to draw the aliquot of final output fluid from the final output channel through the quality control channel and into the quality control vessel. The quality control vessel may be preloaded with a dye to be mixed with the aliquot of final output fluid for quality control analysis.

The sample cartridge may further comprise a buffer solution vessel configured to receive a buffer solution through an open top of the buffer solution vessel for mixing with the final output fluid for quality control analysis; a buffer channel extending between the buffer solution channel and a buffer junction with the final output channel between the quality control junction and the primary reaction vessel; and a buffer channel valve disposed in the buffer channel to control flow of the buffer solution through the buffer channel.

The sample cartridge may further comprise: an intermediate outlet from the final output channel between the quality control junction and the output vessel; a sealed chamber into which the intermediate outlet opens; an air-permeable liquid barrier membrane covering the outlet; and an intermediate outlet pneumatic port in fluid communication with the sealed chamber and configured to be connected to a pneumatic module to selectively adjust a pressure within the sealed chamber to draw air through the air-permeable membrane from the final output channel.

In some embodiments, the sample cartridge further comprises a sealed waste vessel configured to receive waste fluid from the primary reaction vessel via a waste channel; and a waste pneumatic port in fluid communication with the waste vessel and configured to be connected to a pneumatic module to selectively adjust a pressure within the waste vessel to draw fluid from the primary reaction vessel through the waste channel and into the waste vessel.

In some embodiments, the sample cartridge further comprises a secondary reaction vessel configured to receive a primary output fluid from the primary reaction vessel via a primary output channel fluidly connecting the primary reaction vessel to the secondary reaction vessel, and configured to receive one or more fluid reagents from the reagent vessel via a secondary reagent channel fluidly connecting the reagent vessel to the secondary reaction vessel; a primary outlet valve disposed in the primary outlet channel to control flow through the primary outlet channel; and a secondary reagent valve disposed in the secondary reagent channel to control flow through the secondary reagent channel. The secondary reaction vessel may be sealed, and in some embodiments, the sample cartridge further comprises a secondary pneumatic port in fluid communication with the secondary reaction vessel and configured to be connected to a pneumatic module to selectively adjust a pressure in the secondary reaction vessel to draw fluid from the primary outlet channel or secondary reagent channel into the secondary reaction vessel. The sample cartridge may further comprise a secondary pneumatic channel extending between the secondary pneumatic port and the secondary reaction vessel, wherein an opening of the secondary pneumatic channel into the secondary reaction vessel is located part way up a sidewall of the secondary reaction vessel, nearer to a top of the secondary reaction vessel than a bottom of the secondary reaction vessel. An inlet or inlets of the primary output channel and secondary reagent channel may open into the secondary reaction vessel part way up a sidewall of the secondary reaction vessel, nearer to a top of the secondary reaction vessel than a bottom of the secondary reaction vessel.

Some embodiments relate to a chemical processing instrument configured to receive the sample cartridge according to any of the described embodiments, the instrument comprising: a reagent dispenser configured to dispense one or more fluid reagents into the reagent vessel via the open top of the reagent vessel; and a pneumatic module configured to connect to the primary pneumatic port of the primary reaction vessel and selectively adjust a pressure within the primary reaction vessel when the lid is closed to draw fluid from the reagent vessel through the primary reagent channel into the primary reaction vessel.

The reagent dispenser may comprise a reagent cartridge comprising a plurality of reagent reservoirs, each accommodating a volume of a reagent in fluid communication with a dispensing pump via one or more valves. The instrument may be configured to operate the one or more valves to connect a selected one of the reagent reservoirs to the pump, and operate the pump to dispense a selected volume of reagent from the selected reagent reservoir into the reagent vessel of the sample cartridge. The reagent cartridge may be removable from the dispensing pump and instrument to facilitate refilling or replacement of the reagent reservoirs.

In some embodiments, the instrument further comprises a heater mounted to a carriage assembly configured to selectively move the heater relatively close to the primary reaction vessel of the sample cartridge to heat a fluid sample in the primary reaction vessel and move the heater relatively further away from the sample cartridge when heating is not required.

The heater may comprise a radiator configured to pass through slots or apertures in the sample cartridge to partially surround the primary reaction vessel.

In some embodiments, the instrument further comprises a magnet mounted on the carriage and configured to be moved relatively closer to the primary reaction vessel of the sample cartridge to apply a magnetic field to the fluid sample in the primary reaction vessel and to be moved relatively further away from the sample cartridge when the magnetic field is not required.

The carriage may be configured to allow independent movement of the heater relative to the magnet to allow heating of the fluid sample without applying the magnetic field.

The heater may be mounted to the carriage via sprung rods to bias the heater away from the carriage in a disengaged position, as well as a first heater engagement position, and allow the heater to move relatively closer to the carriage and magnet when the carriage is moved to a magnet engagement position.

In some embodiments, the pneumatic module is configured to connect to a plurality of different pneumatic ports on each sample cartridge and apply a selected pressure level to each pneumatic port independently at selected times.

In some embodiments, the instrument further comprises an optics module configured to detect light transmitted from the fluid sample to determine a property of the fluid sample.

The pneumatic module may be further configured to connect to the output vessel pneumatic port and selectively adjust the pressure in the output vessel to draw the final output fluid into the output vessel from the primary reaction vessel via the final output channel. The pneumatic module may be further configured to connect to the quality control pneumatic port and selectively adjust a pressure within the quality control vessel to draw the aliquot of final output fluid from the final output channel through the quality control channel and into the quality control vessel. The reagent module may be configured to dispense buffer solution into the buffer solution vessel. The pneumatic module may be further configured to connect to the intermediate outlet pneumatic port and selectively adjust a pressure within the sealed chamber to draw air through the air-permeable membrane from the final output channel. The pneumatic module may be further configured to connect to the waste pneumatic port and selectively adjust a pressure within the waste vessel to draw fluid from the primary reaction vessel through the waste channel and into the waste vessel. The pneumatic module may be further configured to connect to the secondary pneumatic port and selectively adjust a pressure in the secondary reaction vessel to draw fluid from the primary outlet channel or secondary reagent channel into the secondary reaction vessel.

The pneumatic module may be configured to detect changes in pressure and/or flow rates in order to determine when liquid transfer operations are completed. For example, when the pressure is adjusted to draw liquid from one chamber to another, once all of the liquid has been drawn through the transfer channel, air will be drawn through following the liquid, which requires less pressure difference and thus has a higher flow rate. This change in pressure and/or flow rate may be detected by the pneumatic module and used as a signal to stop the pressure actuation when the transfer process is complete.

The pneumatic module may be configured to move liquids between the various vessels of the cartridge using positive pressure or negative pressure. That is, applying positive pressure (above atmospheric pressure) in one vessel to push liquid through the transfer channels into another vessel, or applying negative pressure (below atmospheric pressure) to one vessel to draw liquid through the transfer channels into another vessel.

In some embodiments, the pneumatic module may be configured to operate using a single pressure level selectively applied to the various pneumatic ports at different times to affect different operations. In some embodiments, the pneumatic module may be configured to operate using only two pressure levels selectively applied to the various pneumatic ports at different times to affect different operations.

In some embodiments, the instrument may further comprise an optics module configured to measure a property of an aliquot of output fluid accommodated in the quality control vessel.

The instrument may be configured to receive a plurality of ones of the sample cartridge. The pneumatic module may be configured to connect to all of the pneumatic ports of the plurality of sample cartridges selectively apply pressure to selected ones of the pneumatic ports at selected times. The reagent module is configured to dispense reagents into each of the plurality of sample cartridges at selected times.

In some embodiments, the instrument further comprises a mechanism and actuator configured to move the reagent module to various positions within the instrument, each position corresponding to a respective one of the plurality of sample cartridges, to allow the reagent module to dispense one or more reagents into each respective sample cartridge.

Some embodiments relate to a chemical processing instrument configured to receive one or more sample cartridges each containing a fluid sample for processing, each sample cartridge defining: a primary reaction vessel configured to accommodate a fluid sample for processing and configured to receive a lid for closing an open top of the primary reaction vessel; a reagent vessel configured to receive one or more fluid reagents via an open top of the reagent vessel, the reagent vessel being connected to the primary reaction vessel via a primary reagent channel with a reagent valve disposed in the reagent channel to control fluid flow through the primary reagent channel; and a pneumatic port in fluid communication with the primary reaction vessel; the chemical processing instrument comprising: a reagent dispenser configured to dispense one or more fluid reagents into the reagent vessel via the open top of the reagent vessel; and a pneumatic module configured to connect to the pneumatic port of the primary reaction vessel and selectively adjust a pressure within the primary reaction vessel when the lid is closed to draw the fluid contents of the reagent vessel into the primary reaction vessel.

Some embodiments relate to an instrument comprising one or more fixed sample cartridge sockets, each configured to receive a sample cartridge containing a fluid sample in a reaction vessel for processing. The instrument further comprises a heater mounted to a carriage assembly configured to selectively move the heater relatively close to the reaction vessel of the sample cartridge to heat a fluid sample in the reaction vessel and move the heater relatively further away from the sample cartridge when heating is not required.

The heater may comprise a radiator configured to pass through slots or apertures in the sample cartridge to partially surround the reaction vessel.

In some embodiments, the instrument further comprises a magnet mounted on the carriage and configured to be moved relatively closer to the reaction vessel of the sample cartridge to apply a magnetic field to the fluid sample in the reaction vessel and to be moved relatively further away from the sample cartridge when the magnetic field is not required.

The carriage may be configured to allow independent movement of the heater relative to the magnet to allow heating of the fluid sample without applying the magnetic field.

The heater may be mounted to the carriage via sprung rods to bias the heater away from the carriage in a disengaged position, as well as a first heater engagement position, and allow the heater to move relatively closer to the carriage and magnet when the carriage is moved to a magnet engagement position.

Some embodiments relate to a chemical processing system comprising: the instrument according to any one of the described embodiments; and one or more of the sample cartridges according to any one of the described embodiments.

Some embodiments relate to a chemical processing system comprising: one or more sample cartridges, each sample cartridge defining: a primary reaction vessel configured to accommodate a fluid sample for processing and configured to receive a lid for closing an open top of the primary reaction vessel; a reagent vessel configured to receive one or more fluid reagents via an open top of the reagent vessel, the reagent vessel being connected to the primary reaction vessel via a primary reagent channel with a reagent valve disposed in the reagent channel to control fluid flow through the primary reagent channel; and a pneumatic port in fluid communication with the primary reaction vessel; and a chemical processing instrument comprising: a reagent dispenser configured to dispense one or more fluid reagents into the reagent vessel via the open top of the reagent vessel; and a pneumatic module configured to connect to the pneumatic port of the primary reaction vessel and selectively adjust a pressure within the primary reaction vessel when the lid is closed to draw the fluid contents of the reagent vessel into the primary reaction vessel.

Some embodiments relate to a method of operation of the chemical processing instrument system, according to any one of the described embodiments, accommodating one or more of the sample cartridge, according to any one of the described embodiments, each containing a fluid sample in the primary reaction vessel, the method comprising: connecting the pneumatic module to the primary pneumatic port of the or each sample cartridge; operating the reagent module to dispense one or more reagents into the reagent vessel of the or each sample cartridge; operating the pneumatic module to reduce the pressure in the primary reaction vessel of the or each sample cartridge to draw the fluid contents of the corresponding reagent vessel through the or each primary reagent channel and into the primary reaction vessel of the or each sample cartridge.

The method may further comprise operating a shaker of the instrument to facilitate mixing of fluids in the primary reaction vessel of the or each sample cartridge. The method may further comprise operating a heater of the instrument to heat the primary reaction vessel of the or each sample cartridge to a predetermined temperature for a predetermined period of time.

In some embodiments, reagents in the primary reaction vessel of the or each sample cartridge comprise functionalised magnetic beads, and the method further comprises operating or moving magnets to hold the magnetic beads in a selected position within the primary reaction vessel.

The method may further comprise connecting the pneumatic module to the waste pneumatic port of the or each sample cartridge and reducing a pressure within the waste vessel to draw fluid from the primary reaction vessel through the waste channel and into the waste vessel. The method may further comprise connecting the pneumatic module to the secondary pneumatic port of the or each sample cartridge and reducing a pressure in the secondary reaction vessel to draw fluid from the primary outlet channel into the secondary reaction vessel. The method may further comprise connecting the pneumatic module to the secondary pneumatic port of the or each sample cartridge and reducing a pressure in the secondary reaction vessel to draw fluid from the secondary reagent channel into the secondary reaction vessel.

The method may further comprise operating a shaker of the instrument to facilitate mixing of fluids in the secondary reaction vessel of the or each sample cartridge. The method may further comprise operating a heater of the instrument to heat the secondary reaction vessel of the or each sample cartridge to a predetermined temperature for a predetermined period of time.

In some embodiments, reagents in the secondary reaction vessel of the or each sample cartridge comprise functionalised magnetic beads, and the method further comprises operating or moving magnets to hold the magnetic beads in a selected position within the secondary reaction vessel.

The method may further comprise connecting the pneumatic module to the waste pneumatic port of the or each sample cartridge and reducing a pressure within the waste vessel to draw fluid from the secondary reaction vessel and into the waste vessel via a secondary waste channel extending between the secondary reaction vessel and the waste vessel. The method may further comprise connecting the pneumatic module to the output vessel pneumatic port of the or each sample cartridge and reducing the pressure in the output vessel to draw processed fluid into the output vessel from the primary reaction vessel via the final output channel.

In some embodiments, the processed fluid drawn from the primary reaction vessel of the or each sample cartridge is drawn into the secondary reaction vessel and processed with further reagents prior to being drawn into the final output vessel via the final output channel.

The method may further comprise connecting the pneumatic module to the quality control pneumatic port of the or each sample cartridge and, prior to reducing the pressure in the output vessel to draw processed fluid into the output vessel, reducing a pressure within the quality control vessel to draw an aliquot of processed fluid from the final output channel through the quality control channel and into the quality control vessel.

The method may further comprise operating the reagent module to dispense buffer solution into the buffer solution vessel of the or each sample cartridge; and opening the buffer channel valve of the or each sample cartridge, prior to reducing the pressure in the quality control vessel of the or each sample cartridge to draw buffer solution from the buffer solution vessel via the buffer channel, and via the final output channel and quality control channel, along with the aliquot of processed fluid, into the quality control vessel.

The method may further comprise connecting the pneumatic module to the intermediate outlet pneumatic port of the or each sample cartridge and, prior to reducing the pressure in the quality control vessel, reducing a pressure within the outlet chamber of the or each sample cartridge to draw air through the air-permeable membrane from the final output channel.

The method may further comprise operating the optics module to measure a property of the aliquot of processed fluid accommodated in the quality control vessel of the or each sample cartridge.

In some embodiments, operating the reagent module to dispense reagents into the reagent vessel further comprises operating the mechanism and actuator to move the reagent module to various positions within the instrument, each position corresponding to a respective one of the one or more of sample cartridges.

Some embodiments relate to a computer-readable storage medium storing instructions that, when executed by a computer, cause the computer to perform any one of the described methods.

Some embodiments relate to a method of use of the system of any one of the described embodiments, the method comprising: depositing a fluid sample in the primary reaction vessel of the or each sample cartridge; applying a lid to seal closed the open top of the primary reaction vessel of the or each sample cartridge; inserting the or each sample cartridge into a corresponding cartridge slot in the instrument; and operating the instrument to process the fluid sample.

Some embodiments relate to a method of use of the system of any one of the describe embodiments, the method comprising: depositing a fluid sample in the primary reaction vessel of the or each sample cartridge; applying a lid to seal closed the open top of the primary reaction vessel of the or each sample cartridge; inserting the or each sample cartridge into a corresponding cartridge slot in the instrument; and operating the instrument to process the fluid sample.

The method may further comprise removing the or each sample cartridge from the instrument once the fluid sample has been processed. The method may further comprise removing the output vessel containing the processed fluid sample from the sample cartridge. The method may further comprising removing the temporary lid from the output vessel.

Some embodiments relate to a sample cartridge for use with a fluid analysis instrument, the cartridge comprising: a sample vessel configured to accommodate a fluid sample for analysis; a buffer solution vessel configured to accommodate a buffer solution; an analysis vessel configured to accommodate a mixed fluid comprising an aliquot of the fluid sample mixed with at least some of the buffer solution for analysis; a sample channel extending between the sample vessel and a first junction; a sample channel valve disposed in the sample channel to control flow of the sample through the sample channel; a buffer channel extending between the buffer solution vessel and the first junction; a buffer channel valve disposed in the buffer channel to control flow of the buffer solution through the buffer channel; a metering channel in fluid communication with the buffer channel and sample channel, the metering channel extending between the first junction and a second junction; an analysis vessel channel in fluid communication with the metering channel and extending between the second junction and the analysis vessel; and an analysis vessel pneumatic port in communication with the analysis vessel and configured to be connected to a pneumatic module to selectively adjust a pressure in the analysis vessel to draw fluid into the analysis vessel via the analysis vessel channel.

In some embodiments, at least one of the sample channel valve and the buffer channel valve comprises an active valve which can be selectively opened and closed to allow an aliquot of the fluid sample to be drawn into the metering channel, and to allow buffer solution to then be drawn through the buffer channel and through the metering channel and analysis vessel channel into the analysis vessel with the aliquot of the fluid sample for analysis. The analysis vessel may be preloaded with a dye configured to mix with the buffer solution and fluid sample to facilitate analysis.

The sample cartridge may further comprise: an intermediate outlet in fluid communication with the metering channel via the second junction; an outlet chamber into which the intermediate outlet opens; an air-permeable liquid barrier membrane covering the outlet; and an intermediate outlet pneumatic port in fluid communication with the outlet chamber and configured to be connected to a pneumatic module to selectively adjust a pressure in the outlet chamber to draw air through the air-permeable membrane from the metering channel, wherein the intermediate outlet is arranged such that liquid drawn into the metering channel from the sample channel or buffer channel is allowed to fill the metering channel, but is not allowed to progress into the analysis vessel channel. The intermediate outlet may be located at the second junction.

In some embodiments, the sample cartridge further comprises an outlet channel extending between the second junction and the outlet, such that liquid drawn into the metering channel from the sample channel or buffer channel is allowed to fill the metering channel and progress into the outlet channel, but is not allowed to progress into the analysis vessel channel.

The sample channel may further comprise: an output vessel in fluid communication with the metering channel via the second junction and via an output channel; and an output vessel pneumatic port in communication with the output vessel and configured to be connected to a pneumatic module to selectively adjust a pressure in the output vessel to draw fluid into the output vessel from the metering channel via the second junction and the output channel. The output channel may extend from the second junction to the output vessel. The output channel may extend between the intermediate outlet and the output vessel.

In some embodiments, the buffer channel valve comprises a pressure actuated valve including a buffer channel valve pneumatic port configured to be connected to a pneumatic module to selectively open or close the buffer channel valve.

Some embodiments relate to a fluid analysis instrument configured to receive a sample cartridge of any one of the described embodiments, the instrument comprising: a pneumatic module configured to connect to the analysis vessel pneumatic port and to selectively adjust a pressure in the analysis vessel to draw fluid into the analysis vessel via the analysis vessel channel; and an analysis module configured to measure a property of a fluid in the analysis vessel.

Some embodiments relate to fluid analysis instrument comprising the sample cartridge according to any one of the described embodiments, the instrument comprising: a pneumatic module connected to the analysis vessel pneumatic port and configured to selectively adjust a pressure in the analysis vessel to draw fluid into the analysis vessel via the analysis vessel channel; and an analysis module configured to measure a property of a fluid in the analysis vessel.

The analysis module may comprise an optical source configured to illuminate the fluid in the analysis vessel, and an optical detector configured to detect or measure light transmitted from the fluid in the analysis vessel.

In some embodiments, the pneumatic module is further connected to or configured to connect to the intermediate outlet pneumatic port and configured to selectively adjust a pressure in the outlet chamber to draw air through the air-permeable membrane from the metering channel. The pneumatic module may be further connected to or configured to connect to the output vessel pneumatic port and configured to selectively adjust a pressure in the output vessel to draw fluid into the output vessel from the metering channel via the second junction and the output channel. The pneumatic module may be further connected to or configured to connect to the buffer channel valve pneumatic port and to selectively open or close the buffer channel valve.

In some embodiments, the instrument is configured to receive a plurality of ones of the sample cartridge of any one of the described embodiments containing fluid samples.

The instrument may further comprise a mechanism and actuator configured to move the analysis module to various positions corresponding to respective ones of the sample cartridges for analysis of fluid in the analysis vessel of each sample cartridge.

Some embodiments relate to fluid analysis system comprising: the instrument of any one of the described embodiments; and one or more of the sample cartridge of any one of the described embodiments.

Some embodiments relate to method of operation of the fluid analysis instrument of any one of the described embodiments, containing a fluid sample in the sample vessel, the method comprising: operating the pneumatic module to draw sample fluid from the sample vessel through the sample channel and into the metering channel up to the second junction without the sample fluid progressing into the analysis vessel channel; and operating the pneumatic module to draw fluid from the buffer solution vessel through the buffer channel, metering channel and analysis channel into the analysis vessel along with an aliquot of the sample fluid from the metering channel.

The method may further comprise: operating the pneumatic module to reduce pressure in the analysis vessel during a predetermined period of time to draw sample fluid from the sample vessel through the sample channel and into the metering channel up to the second junction without the sample fluid progressing into the analysis vessel channel; and operating the pneumatic module to reduce pressure in the analysis vessel after the predetermined period to draw fluid from the buffer solution vessel through the buffer channel, metering channel and analysis channel into the analysis vessel along with an aliquot of the sample fluid from the metering channel.

In some embodiments, the method may further comprise: operating the pneumatic module to reduce pressure in the intermediate outlet to draw sample fluid from the sample vessel through the sample channel and into the metering channel until the sample fluid meets the air-permeable barrier; and subsequently operating the pneumatic module to reduce pressure in the analysis vessel to draw fluid from the buffer solution vessel through the buffer channel, metering channel and analysis channel into the analysis vessel along with an aliquot of the sample fluid from the metering channel.

The method may further comprise: operating the pneumatic module to reduce pressure in the output vessel during a predetermined period of time to draw sample fluid from the sample vessel through the sample channel and into the metering channel up to the second junction without the sample fluid progressing into the analysis vessel channel; and operating the pneumatic module to reduce pressure in the analysis vessel after the predetermined period to draw fluid from the buffer solution vessel through the buffer channel, metering channel and analysis channel into the analysis vessel along with an aliquot of the sample fluid from the metering channel. In some embodiments, the operation of the pneumatic module to draw fluid from the buffer solution vessel through the buffer channel, is continued until the metering channel is filled with air. The method may further comprise: subsequently operating the pneumatic module to reduce pressure in the output vessel to draw sample fluid from the sample vessel into the output vessel.

In some embodiments, the method further comprises: operating the pneumatic module to maintain the buffer valve in a closed state during the period in which fluid is drawn from the sample vessel; and subsequently operating the pneumatic module to maintain the buffer valve in an open state to allow fluid to be drawn from the buffer solution vessel.

Some embodiments relate to a method of operation of the fluid analysis instrument of any one of the described embodiments, accommodating one or more of the sample cartridges of any one of the described embodiments containing a fluid sample in the sample vessel of the or each sample cartridge, the method comprising: operating the pneumatic module to draw sample fluid from the sample vessel of the or each sample cartridge through the sample channel and into the metering channel up to the second junction without the sample fluid progressing into the analysis vessel channel; and subsequently operating the pneumatic module to draw fluid from the buffer solution vessel of the or each sample cartridge through the buffer channel, metering channel and analysis channel into the analysis vessel along with an aliquot of the sample fluid from the metering channel.

In some embodiments, the method further comprises: connecting the pneumatic module to the analysis vessel pneumatic port of the or each sample cartridge; operating the pneumatic module to reduce pressure in the analysis vessel of the or each sample cartridge during a predetermined period of time to draw sample fluid from the sample vessel through the sample channel and into the metering channel up to the second junction without the sample fluid progressing into the analysis vessel channel; and operating the pneumatic module to reduce pressure in the analysis vessel of the or each sample cartridge after the predetermined period to draw fluid from the buffer solution vessel through the buffer channel, metering channel and analysis channel into the analysis vessel along with an aliquot of the sample fluid from the metering channel.

The method may further comprise connecting the pneumatic module to the analysis vessel pneumatic port and intermediate outlet pneumatic port of the or each sample cartridge; operating the pneumatic module to reduce pressure in the intermediate outlet of the or each sample cartridge to draw sample fluid from the sample vessel through the sample channel and into the metering channel until the sample fluid meets the air-permeable barrier; and subsequently operating the pneumatic module to reduce pressure in the analysis vessel of the or each sample cartridge to draw fluid from the buffer solution vessel through the buffer channel, metering channel and analysis channel into the analysis vessel along with an aliquot of the sample fluid from the metering channel.

The method may further comprise: connecting the pneumatic module to the analysis vessel pneumatic port and output vessel pneumatic port of the or each sample cartridge; operating the pneumatic module to reduce pressure in the output vessel of the or each sample cartridge during a predetermined period of time to draw sample fluid from the sample vessel through the sample channel and into the metering channel up to the second junction without the sample fluid progressing into the analysis vessel channel; and operating the pneumatic module to reduce pressure in the analysis vessel of the or each sample cartridge after the predetermined period to draw fluid from the buffer solution vessel through the buffer channel, metering channel and analysis channel into the analysis vessel along with an aliquot of the sample fluid from the metering channel.

The operation of the pneumatic module to draw fluid from the buffer solution vessel through the buffer channel may be continued until the metering channel of the or each sample cartridge is filled with air.

In some embodiments, the method may further comprise: connecting the pneumatic module to the output vessel pneumatic port of the or each sample cartridge; and subsequent to drawing the buffer solution into the analysis vessel, operating the pneumatic module to reduce pressure in the output vessel of the or each sample cartridge to draw sample fluid from the sample vessel into the output vessel. The method further comprises: connecting the pneumatic module to the buffer valve pneumatic port of each of the or each sample cartridge; operating the pneumatic module to maintain the buffer valve of the or each sample cartridge in a closed state during the period in which fluid is drawn from the sample vessel; and subsequently operating the pneumatic module to maintain the buffer valve of the or each sample cartridge in an open state to allow fluid to be drawn from the buffer solution vessel.

The method may further comprise subsequently operating the analysis module to measure a property of the fluid in the analysis vessel.

The method may further comprise transmitting data relating to the measured property to an external computing device.

Some embodiments relate to a computer-readable storage medium storing instructions that, when executed by a computer, cause the computer to perform any one of the described methods.

Some embodiments relate to a method of use of any one of the described systems, the method comprising: depositing a fluid sample in the sample vessel of the or each sample cartridge; inserting the or each sample cartridge into a corresponding cartridge slot in the instrument; and operating the instrument to analyse the fluid sample. The method may further comprise removing the or each sample cartridge from the instrument once the fluid sample has been processed.

Some embodiments relate to a sample cartridge for use with a fluid analysis instrument comprising, the cartridge comprising: a sample vessel configured to accommodate a fluid sample for analysis; a buffer solution vessel configured to accommodate a buffer solution; a sealed analysis vessel configured to accommodate a mixed fluid comprising an aliquot of the fluid sample mixed with at least some of the buffer solution for analysis; a first channel extending between the sample vessel and the analysis vessel; a second channel extending from the buffer vessel to a junction with the first channel; a first valve disposed in the first channel between the sample vessel and the junction; a second valve disposed in the second channel between the buffer vessel and the junction; and a pneumatic port in communication with the analysis vessel and configured to be connected to a vacuum pump to draw fluid into the analysis vessel from the first channel, wherein at least one of the first valve and the second valve comprises an active valve which can be selectively opened and closed to allow an aliquot of the fluid sample to be drawn into the first channel and past the junction, and to allow buffer solution to then be drawn through the second channel and into the first channel past the junction, carrying and mixing with the aliquot of the fluid sample, and then flow into the analysis vessel for analysis.

Some embodiments relate to a chemical processing instrument configured to receive a sample cartridge containing a volume of at least 0.2 mL of a fluid sample, wherein the instrument is configured to be operated according to instructions stored on a computer-readable storage medium to perform any two or more of the following processing steps on the sample: processing the sample while maintaining the sample in isolation to avoid contamination of the instrument or cross-contamination with other samples; selecting nucleic acid using specific chemistries, incubation conditions, bead selection and elution parameters; selecting a desired range of single or double stranded nucleic acid sizes of a processed fluid product and discarding unwanted materials falling outside of the desired range; increasing a concentration of a selected nucleic acid product; and quantitating an aliquot of the processed fluid product, mixing with specific fluorochromes for the selected nucleic acid, and quantifying a property of the product, such as relative to a standard reference curve or a calibrated reference curve.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Various ones of the appended drawings merely illustrate example embodiments of the present disclosure and cannot be considered as limiting its scope.

FIG. 1A is a schematic of an instrument configured to receive one or more sample cartridges each containing a sample for processing, according to some embodiments;

FIG. 1B is a perspective view of the instrument of FIG. 1A, according to some embodiments;

FIG. 1C is a cut-away perspective view illustrating some of the internal components of the instrument of FIG. 1A, according to some embodiments;

FIG. 2A is a perspective view of a sample cartridge for use an instrument, according to some embodiments;

FIG. 2B is a top view of the sample cartridge of FIG. 2A;

FIG. 2C is a side view of the sample cartridge of FIG. 2A;

FIG. 2D is a bottom view of the sample cartridge of FIG. 2A;

FIG. 2E is a bottom view of the sample cartridge of FIG. 2A illustrating further details;

FIG. 2F is a bottom view of a fluid metering arrangement, according to some embodiments, which may form part of the sample cartridge of FIG. 2A;

FIG. 2G is a circuit diagram of the sample cartridge of FIG. 2A, according to some embodiments;

FIGS. 2H and 21 are perspective views illustrating alternative channel arrangements for the sample cartridge of FIG. 2A, according to some embodiments;

FIGS. 2J to 2N illustrate alternative valves for the sample cartridge of FIG. 2A, according to some embodiments;

FIG. 2O is a close-up perspective view of an intermediate outlet of the sample cartridge, according to some embodiments;

FIG. 3A is a perspective view of a reagent module of the instrument of FIGS. 1A to 1C, according to some embodiments;

FIG. 3B is a perspective view of a reagent cartridge of the reagent module of FIG. 3A;

FIGS. 4A and 4B are schematics of an optics module of the instrument of FIGS. 1A to 1C, according to some embodiments;

FIG. 5A is a schematic of the instrument of FIGS. 1A to 1C showing parts of a pneumatic module, thermal module, magnetic module, mixing module and motion module, according to some embodiments;

FIG. 5B is a side view of the instrument of FIGS. 1A to 1C showing parts of a thermal module, magnetic module, mixing module and motion module, according to some embodiments;

FIG. 6 is a schematic diagram of a control module of the instrument of FIGS. 1A to 1C, according to some embodiments;

FIG. 7A is a perspective view of a chemical processing instrument, according to some embodiments;

FIG. 7B is a perspective view of the instrument of FIG. 7A with some features omitted;

FIG. 7C illustrates a reagent module and part of a motion module of the instrument of FIG. 7A;

FIG. 7D is another view of the reagent module also indicating the position of an optics module of the instrument of FIG. 7A;

FIG. 7E is a view of the motion module and motion module;

FIG. 7F is a further view of the motion module of the instrument of FIG. 7A;

FIG. 8A is a fluidic layout diagram of the reagent module of the instrument of FIG. 7A;

FIG. 8B is a close-up of a reagent cartridge layout of the reagent module;

FIG. 8C is a close-up of a pump portion layout of the reagent module;

FIG. 8D is a is a close-up of a dispensing portion layout of the reagent module;

FIG. 8E is a perspective view of the reagent module and disconnected reagent cartridge;

FIG. 8F is an internal perspective view of the reagent cartridge with the outer housing omitted;

FIG. 8G is a perspective view of a reagent store support and clamping mechanism in a non-clamping configuration;

FIG. 8H is a close-up perspective of the reagent cartridge clamp of FIG. 8G;

FIG. 8I is a perspective view of the pump portion of the reagent module;

FIG. 8J is a perspective view of the dispensing portion of the reagent module;

FIG. 9A is a perspective view of a pneumatic module and core units of the instrument of FIG. 7A;

FIG. 9B is a further view of the pneumatic module;

FIG. 9C is a perspective view of a manifold of the pneumatic module;

FIG. 9D is a cross-sectional perspective view of the manifold of FIG. 9C;

FIG. 9E is a perspective view of a pinch valve of the pneumatic module in an open configuration;

FIG. 9F is a cross-sectional perspective view of the pinch valve of FIG. 9E in the open configuration;

FIG. 9G is a perspective view of the pinch valve of FIG. 9E in an closed configuration;

FIG. 9H is a cross-sectional perspective view of the pinch valve of FIG. 9E in the closed configuration;

FIG. 9I is a pneumatic circuit diagram of the pneumatic module of FIG. 9A;

FIG. 9J is a pneumatic circuit diagram of a first manifold of the pneumatic module;

FIG. 9K is a pneumatic circuit diagram of a second manifold of the pneumatic module;

FIG. 9L is a pneumatic circuit diagram of a pneumatic interface plate of the pneumatic module;

FIG. 10A is a perspective view of a core unit of the instrument of FIG. 7A;

FIG. 10B is a close-up perspective view of the pneumatic interface plate of FIG. 9L in the core unit of FIG. 10A;

FIG. 10C illustrates internal components of the core unit of FIG. 10A with other components omitted for clarity;

FIG. 10D is a perspective view of a heating assembly of the core unit of FIG. 10A;

FIG. 10E is a cross-sectional perspective view of the heating assembly mounted on a motion carriage along with a magnet;

FIG. 10F is a perspective view of the sample cartridge of FIG. 12A installed in a socket of the core unit of FIG. 10A and the heating assembly engaging the sample cartridge;

FIG. 10G is a perspective view of the sample cartridge of FIG. 12A installed in a socket of the core unit of FIG. 10A with the heating assembly and magnet engaging the sample cartridge;

FIG. 10H is a force diagram of an orbital shaker of the instrument of FIG. 7A and the core unit of FIG. 10A;

FIG. 10I is a perspective view of the orbital shaker with certain components omitted for clarity;

FIG. 10J is a close-up cross-sectional perspective view of the orbital shaker;

FIG. 10K is a further perspective view showing internal components of the orbital shaker including a stop mechanism;

FIG. 10L is a close-up perspective of the stop mechanism;

FIG. 10M is a perspective view of a magnet holder and magnets of the magnetic module, according to some embodiments;

FIG. 10N is a cross-sectional view of a top portion of the magnet holder of FIG. 10M;

FIG. 11 is a cross-sectional perspective view of the optics module of FIG. 7D;

FIG. 12A is a bottom perspective view of a sample cartridge according to some embodiments;

FIG. 12B is a top exploded perspective view of the sample cartridge of FIG. 12A;

FIG. 13 is a schematic diagram of a control module of the instrument of FIG. 7A and associated software components;

FIG. 14A is an electrical layout diagram of the instrument of FIG. 7A;

FIG. 14B shows the electrical layout of the controller unit forming part of the control module of the instrument of FIG. 7A;

FIG. 14C shows the electrical layout of the power sub-assembly of the instrument of FIG. 7A;

FIG. 14D shows the electrical layout of part of the motion module of the instrument of FIG. 7A;

FIG. 14E shows the electrical layout of the pneumatic module of the instrument of FIG. 7A;

FIG. 14F shows the electrical layout of the core unit of the instrument of FIG. 7A;

FIG. 14G shows a first close-up of the electrical layout of the core unit of the instrument of FIG. 7A;

FIG. 14H shows a second close-up of the electrical layout of the core unit of the instrument of FIG. 7A;

FIG. 14I shows a third close-up of the electrical layout of the core unit of the instrument of FIG. 7A for controlling core carriage movement;

FIG. 14J shows a fourth close-up of the electrical layout of the core unit of the instrument of FIG. 7A for controlling core carriage movement; and

FIG. 14K shows a fifth close-up of the electrical layout of the core unit of the instrument of FIG. 7A for controlling the orbital shaker.

### DESCRIPTION OF EMBODIMENTS

Embodiments generally relate to systems, instruments, methods and computer-readable media for performing operations on samples, such as nucleic acid extraction operations and the like.

There are many chemical process workflows involving several steps that conventionally require transfer of a fluid sample to different vessels and/or different instruments. At each transfer step, there is a possibility of spillage of the sample, contamination of instruments with the sample, and potentially cross-contamination with other samples for processing.

Some embodiments relate to a sample cartridge for a chemical processing instrument, which facilitates workflow processes that isolate the sample and mitigate against cross-contamination. The sample cartridge comprises a primary reaction vessel, arranged to receive a lid, and a reagent vessel. The primary reaction vessel and the reagent vessel are connected or in fluid communication via a primary reagent channel. The primary reagent channel may have a primary reagent valve disposed in the primary reagent channel to control fluid flow through the primary reagent channel. A primary pneumatic port is in fluid communication with the primary reaction vessel and is configured to be connected to a pneumatic module. By using the pneumatic module to selectively adjust a pressure within the primary reaction vessel when the lid is closed, the fluid contents of the reagent vessel can be drawn into the primary reaction vessel.

The sample cartridge may further comprise a primary pneumatic channel extending between the primary pneumatic port and the primary reaction vessel, wherein an opening of the primary pneumatic channel into the primary reaction vessel is located part way up a sidewall of the primary reaction vessel. The opening of the primary pneumatic port into the primary reaction vessel may be located nearer to the top of the primary reaction vessel than the bottom of the primary reaction vessel. This may reduce the likelihood of the liquid specimen being aspirated into the pneumatic module and potentially contaminating the instrument.

In some embodiments, an opening of the primary reagent channel into the primary reaction vessel is located part way up a sidewall of the primary reaction vessel. In some embodiments, the opening of the primary reagent channel into the primary reaction vessel is located nearer to the top of the primary reaction vessel than to the bottom of the primary reaction vessel. This may reduce the likelihood of the liquid specimen entering the reagent channel and subsequently the reagent vessel, which might otherwise lead to cross-contamination in the instrument.

Various other features are described below, according to some embodiments, which further mitigate against cross-contamination, including sealed vessels for processing of the sample, separate open vessels for receiving reagents, one way valves and a pneumatic system for driving fluid flow which allows for the reaction vessels to be sealed.

There are also many chemical processing workflows which require quantitation of an aliquot of a fluid sample for analysis or measurement of one or more properties of the fluid sample, such as for quality control, for example.

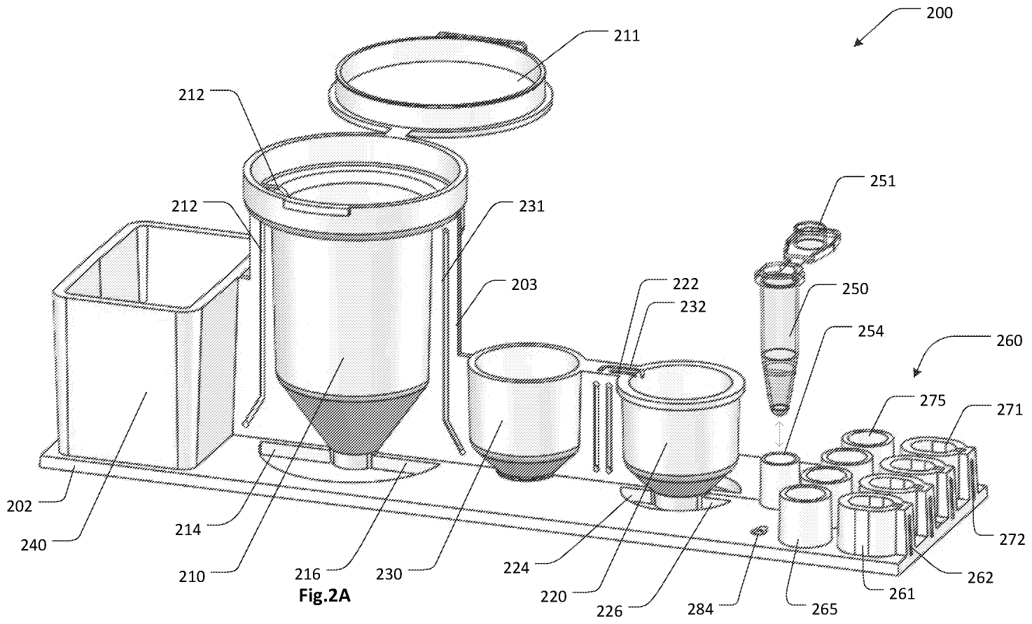

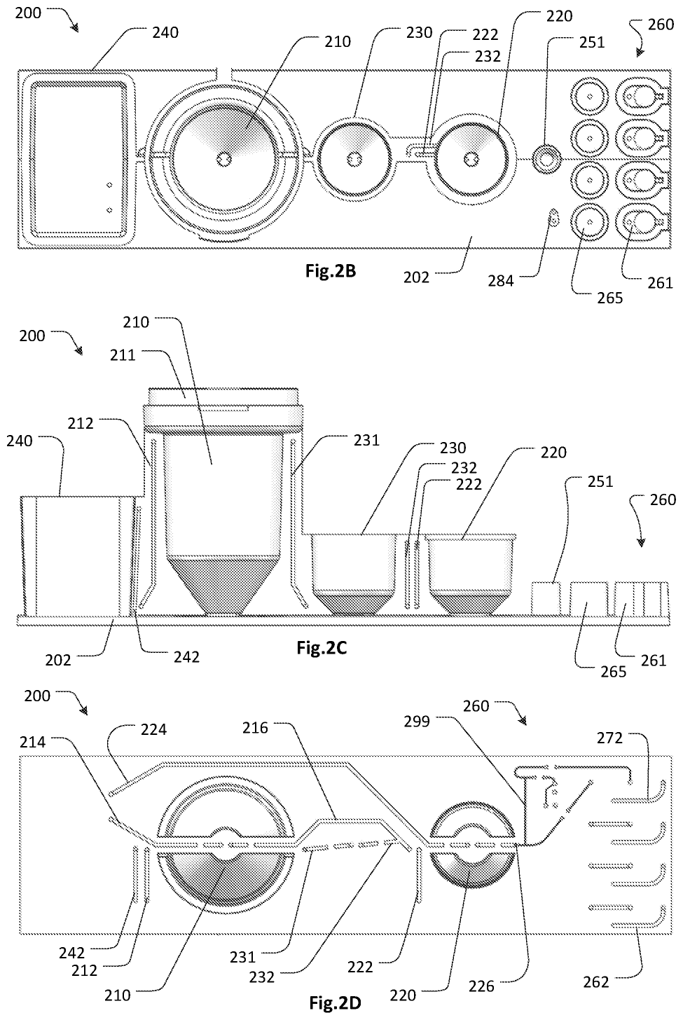

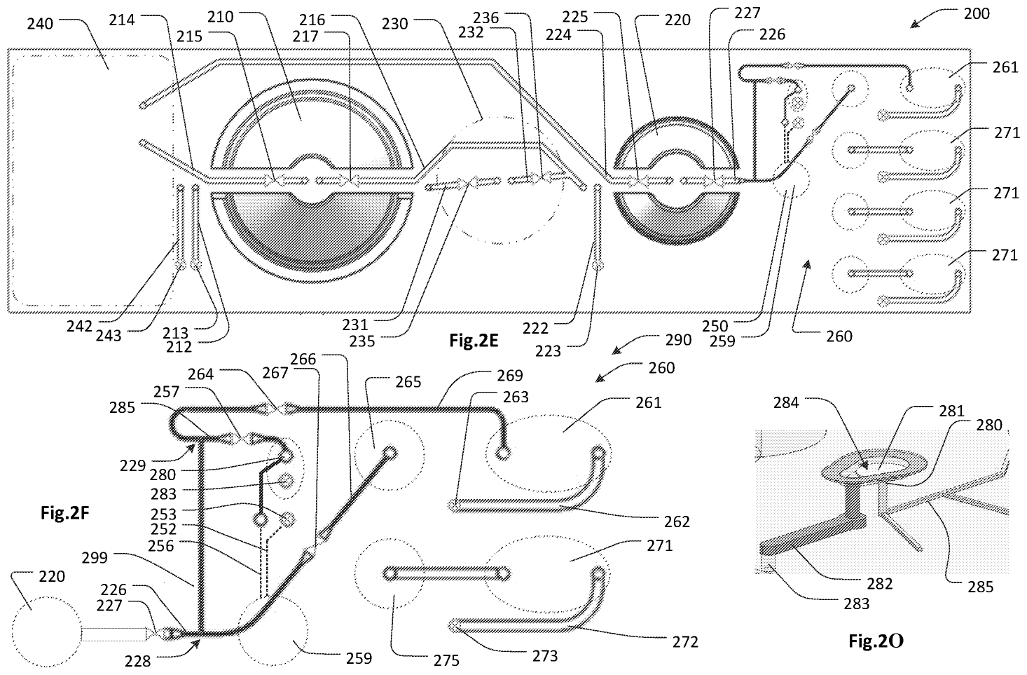

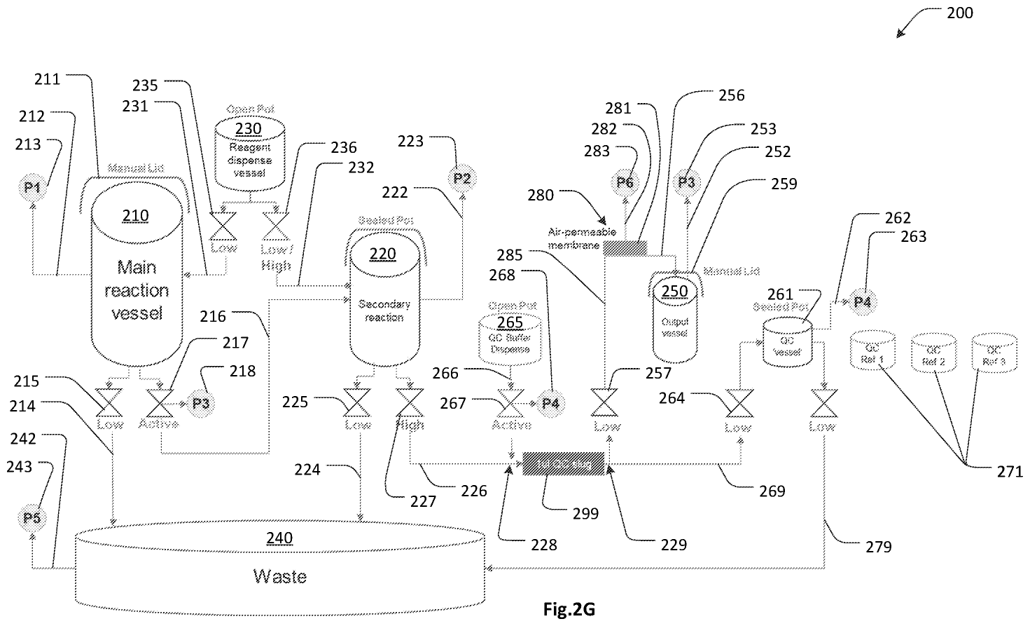

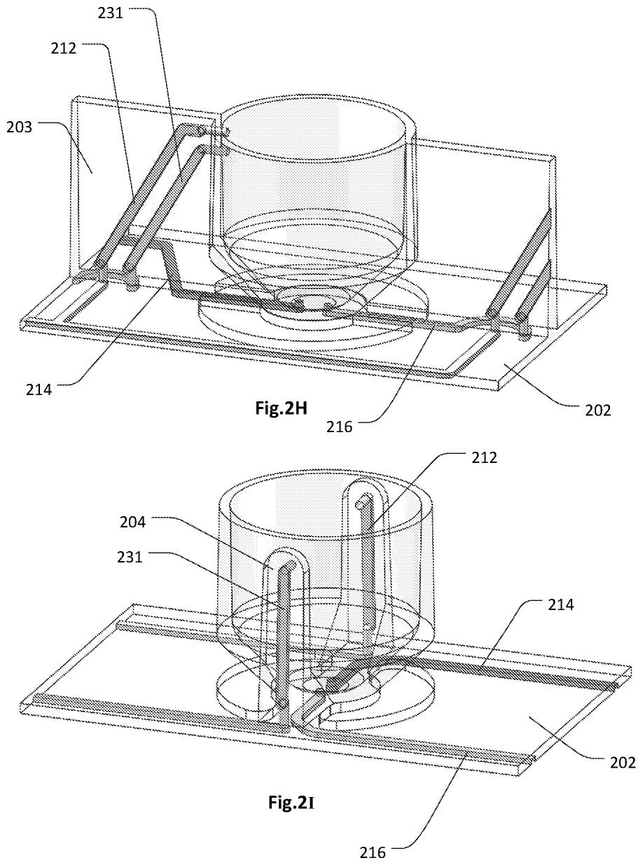

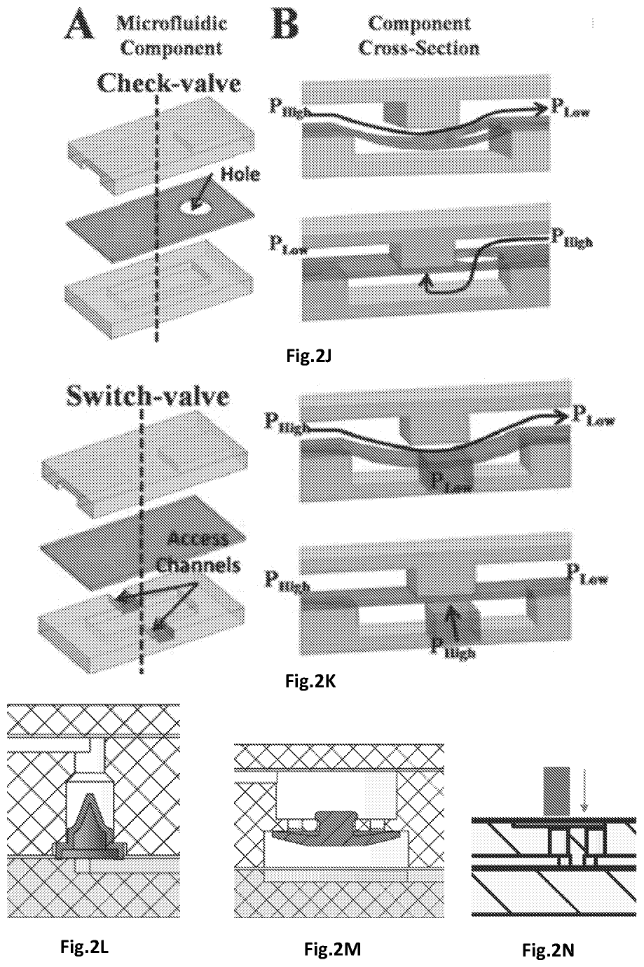

Some embodiments relate to an arrangement of channels and valves which allow precise fluid metering for isolating an aliquot of known volume for analysis or quality control, as described below in relation to FIGS. 2E to 2G. This arrangement may be included on a sample cartridge for use in an instrument, or even on a dedicated fluid analysis instrument.

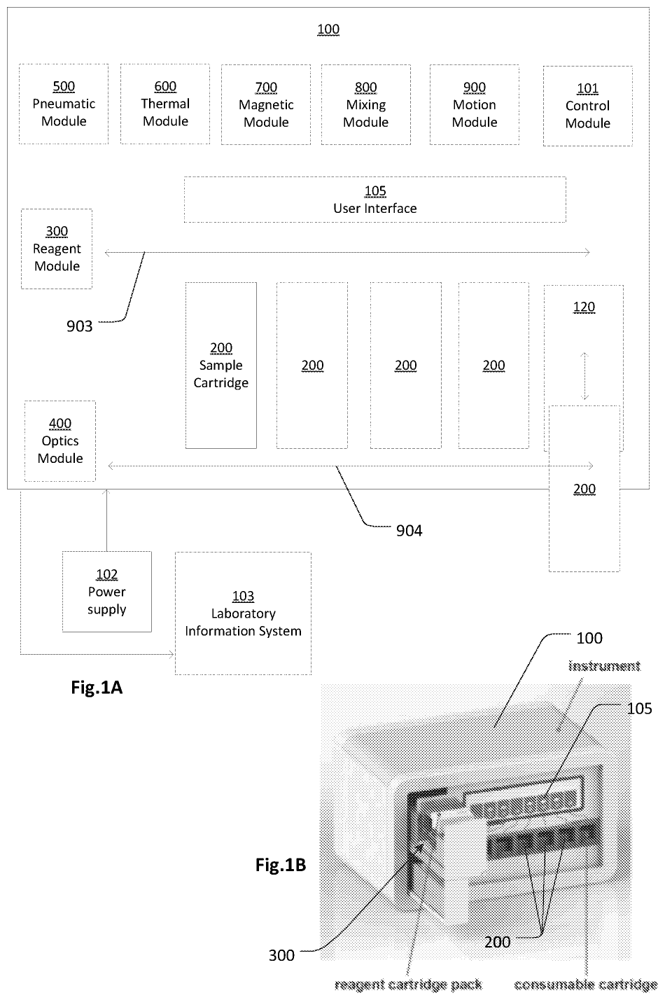

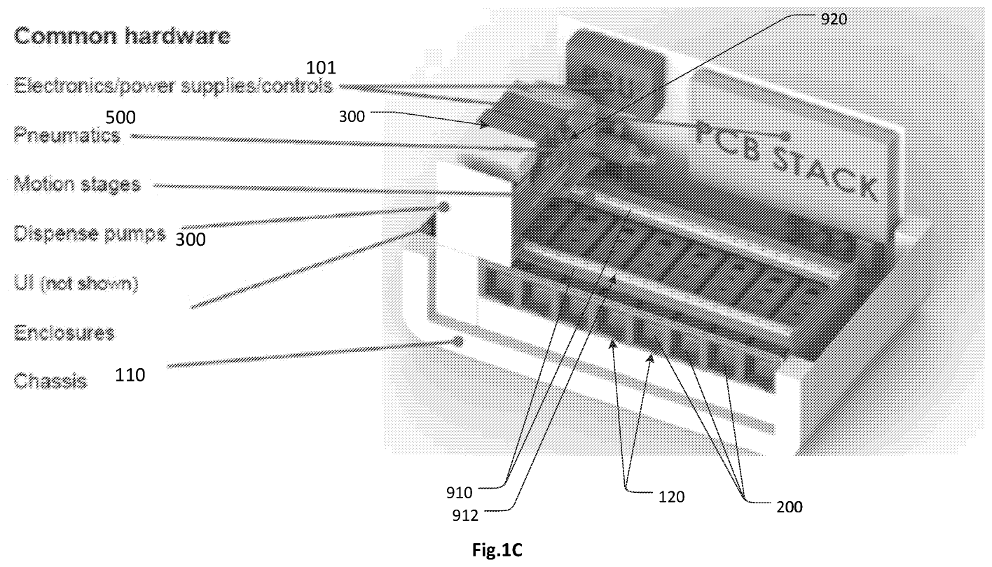

Referring first to FIG. 1A to 1C, an instrument 100 is shown, according to some embodiments. The instrument 100 may be configured to receive one or more sample cartridges 200, each containing a sample for processing. The instrument 100 may be configured to perform one or more operations on the sample, such as: chemical processing steps, heating, cooling, culturing, mixing, analysis or measurement. The instrument 100 may be configured to perform a plurality of operations on the sample which might conventionally be performed in separate instruments or manually in a laboratory.

In some embodiments, the instrument 100 may be configured to perform one or more nucleic acid extraction operations on the sample. For example, to extract nucleic acid (e.g., DNA or RNA) from a patient sample and provide a concentrated and, optionally, quantified output fluid containing nucleic acid from the sample.

The instrument 100 may comprise various different modules configured to perform the operations on the sample. These may include any one or more selected from the following group: reagent module 300, optics module 400, pneumatic module 500, thermal module 600, magnetic module 700, mixing module 800, motion module 900 and control module 101 to control the operations performed by the instrument 100. The instrument 100 may also have a power supply 102 or be connected to a power supply 102 to power the various modules.

The reagent module 300 may be configured to dispense selected reagents into the sample cartridges 200. For example, the reagent module 300 may comprise a plurality of reservoirs respectively containing a corresponding plurality of reagents for use in the operations of the instrument workflows. The reagent module 300 may comprise one or more pumps, channels and dispensing nozzles to selectively dispense controlled amounts of the reagents into a selected sample cartridge 200 at a selected time as part of one or more of the instrument workflows.

For example, the reagent module 300 may comprise a syringe pump configured to control dispensing of the reagents. The reagent module may comprise two dispense nozzles, each configured to dispense different reagents at different times. Previous reagents may be flushed out of the nozzle before dispensing subsequent reagents into the cartridge. In some embodiments, the instrument may comprise a waste receptacle and the reagent module may be configured to dispense some reagents into the waste receptacle to flush out previous reagents from the nozzles before dispensing into the cartridges.

In some embodiments, the reagent module 300 may comprise a sensor configured to detect the presence or absence of liquid in part of the reagent module. For example, the sensor may be configured to monitor the dispensing outlet, or a dispensing outlet tube to indicate or confirm when reagents are being dispensed via the outlet tube. In some embodiments, multiple sensors may be configured to monitor multiple different fluid lines within the reagent module, and/or fluid levels in the reagent reservoirs.

The or each sensor may comprise an optical sensor, such as a light source and light detector arranged to detect light from the light source passing through (or reflecting off of) a translucent or transparent wall of the fluid line or reservoir.

The sensor or sensors of the reagent module may be connected to the user interface or to indicator LEDs, for example, to confirm priming of the reagent lines; confirm when reagents are being dispensed; or to indicate when reagents are exhausted, or will be in the near future and need to be replaced.

The tubing used for the reagent lines within the reagent module may comprise any suitable materials, such as silicon tubing or PTFE tubing, for example. Any suitable dimensions of tubing may be chosen depending on the liquids to be dispensed for a particular application. For example, the inner diameter may be about 0.3 mm and the outer diameter may be about 1.6 mm.

The optics module 400 may comprise optical sensors or detectors for optical inspection of materials or fluids contained within the sample cartridges 200. The optics module 400 may further comprise one or more optical sources to illuminate the materials or fluids contained within the sample cartridges 200 for inspection. The optics module 400 may be configured to detect and/or measure certain frequencies and/or intensities of light in the optical or near optical spectrum in order to determine certain properties of the materials or fluids contained within the sample cartridges, such as concentration or density for example.

For example, the optics module may comprise an epifluorescent system including a UV LED light source, which transmits light through a band pass filter, excites fluorescence in dye within the cartridge and causes an emission from the dye which is detected by a photodiode.

The pneumatic module 500 may be configured to apply pressure differences across certain flow paths of the sample cartridges 200 or instrument 100 to drive fluid flow along those flow paths.

The pneumatic module may be configured to move liquids between the various vessels of the cartridge using positive pressure or negative pressure. That is, applying positive pressure (above atmospheric pressure) in one vessel to push liquid through the transfer channels into another vessel, or applying negative pressure (below atmospheric pressure) to one vessel to draw liquid through the transfer channels from another vessel.

In some embodiments, the pneumatic module may be configured to operate using a single pressure level selectively applied to the various pneumatic ports at different times to affect different operations. In some embodiments, the pneumatic module may be configured to operate using only two pressure levels selectively applied to the various pneumatic ports at different times to affect different operations.

For example, two pressure levels may be required if the cartridge comprises pressure actuated valves that require a higher pressure than the driving pressure for transferring liquids through the channels.

Any suitable pressure difference (e.g., vacuum pressure) may be used to drive flow in the cartridge, though it should be noted that too little pressure may result in particularly long liquid transfer times, and too greater pressure gradient may result in splashing or sputtering, which may be undesirable in certain applications, or high shear rates in the liquid flow, which could potentially be damaging to certain molecules, such as nucleic acid, for example. The suitable vacuum pressure will also depend on the viscosity or range of viscosities of liquids used in a given application. In some embodiments, the driving vacuum pressure may be in the range of 50 mBar to 500 mBar, 80 mBar to 300 mBar, 100 mBar to 200 mBar, 100 mBar to 120 mBar, about 100 mBar or about 120 mBar, for example.

The thermal module 600 may comprise one or more heating or cooling elements configured to control and/or adjust the temperature of the sample cartridges 200 and materials contained therein during different operations of the instrument workflows, such as incubation for culturing, for example.

The magnetic module 700 may comprise one or more permanent magnets or electromagnets configured to control movement of magnetic beads in the sample cartridges 200. For example, magnetic beads may be used in a primary reaction vessel 210 (FIG. 2A) for components of the sample to bind to during certain operations of the instrument workflows. The magnetic module 700 may be configured to hold the magnetic beads in position while liquids are drained away from the magnetic beads.

Alternatively, non-magnetic functionalised beads may be used for binding, and a filter may be used to restrict the beads from leaving the reaction vessels. Another alternative would be to use a porous material such as a frit with a functionalised surface for binding, and the liquids could be drawn through the frit to achieve the desired reactions.

In other embodiments, chemical catalysts or reactants may be provided as coatings on the surface of solid structures such as beads or porous solids for reaction with liquids in the reaction vessels.

The mixing module 800 may be configured to promote mixing of fluids in the primary and/or secondary reaction vessels 210, 220 (FIG. 2A) during certain operations of the instrument work flows. For example, the mixing module 800 may comprise an orbital shaker, such as an eccentric weight configured to be rotated by a motor.

The motion module 900 may comprise one or more motors or actuators configured to move certain modules to different positions corresponding to the cartridge slots 120 to perform operations on the corresponding cartridges 200 (and/or samples therein) at different times. For example, the reagent module 300 and optics module 400 may be moved to different cartridge positions to perform operations on the corresponding cartridges 200 at those positions.

The control module 101 may comprise electronics hardware in communication with the other modules of the instrument 100, and software configured to control operations of the instrument modules according to a selected instrument workflow.

Each of the modules is described further below, according to some embodiments.

The instrument 100 may be configured to be connected to an external computer system such as a laboratory information system 103. The instrument 100 may be configured to transmit data to the external laboratory information system 103, such as analysis or measurement data relating to the sample in the sample cartridge 200. In some embodiments, the instrument 100 may be configured to receive information from and external laboratory information system, such as data relating to the sample, reference data for comparison, or commands to control operations of the instrument 100.

In some embodiments, the instrument 100 may comprise a user interface 105. The user interface 105 may comprise a display on the instrument 100 itself, or an external display in communication with the instrument 100. The user interface 105 may be configured to allow a user to select a workflow program to perform on a sample in a sample cartridge 200. The workflow program may be selected from a list of different programs comprising different workflow operations configured to achieve different processes.

For example, the list of workflow programs may include: the extraction, isolation, enrichment, concentration or quantification of naturally or non-naturally occurring nucleic acids including, for example, DNA (such as genomic DNA, rearranged immunoglobulin or TCR DNA, cDNA, cfDNA) and RNA (such as mRNA, primary RNA transcript, transfer RNA or microRNA). Non-naturally occurring nucleic acids which one might seek to isolate include glycol nucleic acid, threose nucleic acid, locked nucleic acid and peptide nucleic acid. Other workflow programs may include the preparation of nucleic acid for amplification (eg. PCR library preparation) or any other type of manipulation or analysis, such as sequencing or the insertion into a vector for applications such in vitro transcription and/or translation.

The user interface 105 may also display information relating to the sample, and/or an indication of which workflow program or particular step of a workflow program is currently in progress.

The instrument 100 may comprise a chassis or housing 110 to accommodate some or all of the modules. In some embodiments, the housing 110 may be configured to be stackable with other ones of the instrument 100 so that multiple ones of the instrument 100 can be stacked vertically or arranged side by side in a laboratory, for example.

The instrument 100 may comprise a plurality of cartridge slots or sockets 120, each configured to receive a corresponding sample cartridge 200. In this way, multiple samples may be processed concurrently. The cartridge slots 120 may be at least partly defined by external openings in the housing 110 configured to receive the sample cartridges 200.

Some of the modules may have dedicated components for each cartridge socket 120. Some of the modules may act on all of the cartridges 200 in the cartridge slots 120 simultaneously. Some of the modules may be configured to act on different cartridges 200 in the cartridge slots 120 at different times.

Referring to FIG. 1C, a cutaway view of the instrument 100 is shown, illustrating part of the motion module 900, according to some embodiments. A plurality of sample cartridges 200 are shown disposed in a corresponding plurality of cartridge slots 120. The cartridges 200 and cartridge slots 120 are arranged in parallel, extending across part of the instrument 100.

The motion module 900 may comprise a track 910 extending across the plurality of cartridge slots 120, and a carriage 920 configured to move along the track 910. The carriage 920 may be configured to carry one or more of the modules, such as the reagent module 300 and optics module 400, and move them to different cartridge positions to perform operations on the sample cartridges 200. An actuator, such as a motor, operated by the control module 101 may be configured to move the carriage 920 between a rest position and the various cartridge positions.

In some embodiments, the motion module 900 may comprise a plurality of carriages 920 and corresponding tracks 910, each configured to carry a different module, such as the reagent module 300 and optics module 400, for example.

The track 910 may include motion stages 912, which may comprise markings or other indicia, specifying a plurality of carriage positions corresponding to cartridge positions which appropriately align the carriage module(s) with the cartridge slots 120 and corresponding sample cartridges 200 to allow the module(s) to perform operations on selected sample cartridges 200. The motion module 900 may comprise one or more sensors disposed on the carriage 920 configured to detect the indicia signalling for the carriage 920 to be stopped at a selected carriage position. Alternatively, known actuator states (e.g., angle of a stepper motor) corresponding to specific carriage positions may be selected to move the carriage to a selected carriage position.

Referring to FIGS. 2A to 2N a sample cartridge 200 is shown, according to some embodiments. The sample cartridge 200 comprises a base 202, a primary reaction vessel 210, a reagent vessel 230, and an output vessel 250. The sample cartridge 200 may comprise different features for different applications, depending on the operations to be performed on the sample.

In some embodiments, the sample cartridge 200 may further comprise an optional secondary reaction vessel 220, as shown in FIG. 2A and described further below.

In some embodiments, the sample cartridge 200 may further comprise an optional waste vessel 240, as shown in FIG. 2A and described further below.

In some embodiments, the sample cartridge 200 may further comprise an optional quality control module 260, as shown in FIG. 2A and described further below.

The sample cartridge 200 defines channels connecting the various vessels (the primary reaction vessel 210, reagent vessel 230, and output vessel 250, and in some embodiments, optional secondary reaction vessel 220, optional waste vessel 240, optional quality control module 260), such that the vessels are in fluid communication and fluids (including liquids and potentially liquid slurries containing solids) can be exchanged between the vessels. The sample cartridge 200 may include valves to selectively allow or disallow flow through the channels, and allow control of fluid exchange between the vessels. The network of valves and channels are described further below, according to some embodiments.

In some embodiments, the vessels (including the primary reaction vessel 210, reagent vessel 230, output vessel 250, and optional secondary reaction vessel 220, waste vessel 240, and quality control module 260) may be integrally formed with the base 202.

In some embodiments, the output vessel 250 may comprise a separate removable component, such as an Eppendorf tube, for example. This may allow a final output liquid to be readily removed from the cartridge 200 in a sealed vessel 250 for further processing or use elsewhere.

The sample cartridge 200 may define an output vessel holder or seat 254, which may be integrally formed with the base 202. The output vessel 250 may be seated in the seat 254 during processing in the instrument 100. When a selected instrument workflow is complete, and an output fluid has been deposited in the output vessel 250, the output vessel 250 may be sealed and removed from the seat 254, and the rest of the sample cartridge 200 may be discarded.

Referring FIG. 2G, a flow circuit diagram of the sample cartridge 200 is shown with optional additional features, according to some embodiments. The network of channels and valves of the sample cartridge 200 will be described with reference to a simple workflow, though it will be understood that many different workflows may be performed on or in the cartridge 200.

A liquid sample may be introduced to the primary reaction vessel 210 and a lid 211 used to seal the sample within the primary reaction vessel 210. The lid 211 may be integrally formed with the primary reaction vessel 210 as shown in FIG. 2A, for example.

One or more reagents may be dispensed (e.g., from the reagent module 300) into an open top of the reagent vessel 230. A primary reagent channel 231 extends between the reagent vessel 230 and the primary reaction vessel 210. Reagents may be delivered from the reagent vessel 230 to the primary reaction vessel 210 via the primary reagent channel 231.

A primary reagent valve 235 may be disposed in the primary reagent channel 231 to control flow through the primary reagent channel 231. The primary reagent valve 235 may comprise an active valve (examples of which are discussed below), or a passive valve. For example, the primary reagent valve 235 may comprise a low pressure valve, which has a relatively low cracking pressure in comparison with certain other valves in the network. That is, the valve may restrict flow until a relatively low threshold pressure difference exists across the valve, at which point the primary reagent valve 235 will open and fluid will be allowed to flow through the primary reagent channel 231 from the reagent vessel 230 to the primary reaction vessel 210.

A driving pressure gradient may be created using the pneumatic module 500. The cartridge 200 may comprise a primary pneumatic channel 212 extending between the primary reaction vessel 211 and a primary pneumatic port 213. The primary pneumatic port 213, along with other pneumatic ports described below, may be defined by openings in an external surface of the sample cartridge 200, such as a bottom surface or side surface of the base 202, and configured to engage with pneumatic connectors 510 in the instrument 100 to connect the pneumatic port 213 to the pneumatic module 500.

The pneumatic module 500 may comprise a plate defining a plurality of pneumatic ports, each connected to a pressure control manifold by a pneumatic line. Each pneumatic port may include a seal and be configured to connect to a corresponding port on the underside of the cartridge base 202. The plate may be configured to be moved upwards by the motion module to meet the cartridge once the cartridge is installed in the instrument, such that the corresponding ports are connected to connect the pneumatic module to the channels in the cartridge, so that they are in fluid communication.

With the lid 211 sealed, when the pneumatic module 500 applies a negative or vacuum pressure to the pneumatic port 213 (negative relative to atmospheric or ambient pressure), a pressure gradient is created between the primary reaction vessel 210 and the reagent vessel 230 so that reagents can be drawn from the reagent vessel 230 through the primary reagent channel 231 and into the primary reaction vessel 210 and the sample contained therein.

The primary reagent valve 235 may remain closed and restrict flow in the primary reagent channel 231 until it is activated to open, or until the threshold cracking pressure is overcome by the pressure applied to the pneumatic port 213 by the pneumatic module 500. The primary reagent valve 235 may comprise a check valve configured to restrict or prevent back flow, to avoid part of the fluid sample in the primary reaction chamber 210 flowing into the reagent vessel 230.

In order to avoid aspiration of part of the contents of the primary reaction vessel 210 into the primary pneumatic channel 212, an opening of the primary pneumatic channel 212 into the primary reaction vessel 210 may be defined part way up a sidewall of the primary reaction vessel 210 or at or near a top of the primary reaction vessel 210, as shown in FIG. 2A. The primary pneumatic channel 212 may be defined in a structure extending up the side of the primary reaction vessel 210 either within or alongside the sidewall of the primary reaction vessel 210, as shown in FIG. 2A.

In some embodiments, the primary reagent channel 231 may also extend upwards alongside the sidewall and open into the primary reaction vessel 210 at or near the top of the primary reaction vessel 210, as shown in FIG. 2A. This may further reduce the likelihood of part of the fluid sample flowing from the primary reaction vessel 210 into the primary reagent channel 231 or reagent vessel 230.

Alternative designs for incorporating a pneumatic channel and input channel of either of the reaction vessels 210, 230 into the sample cartridge 200 are shown in FIGS. 2H and 21. For example, the channels may be formed as open channels in the base 202 and in a flat perpendicular web 203, as shown in FIG. 2H. Alternatively, the channels may be formed as open channels in side structures 204 extending up alongside the reaction vessel 210, 230, as shown in FIG. I. The channels may then be closed by covering them with a foil or film, which may be adhesively bonded or welded to the base 202 and the web 203 or side structure 204.

If the instrument workflow includes operations that require the removal of waste fluid from the primary reaction vessel 210, then the sample cartridge 200 may comprise a waste vessel 240. Alternatively, the instrument 100 may comprise a waste receptacle or waste channel to dispose of waste fluid externally.

The sample cartridge 200 may comprise a primary waste channel 214 extending between the primary reaction vessel 210 and the waste vessel 240 (or other waste channel or receptacle). A primary waste valve 215 may be disposed in the primary waste channel 214 to control when fluid is removed from the primary reaction vessel 210 through the primary waste channel 214. For example, the primary waste valve 215 may comprise a low pressure valve with a relatively low cracking pressure.

The sample cartridge 200 may further comprise a waste pneumatic channel 242 extending between the waste vessel 240 and a waste pneumatic port 243. The waste pneumatic channel 242 may also open into the waste vessel 240 at or near a top of the waste vessel 240 to avoid aspiration of waste fluid into the waste pneumatic channel 242. The top of the waste vessel 240 may be sealed with a lid or foil, for example.

In some embodiments, depending on which liquids are required to be transferred between the vessels 210, 220, 230, 240, some splashing may occur, and small volumes of liquids may splash into the pneumatic channels 212, 222, 242. If liquids are aspirated through the pneumatic channels they may pass out of the cartridge and into the pneumatic module 500, thereby contaminating the instrument.

In order to mitigate against this scenario, the cartridge may include liquid traps associated with one or more (or each) of the pneumatic channels to prevent or restrict liquids leaving the cartridge via the pneumatic channels. For example, the liquid traps may comprise gas permeable membranes which allow passage of air but restrict or stop the passage of liquids. The gas permeable membranes may be located at any position along the pneumatic channels 212, 222, 242, such as at the openings, or at an end of each pneumatic channel at the base of the cartridge, for example.

In some embodiments, the gas permeable membranes may be disposed over a relatively large area (larger than a cross-section of the corresponding channel) in order to increase the capacity of trapped liquid that can be present before blocking the flow of gas through the membranes. The instrument may be configured to detect pressure changes due to one of the channels or liquid traps being blocked, and subsequently trigger an end to workflow operations and an indication that the process has failed, for example.

The sample cartridge 200 may further define a primary output channel 216 to allow the discharge of an output fluid from the primary reaction chamber 210. In some embodiments, if only one reaction vessel is required, the primary output channel 216 may lead directly to the output vessel 250. In some embodiments, if a secondary reaction vessel is required, the primary output channel 216 may extend between the primary reaction vessel 210 and the secondary reaction vessel 220.

A primary outlet valve 217 may be disposed in the primary outlet channel 216 to control the discharge of output fluid through the primary output channel 216. For example, the primary outlet valve 217 may comprise an active pressure actuated valve operated by applying pressure to a corresponding primary outlet valve pneumatic port 218.

In embodiments where the sample cartridge 200 comprises a secondary reaction vessel 220, sample cartridge 200 may comprise a secondary reagent channel 232 extending between the reagent vessel 230 and the secondary reaction vessel 220.

A secondary reagent valve 236 may be disposed in the secondary reagent channel 232 to control flow of reagents through the secondary reagent channel 232. For example, the secondary reagent valve 236 may comprise a high pressure valve with a relatively high cracking pressure compared with other valves in the sample cartridge 200.

The sample cartridge 200 may comprise a secondary pneumatic channel 222 extending between the secondary reaction vessel 220 and a secondary pneumatic port 223. The secondary pneumatic channel 222 may open into the secondary reaction vessel 220 at or near a top of the secondary reaction vessel 220. The top of the waste vessel 240 may be sealed with a lid or foil, for example.

Reagents may be drawn from the reagent vessel 230 into the secondary reaction vessel 220 via the secondary reagent channel 232 by applying a negative vacuum pressure to the secondary pneumatic port 223 to create a pressure difference across the secondary reagent valve 236 sufficient to overcome the relatively high cracking pressure. During this flow, the primary output valve 217 may be closed to avoid flow through the primary outlet output 216.

On the other hand, when flow of the output fluid is required from the primary reaction vessel 210 to the secondary reaction vessel 220, the primary output valve 217 may be opened and a vacuum pressure may be applied to the secondary pneumatic port 223 which to create a pressure difference which is sufficient to drive flow through the primary output channel 216, but not sufficient to overcome the relatively high cracking pressure of the secondary reagent valve 236. The primary output channel 216 may open into the secondary reaction vessel 220 at or near the top of the secondary reaction vessel 220.

The sample cartridge 200 may comprise a secondary waste channel 224 extending between the secondary reaction vessel 220 and the waste vessel 240 (or other waste channel or receptacle). A secondary waste valve 225 may be disposed in the secondary waste channel 224 to control when fluid is removed from the secondary reaction vessel 220 through the secondary waste channel 224. For example, the secondary waste valve 225 may comprise a low pressure valve with a relatively low cracking pressure. In some embodiments, a secondary waste channel 224 may not be required. That is, if there are no waste fluids to be removed from the secondary reaction vessel 220.

The sample cartridge 200 may further define a secondary output channel 226 to allow the discharge of an output fluid from the secondary reaction chamber 220. In some embodiments, if no quality control is required, the secondary output channel 226 may lead directly to the output vessel 250. In some embodiments, if quality control is required, the secondary output channel 226 may extend between the secondary reaction vessel 220 and the quality control module 260.

The secondary output channel 226 may extend between the secondary reaction vessel 220 and a buffer junction 228. A secondary outlet valve 227 may be disposed in the secondary outlet channel 226 to control the discharge of output fluid through the secondary output channel 226. For example, the secondary outlet valve 227 may comprise a high pressure valve with a relatively high cracking pressure.

The quality control (QC) module 260 comprises a quality control QC vessel 261 configured to receive an amount of output fluid from the secondary reaction vessel 220 (or primary reaction vessel 210 if there is no secondary vessel) for analysis. The sample cartridge 200 may further comprise a QC pneumatic channel 262 and QC pneumatic port 263 to which vacuum pressure may be applied to draw output fluid into the QC vessel 261 from the secondary output channel 226. A top of the QC vessel 261 may be sealed with a lid or foil, for example.

In some embodiments, the QC vessel 261 may be preloaded with a dye (optionally a desiccated dye) to facilitate optical analysis with the optics module 400.

In some embodiments, the output fluid may be mixed with a quality control buffer solution before optical analysis. The QC buffer solution may be held in a QC buffer vessel 265 prior to being transferred into the QC vessel 261 with the output fluid. For example, the QC buffer vessel 265 may define an open top so that buffer solution can be dispensed into the QC buffer vessel 265 by the reagent module 300.

The sample cartridge 200 may comprise a QC buffer channel 266 extending from the QC buffer vessel 261 to the secondary output channel 226 (or primary output channel 216 if there is no secondary vessel) at the buffer junction 228. A QC buffer valve 267 may be disposed in the QC buffer channel 266 to control flow of the buffer solution through the QC buffer channel 266. For example, the QC buffer valve 267 may comprise an active valve, such as a pressure actuated valve activated by applying positive or negative pressure to a corresponding QC buffer pneumatic port 268.

The sample cartridge 200 may further comprise a metering channel 299 in fluid communication with the secondary output channel 226 and buffer channel 266, and extending from the buffer junction 228 to a quality control junction 229.

The sample cartridge 200 may further comprise a QC channel 269 extending between the QC junction 229 and the QC vessel 261. The sample cartridge 200 may further comprise a QC vessel valve 264 disposed in the QC channel 269 to control the flow of fluid into the QC vessel 261 through the QC channel 269. The QC vessel valve 264 may comprise a low pressure valve with a relatively low cracking pressure.

While the QC buffer valve 267 is closed, vacuum pressure may be applied to the QC vessel pneumatic port 263 to create a relatively high pressure difference to overcome the threshold of the secondary output valve 227 for a short time to draw some of the output fluid from the secondary reaction vessel 220 into the secondary output channel 226 past the buffer junction 228 and into the metering channel 299 up to the QC junction 229, then the pressure difference may be neutralised to stop the flow. The metering channel 299 may define a known volume (e.g., 1 μL) so that the metering channel 299 can be filled from the buffer junction 228 to the QC junction 229, to define a precise aliquot of output fluid.

The QC buffer valve 267 may then be opened by applying the appropriate activation pressure to QC buffer pneumatic port 268 and applying vacuum pressure to the QC vessel pneumatic port 263 to create a pressure difference sufficiently high to open the low pressure QC vessel valve 264, but below the threshold for the high pressure secondary output valve 227. This allows QC buffer solution to flow through the QC buffer channel 266 and through the metering channel 299 and QC channel 269 into the QC vessel 261 along with the aliquot of output fluid from the metering channel 299.

The mixed fluid may then mix with the preloaded dye in the QC vessel 261 for analysis.

In some embodiments, the sample cartridge 200 may further comprise one or more QC reference vessels 271, each with a corresponding QC reference pneumatic channel 272 and QC reference pneumatic port 273, and each of which may be preloaded with a predefined quantity of desiccated dye. Each QC reference vessel 271 may also have a corresponding QC buffer vessel 275 configured to receive a certain required amount of QC buffer solution to be drawn into the QC reference vessel 271 by applying a vacuum pressure to the corresponding QC reference pneumatic port 273.

The contents of the QC vessel 261 can then be compared with the contents of the QC reference vessels 271 using the optics module 400 to measure a property of the output fluid, such as the concentration of a particular component, for example.

The sample cartridge 200 further comprises a final output channel 256 which branches off from the secondary output channel 226 at the QC junction 229 and connects the secondary output channel 226 to the output vessel 250. A final output valve 257 is disposed in the final output channel 256 to control flow through the final output channel 256. The final output valve 257 may comprise a low pressure check valve, for example.

The sample cartridge 200 further comprises an output vessel pneumatic channel 252 extending between the output vessel 250 and an output vessel pneumatic port 253. Vacuum pressure may be applied to the output vessel pneumatic port 253 to draw the output fluid through the final output channel 256 and into the output vessel 250.

The final output channel 256 and output vessel pneumatic channel 252 may be connected to a temporary removable lid 259 (shown in FIGS. 2F and 2G) used to seal the output vessel 250 closed during the instrument workflow. Once the sample has been processed and the sample cartridge 200 removed from the instrument 100, the temporary lid 259 may be removed from the output vessel 250 and the output vessel 250 may be closed with a main output vessel lid 251. For example, the output vessel lid 251 may be a hinged lid, integrally formed with the output vessel 250 as shown in FIG. 2A.

In order to measure a precise aliquot of the output fluid for QC analysis, vacuum pressure may be applied for a predetermined period of time until the output fluid has filled the metering channel 299 between the QC junction 229 and the buffer junction 228 and entered the final output channel 256. The length of the metering channel 299 may be designed to define a specific known volume (e.g., 1 μL). The flow through the final output channel 256 may then be stopped by returning the pressure at the output vessel pneumatic port 253 to ambient pressure.

Then the QC buffer valve 267 may be opened, and vacuum pressure may be applied to QC pneumatic port 263 to draw buffer solution from the QC buffer vessel 265 past the QC and buffer junctions 228, 229 and through the metering channel 299 and QC channel 269 carrying the aliquot of output fluid and being drawn into the QC vessel 261. In this way, a precise aliquot volume is defined between the QC and buffer junctions 228, 229 which progresses as a slug into the QC vessel to be mixed with the buffer solution.

The entire contents of the QC buffer vessel 265 may be drawn into the QC vessel 261 so that no buffer solution (or only a minor quantity) remains in the channel between the QC and buffer junctions 228, 229. This ensures that the known volume (or very close to the known volume) of buffer solution has been drawn into the QC vessel 261. It also reduces or minimises the amount of buffer solution which might remain in the channel and dilute the output fluid, which may be advantageous if a high concentration of output fluid is required.

In some embodiments, the sample cartridge 200 may comprise a waste channel 279 to discard excess fluid to the waste vessel 240 as shown in FIG. 2G. However, in some embodiments, this may not be necessary, as a precise volume of output fluid and buffer solution may be measured and drawn into the QC vessel 261 so that there is no excess fluid.

In some embodiments, the sample cartridge 200 may further comprise an intermediate outlet 280 from the final output channel 256 between the final output valve 257 and the output vessel 250. The outlet 280 may be sealed with an air-permeable membrane 281 which is permeable to gas but does not allow liquid to pass. On the other side of the membrane 281 (opposite the channel 256) an intermediate outlet pneumatic channel 282 connects the outlet 280 to an intermediate outlet pneumatic port 283. Air can be drawn through the air-permeable membrane 281 by applying vacuum pressure to the intermediate outlet pneumatic port 283.

When this is done, the liquid output fluid will be drawn along the final output channel 256 but will stop once it reaches the air-permeable membrane 281. This will result in an increase in the pressure gradient, which can be detected by the pneumatic module 500, indicating that the channel 256 has been filled to the intermediate outlet 280. This signal may be used to trigger the next step in a workflow, such as flowing the buffer solution through the metering channel 299 and QC channel 269.

The sealed reaction vessels 210, 220, QC vessels 261, QC reference vessels 271, output vessel 250 and waste vessel 240 allow processing of a fluid sample without cross-contamination or instrument contamination due to the splashing of the fluid sample out of these vessels. This is achieved by providing separate vessels for receiving reagents from the reagent module (e.g., reagent vessel 230 and buffer vessels 265, 275), and transferring the reagents into the sealed vessels for processing using the pneumatic module and corresponding pneumatic ports to create pressure gradients to drive flow as required. Locating the openings of the inlet channels and pneumatic channels at or near tops of the sealed vessels, also reduces the chance of backflow of sample fluid into the inlet channels or aspiration of sample fluid into the pneumatic module, which might otherwise contaminate the instrument.

Referring to FIG. 2E, a bottom view of the sample cartridge 200 is shown in further detail illustrating the network of channels and valves of the cartridge. A close-up view of the quality control module 260 is shown in FIG. 2F. Like elements are indicated with like reference numerals.

In some embodiments, the QC module 260 may be included as part of a larger sample cartridge, such as sample cartridge 200, or any other sample cartridge which may require QC analysis or precise fluid metering. In some embodiments, the QC module 260 may be included as part of a measurement or analysis instrument.

Referring to FIG. 2F, the QC module 260 could also be considered independently as a separate sample cartridge 290, according to some embodiments. Some embodiments relate to an independent sample cartridge 290 comprising only the QC module 260, as shown in FIG. 2F.

The sample cartridge 290 may be configured for use with a fluid analysis instrument, for example. The cartridge 290 comprises a sample vessel 220 configured to accommodate a fluid sample for analysis. The sample vessel 220 corresponds to the secondary reaction vessel 220 of sample cartridge 200, or could correspond to the primary reaction vessel 210 in a sample cartridge 200 with no secondary reaction vessel 220.

The cartridge 290 comprises a buffer solution vessel 265 (similar to sample cartridge 200) configured to accommodate a buffer solution. The cartridge 290 comprises a sealed analysis vessel 261 (corresponding to QC vessel 261) configured to accommodate a mixed fluid comprising an aliquot of the fluid sample mixed with at least some of the buffer solution for analysis.

The cartridge 290 comprises a sample channel 226 (corresponding to secondary output channel 226) extending between the sample vessel 220 and a first junction 228 (corresponding to buffer junction 228).

The cartridge 290 comprises a sample channel valve 227 (corresponding to secondary output valve 227) disposed in the sample channel 226 to control flow of the sample through the sample channel 226.

The cartridge 290 comprises a buffer channel 266 extending between the buffer solution vessel 265 and the first junction 288. A buffer channel valve 267 is disposed in the buffer channel 266 to control flow of the buffer solution through the buffer channel 266.

The cartridge 290 comprises a metering channel 299 in fluid communication with the buffer channel 266 and sample channel 226, the metering channel 299 extending between the first junction 228 and a second junction 229 (corresponding to QC junction 229).

The cartridge 290 comprises an analysis vessel channel 269 (corresponding to QC channel 269) in fluid communication with the metering channel 299 and extending between the second junction 229 and the analysis vessel 261. The cartridge 290 comprises an analysis vessel pneumatic port 263 (corresponding to QC pneumatic port 263) in communication with the analysis vessel 261 and configured to be connected to a pneumatic module to selectively adjust a pressure in the analysis vessel 261 to draw fluid into the analysis vessel 261 via the analysis vessel channel 269.

At least one of the sample channel valve 227 and the buffer channel valve 267 may comprise an active valve which can be selectively opened and closed to allow an aliquot of the fluid sample to be drawn into the metering channel 299, and to allow buffer solution to then be drawn through the buffer channel 266 and through the metering channel 299 and analysis vessel channel 269 into the analysis vessel 261 with the aliquot of the fluid sample for analysis. For example, the buffer channel valve 267 may comprise an active valve, and the sample channel valve 227 may comprise a relatively high pressure check-valve.

The analysis vessel 261 may be preloaded with a dye configured to mix with the buffer solution and fluid sample to facilitate analysis.

The sample cartridge 290 or 200 may further comprise an intermediate outlet 280 in fluid communication with the metering channel 299 via the second junction 229. The intermediate outlet 280 may be similar to the intermediate outlet of sample cartridge 200, both of which may include any of the features described below.

Referring to FIG. 2O (adjacent FIG. 2F), a close-up top perspective view of the outlet 280 is shown according to some embodiments.

In some embodiments, the outlet 280 may be located at the second junction 229. In some embodiments, the outlet 280 may be located away from the second junction 229 and connected to the second junction 229 via an outlet channel 285.

The sample cartridge 290 or 200 may comprise an outlet chamber 284 into which the intermediate outlet 280 opens. An air-permeable liquid barrier membrane 281 may cover the outlet 280.

The sample cartridge 290 or 200 may comprise an intermediate outlet pneumatic port 283 in fluid communication with the outlet chamber 284 and configured to be connected to a pneumatic module to selectively adjust a pressure in the outlet chamber 284 to draw air through the air-permeable membrane 281 from the metering channel 299.

The sample cartridge 290 or 200 may comprise an intermediate outlet pneumatic channel 282 extending between the intermediate outlet pneumatic port 283 and the outlet chamber 284. The outlet chamber 284 may be sealed with only two fluid openings, namely, the outlet 280 and an opening of the intermediate outlet pneumatic channel 282. A top of the outlet chamber 284 may be sealed with a foil, for example.

The intermediate outlet 280 may be arranged such that liquid drawn into the metering channel 299 from the sample channel 226 or buffer channel 266 is allowed to fill the metering channel 299, but is not allowed to progress into the analysis vessel channel 269.

The sample cartridge 290 or 200 may comprise an outlet channel 285 extending between the second junction 229 and the outlet 280, such that liquid drawn into the metering channel 299 from the sample channel 226 or buffer channel 266 is allowed to fill the metering channel 299 and progress into the outlet channel 285, but is not allowed to progress into the analysis vessel channel 269.

The sample cartridge 290 or 200 may comprise an output vessel 250 in fluid communication with the metering channel 299 via the second junction 229 and via an output channel 256. The output channel 256 may extend from the second junction 229 to the output vessel 250. Alternatively, or additionally, the output channel may extend between the intermediate outlet 280 and the output vessel 250.

The sample cartridge 290 or 200 may comprise an output vessel pneumatic port 253 in communication with the output vessel 250 and configured to be connected to a pneumatic module to selectively adjust a pressure in the output vessel 250 to draw fluid into the output vessel 250 from the metering channel 299 via the second junction 229 and the output channel 256.

The arrangement of channels, valves, vessels and outlets in the sample cartridge 290 and QC module 260 allow for precise quantitation of an aliquot of sample fluid (or processed fluid), as the volume of the metering channel can be precisely defined. The arrangements described above may be used for precise metering fluid for quantitation for any application where precise quantitation is required.

The sample cartridge 290 may further comprise one or more reference vessels 271 and associated buffer vessels 275, pneumatic channels 272 and pneumatic ports 273, as described in relation to sample cartridge 200.

The output channel 256 and output vessel pneumatic channel 252 may be connected to a temporary lid 259 defining openings of the output channel 256 and output vessel pneumatic channel 252 into the output vessel 250, and configured to seal the output vessel 250. The temporary lid 259 may be removed to allow the output vessel 250 to be removed from a base 202 of the sample cartridge 290, and the output vessel 250 may be sealed with an output vessel lid 251.

The sample cartridge 200 or 290 may be formed of any suitable plastics material for a given application. For example, for handling biological materials, polypropylene may be used.

The sample cartridge 200 or 290 may be formed by injection moulding. For example, the sample cartridge 200 or 290 may be formed with some or all of the channels, chambers and vessels having an open top or open side, and some of the openings may be sealed with a welded foil, for example, as required to form the sealed channels, chambers and vessels described above.

The channels in the base may be covered with a polypropylene membrane which may be heat welded to the base. And channels in the side walls leading to and from the vessels may similarly be covered with a polypropylene membrane heat welded to the body. For example, the heat welding may comprise laser welding, and a tractor weld around the perimeter of each channel may fix the membrane to the body to define each channel.

The valves may comprise any suitable active or passive valves depending on the arrangement and application. Suitable valves may include check valves with different relative cracking pressures (as shown in FIG. 2J, for example), duck-bill valves (as shown in FIG. 2L, for example), umbrella valves (as shown in FIG. 2M, for example), microfluidic valves or capillary valves with different cracking pressures depending on surface tension and capillary action, pressure actuated switch valves (as shown in FIG. 2K, for example), electronically actuated switch valves (e.g., solenoid valves), or mechanically actuated switch valves such as Prodger valves (as shown in FIG. 2N, for example). A combination of different valve types may be used to achieve the required flows in the sample cartridge 200.

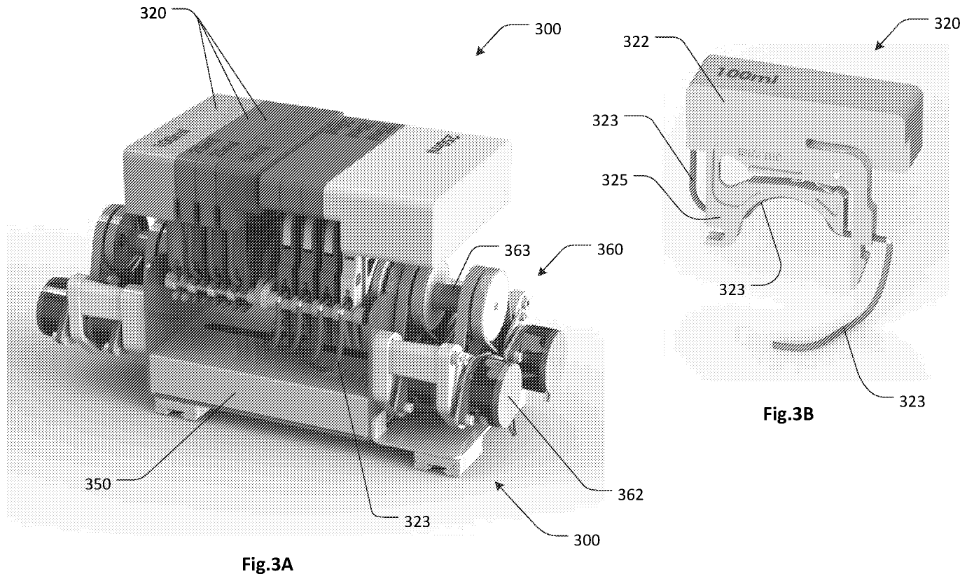

Referring to FIGS. 3A and 3B, the reagent module 300 is shown, according to some embodiments. The reagent module 300 comprises a plurality of reagent cartridges 320 removably mounted to a frame 350. The frame 350 also supports a pump 360 configured to control dispensing of reagents from the reagent cartridges 320.

An isolated reagent cartridge 320 is shown in FIG. 3B. Each reagent cartridge 320 comprises a reservoir 322, a flexible dispensing tube 323, and a reagent cartridge frame 325 configured to support the reservoir 322, and configured to engage the reagent module frame 350 to mount the reagent cartridge 320 on the frame 350.

The pump 360 may comprise a peristaltic pump. For example, the pump 360 may comprise one or motors 362 each configured to drive rotation of a pump shaft 363 and pump cam (not shown) mounted on the pump shaft 363. The pump cam may be generally circular with protuberances, like a round toothed cog, for example.

When mounted on the reagent module frame 350, the reagent cartridge frame 325 may support the dispensing tube 323 such that part of the tube 323 extends at least part way around a circumference of the pump cam, and when the pump cam is rotated by the corresponding motor 362, the protuberances of the pump cam contact and compress part of the dispensing tube 323 thereby pushing fluid through the dispensing tube 323 as the pump cam rotates. The dispensing tubes 323 may be positioned such that the openings dispense the reagents into the desired vessel of a sample cartridge 200 (reagent vessel or QC buffer vessels) when the reagent module 300 is aligned with the sample cartridge 200.

The dispensing tubes 323 may be formed of any suitable material, and in some cases, may be formed of different materials depending on compatibility with the respective reagents. For example, the dispensing tubes 323 may be formed of silicone, viton or Chem-Durance Bio tubing.

Each reagent cartridge 320 may be engaged by a respective pump cam driven by a corresponding one of the motors 362. In some embodiments, a single pump cam, or a single pump shaft 363 configured to drive rotation of multiple pump cams, may be configured to engage more than one of the reagent cartridges 320 to control dispensing. For example, if multiple reagents are to be dispensed simultaneously, in similar amounts, then the corresponding reagent cartridges 320 may be simultaneously engaged by a single pump system to dispense the reagents into the sample cartridge 200.

The pump 360 may comprise independent motors 362 and drive shafts 363 to independently control dispensing of reagents from different reagent cartridges 320.

The reservoirs 322 of the different reagent cartridges 320 may define different volumes in proportion to an expected ratio of consumption of the different reagents contained therein. For example, if a first reagent is typically dispensed at twice the volume of a second reagent, the reservoir 322 for the first reagent may be twice the volume of the reservoir 322 for the second reagent.

The reservoirs 322 may contain a sufficient volume of reagents for a certain number of instrument workflows to be performed. When the reagent reservoirs 322 are empty, the reagent module 300 may be partially slid out of the instrument housing 110 as shown in FIG. 1B so that the reagent reservoirs 322 can be refilled, or the empty reagent cartridges 320 can be removed entirely and replaced with filled reagent cartridges 320.

In some embodiments, the reagent module frame 350 may comprise or be mounted on the (or a) carriage 920 of the motion module 900. The reagent module 300 may be moved (by the motion module 900) along an axis of movement 903 across the plurality of sample cartridges 200 in the cartridge slots 120 to dispense reagents into the sample cartridges 200 at selected times during the instrument workflows.

The reagent module 300 may be moved to a selected carriage position at a selected time corresponding to a selected one of the sample cartridges 200. Then the pump 360 may be operated to dispense one or more reagents from the corresponding reagent cartridges 320 into a selected vessel in the sample cartridge 200, such as the reagent vessel 230 or quality control buffer vessels, for example.

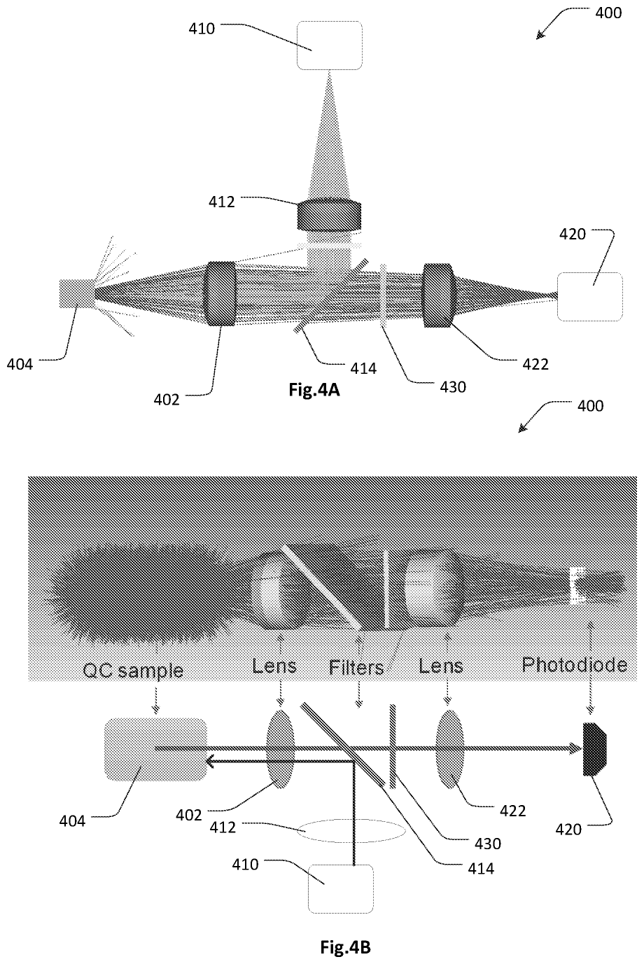

Referring to FIGS. 4A and 4B, a diagram of the optics module 400 is shown, according to some embodiments. The optics module 400 comprises a light source 410 and a detector 420. The light source 410 is configured to illuminate a quality control (QC) sample 404, which may comprise output liquid in the QC vessel 261, or reference liquid in one of the QC reference vessels 271. The detector 420 is configured to detect and measure light transmitted from the QC sample 404.

For example, the light source 410 may comprise an LED or LASER. The detector 420 may comprise a photodiode or any other suitable optical detector. Light source 410 and detector 410 may be configured to operate in any suitable frequency range depending on the application and the property being measured, including in the visible, near visible, infrared and ultraviolet ranges.

The optics module 400 may be configured to measure any one or more of scattered light, refracted light or reflected light transmitted from the QC sample 404.

In some embodiments, the optics module 400 may comprise one or more lenses, filters and/or other optical devices. For example, the optical module 400 may comprise a source lens 412 to focus light from the source 410 (e.g., into parallel rays); a beam splitter 414 to redirect light from the source 410 towards the QC sample 404; a sample lens 402 to focus the source light onto the QC sample 404 and refocus light transmitted from the QC sample 404 (e.g., into parallel rays); a detector lens 422 to focus the light transmitted from the QC sample 404 onto the detector 420; and one or more filters 430 disposed in the detector path and/or the source path to filter certain frequencies of light.

The optics module 400 may be mounted on a carriage 920 of the motion module 900 (either the same carriage as the reagent module 300 or an independent carriage 920), to allow the optics module 400 to be aligned with any selected one of the sample cartridges 200 in the cartridge slots 120 to optically analyse a QC sample 404 disposed in the sample cartridge 200.

For example, the sample cartridge 200 shown in FIG. 2A comprises one QC vessel 261 and three QC reference vessels 271 to be compared. The QC vessel 261 and three QC reference vessels 271 may be arranged along a lateral axis of the sample cartridge 200 parallel to an axis of movement 904 of the optics module 404, to allow ready access for the optics module 400 to the QC samples 404. The carriage 920 may be moved by the motion module 900 to different carriage positions corresponding to the positions of the QC vessel 261 and three QC reference vessels 271.

The QC vessel 261 and three QC reference vessels 271 may comprise a clear window (on the top, bottom or side) to allow light to pass from the optical source 410 into QC samples 404 contained therein, and from the QC samples 404 to the optical detector 420. The window may have a surface finish of SPI A-1 grade to minimise scattering. The window thickness may be less than or equal to 3 mm.

The motion module 900 may position with optics module 400 such that the QC sample 404 is within 2 mm of an optical focal plane of the optics module 400, and optionally within a lateral positional tolerance of 1.25 mm. Different tolerances may be suitable for different applications depending on the characteristics of the optics module 400 and sample cartridge 200.

The pneumatic module 500 is shown in FIG. 1C, according to some embodiments. The pneumatic module 500 may comprise a pressure regulator and a compressor, vacuum generator or vacuum pump. Alternatively, the pneumatic module 500 may be configured to be connected to an external pressure source or vacuum line, for example.

The pneumatic module 500 may comprise a network of pneumatic lines and valves with connectors adjacent the cartridge slots 120 configured to connect to the pneumatic ports of the sample cartridges 200. The pneumatic module 500 may be configured to selectively deliver positive and/or negative pressure (relative to atmospheric pressure) to selected pneumatic ports of the sample cartridges 200 at selected times during the instrument workflows.

In some embodiments, the pneumatic module 500 may be configured to deliver different magnitudes of relative pressure differences to different pneumatic ports of the sample cartridges 200. In some embodiments, the pneumatic module 500 may be configured to deliver different magnitudes of relative pressure differences to selected pneumatic ports of the sample cartridges 200 at different times. In some embodiments, the pneumatic module 500 may be configured to only deliver negative pressure to the pneumatic ports of the sample cartridges 200.

In some embodiments, the pneumatic module 500 may comprise sets of pneumatic lines, each set of pneumatic lines configured to simultaneously deliver a selected pressure to all corresponding pneumatic ports of the plurality of sample cartridges 200 in the cartridge slots 120. For example, to apply a certain negative pressure to all of the primary pneumatic ports 213 simultaneously.

In some embodiments, each pneumatic port in the sample cartridge 200 may have a single selected pressure or pressure range to be delivered to it at selected times without having to vary the pressure.

The pneumatic module 500 may comprise any suitable valve system for selectively delivering the required pressure to the required pneumatic ports at the selected times of the instrument workflows. For example, an array of solenoid valves operated electronically by the control module 101, or a manifold valve system, or rotary valve system.

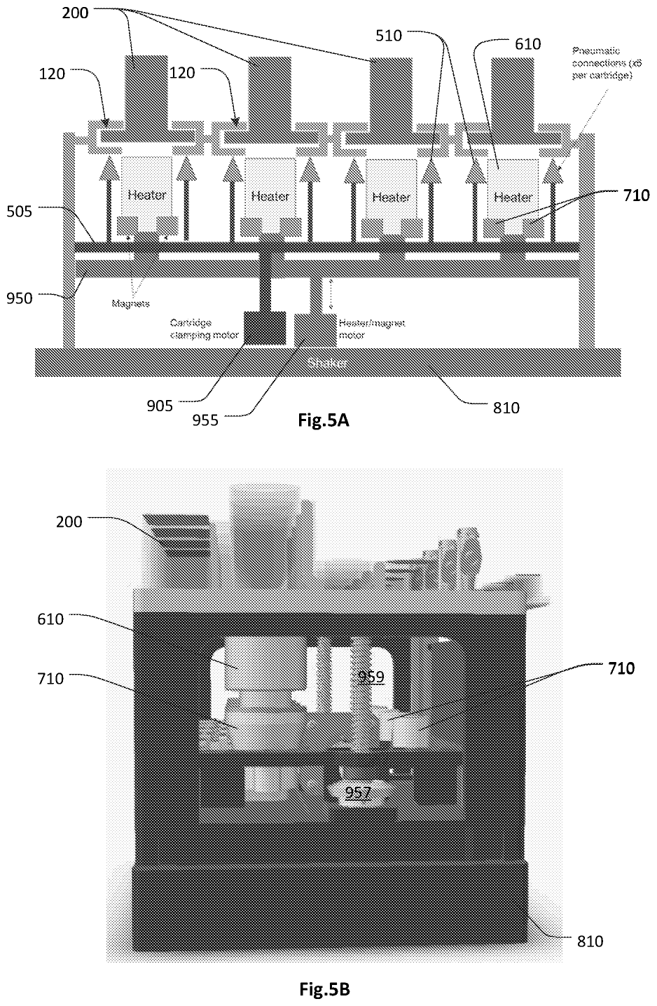

Referring to FIGS. 5A and 5B, parts of the pneumatic module 500, thermal module 600, magnetic module 700, mixing module 800 and motion module 900 are shown, according to some embodiments.

Pneumatic connectors 510 are shown under the cartridge slots 120 supported by a pneumatic support frame 505. The support frame 505 is connected to a pneumatic module actuator 905, which may form part of the motion module 900. The pneumatic module actuator 905 may comprise a motor or linear actuator configured to raise and lower the pneumatic connectors 510. The pneumatic connectors 510 may be in a lowered position for loading the sample cartridges 200 into (or removing them from) the cartridge slots 120. When the sample cartridges 200 are accommodated within the cartridge slots 120, the pneumatic module actuator 905 may be operated to raise the pneumatic support frame 505 and pneumatic connectors 510, such that the pneumatic connectors 510 engage the pneumatic ports in the sample cartridges 200 and fluidly connect the pneumatic module 500 to the channels of the sample cartridges 200.

In some embodiments, the motion module 900 may further comprise a vertical movement platform 950 configured to raise and lower other components of the instrument 100 within the housing 110. Movement of the platform 950 may be driven by a platform actuator 955, which may comprise a linear actuator or a leadscrew actuator as shown in FIG. 4B, for example, with a motor 957 and lead screw 959.

The vertical movement platform 950 may be configured to raise and lower components of the thermal module 600 and/or the magnetic module 700, for example, as well as any other components of the instrument which might need to be raised and lowered. In some embodiments, the pneumatic support frame 505 and connectors 510 may be mounted on a similar vertical movement platform 950. In some embodiments, the motion module 900 may comprise multiple vertical movement platforms 950 configured to be operated independently to independently raise and lower different components or groups of components. For example, the thermal module and magnetic module may be mounted on a single vertical movement platform, which may comprise an additional vertical movement platform mounted thereon to raise and lower the thermal module independently of the magnetic module.

In some embodiments, the instrument 100 may not comprise a vertical movement platform 950.

The thermal module 600 may comprise one or more thermal control devices 610, which may comprise heating and/or cooling elements, thermoelectric devices, peltier elements, resistive heaters, heat lamps, heat exchangers, and/or fans. When heating (or other thermal control) is required during one of the instrument workflows (e.g., for culturing), the platform 950 may be raised to bring the thermal control devices 610 (e.g., heaters) closer to the sample cartridges 200 in the cartridge slots, and the thermal control devices 610 activated.

In some embodiments, the thermal module 600 may comprise a conducting member coupled to a heating element to facilitate heating of the reaction vessels. For example, the conducting member may comprise a plate or jacket, which may define a complimentary surface configured to partially surround the reaction vessel.

The thermal module 600 may comprise a cooling fan disposed below the heating element and conducting member and configured to direct ambient air up around the heating element and conducting member to cool them down when required.

The cartridge may define openings in the base 202 around the bottom of the primary reaction vessel 210 and/or secondary reaction vessel 220 configured to allow passage of the conducting member or conducting members and/or magnets for positioning beside the reaction vessels 210, 220.

In some embodiments, the thermal module 600 may be fixed in a location close to the cartridge slots 120 and aligned with the primary and/or secondary reaction vessel 210, 220, and simply switched from heating to cooling or neutral, depending on the required thermal adjustment for a particular workflow operation.

The magnetic module 700 may comprise one or more magnets 710 arranged to control movement of magnetic beads in the primary and/or secondary reaction vessel 210, 220. The magnets 710 may comprise permanent magnets and/or electromagnets, and may be mounted on the vertical movement platform 950 to be raised close to the primary and/or secondary reaction vessel 210, 220 when the magnetic beads are to be held still, and lowered further away from the primary and/or secondary reaction vessel 210, 220 so that the magnets 710 have less influence on the magnetic beads. The magnets 710 may be disposed on either side of the primary and/or secondary reaction vessel 210, 220 so as to hold the beads away from the discharge outlets to avoid blockage or constriction of the discharge flow into the channels.

In some embodiments, for example, when the magnets 710 comprise electromagnets, the magnets 710 may be fixed in a location close to the cartridge slots 120 and aligned with the primary and/or secondary reaction vessel 210, 220, and simply switched on or off, depending on the required state for a particular workflow operation.

In some embodiments, the instrument may not comprise a magnetic module 700, and the functionalised beads in the primary and/or secondary reaction vessels may be kept out of the output channels by a physical barrier or restriction, such as a filter, for example.

The mixing module 800 may comprise any suitable device for enhancing mixing of fluids in the sample cartridges 200. For example, the mixing module 800 may comprise a shaker 810. The shaker 810 may comprise an orbital shaker, such as an eccentric cam or offset weight configured to be rotated by a motor to induce vibrations in the instrument 100. Alternatively, other conventional mixing devices may be used to promote mixing of fluids in the sample cartridges 200. In some embodiments, the mixing module 800 comprises a single shaker 810 configured to shake all of the sample cartridges 200 simultaneously.

The orbital shaker may include multiple weights and counter weights configured to vibrate the cartridges without toppling the instrument. A suitable power, frequency and amplitude of vibration may be chosen for the required application. For processing relatively fragile molecules (e.g., nucleic acid), a frequency of less than 2000 rpm may be suitable, such as approximately 1100 rpm, for example.

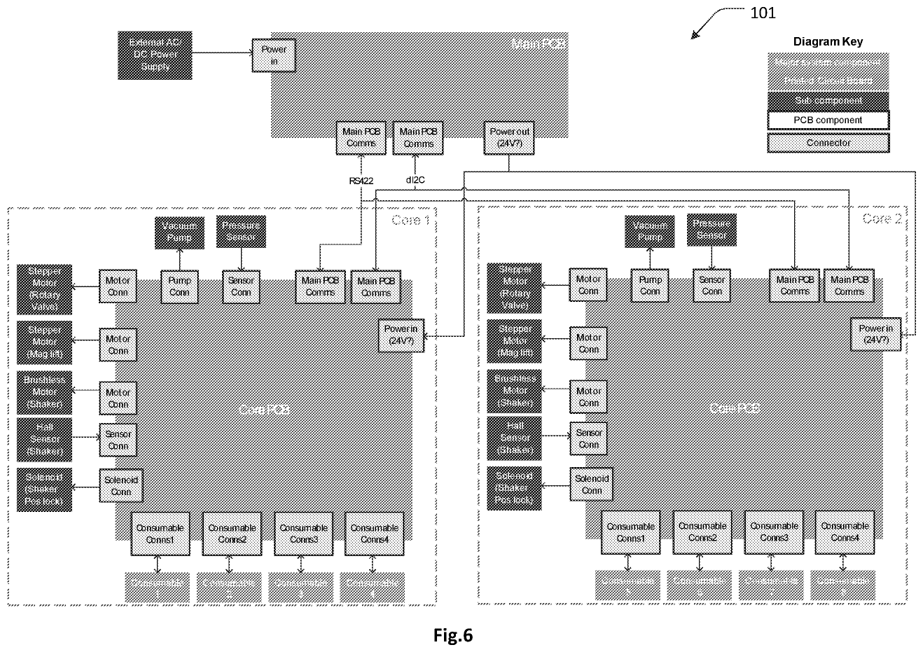

Referring to FIG. 6, a schematic diagram of the control module 101 are shown, according to some embodiments. The control module 101 comprises electronics and software configured to control the operations performed by the instrument 100, which may include control of the reagent module 300, optics module 400, pneumatic module 500, thermal module 600, magnetic module 700, mixing module 800, and motion module 900.

The control module 101 may also comprise one or more sensors to monitor operations of the modules. The sensors may include position sensors, accelerometers, proximity sensors, angular sensors (e.g., shaft angle or speed sensors), Hall sensors and pressure sensors, for example.

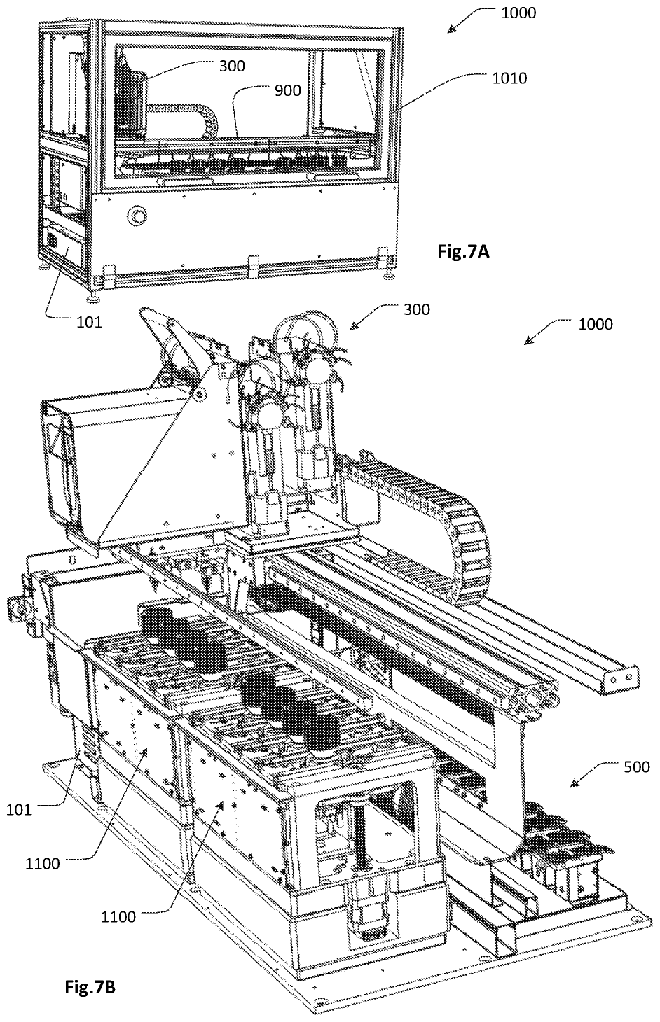

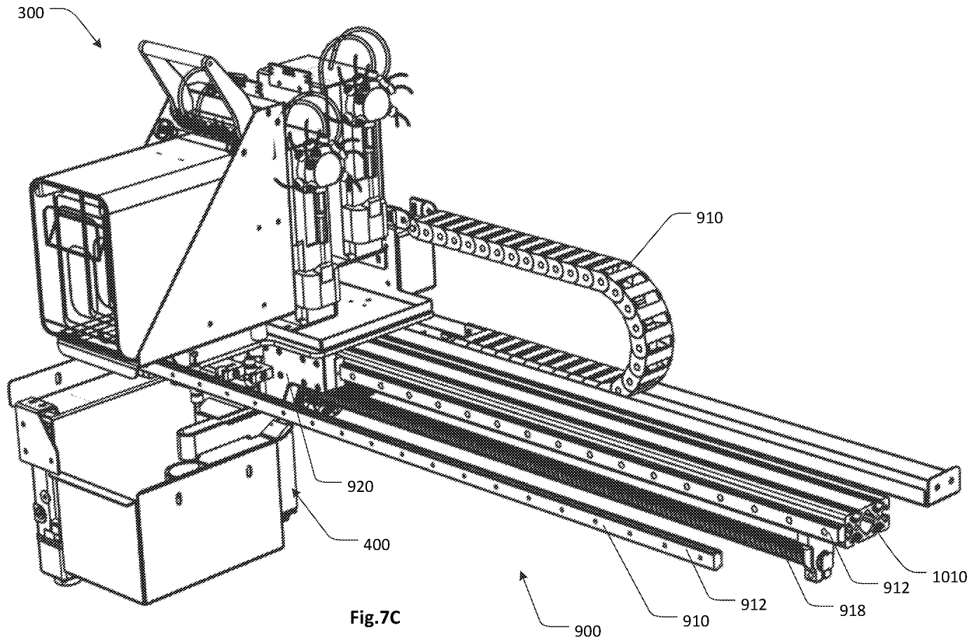

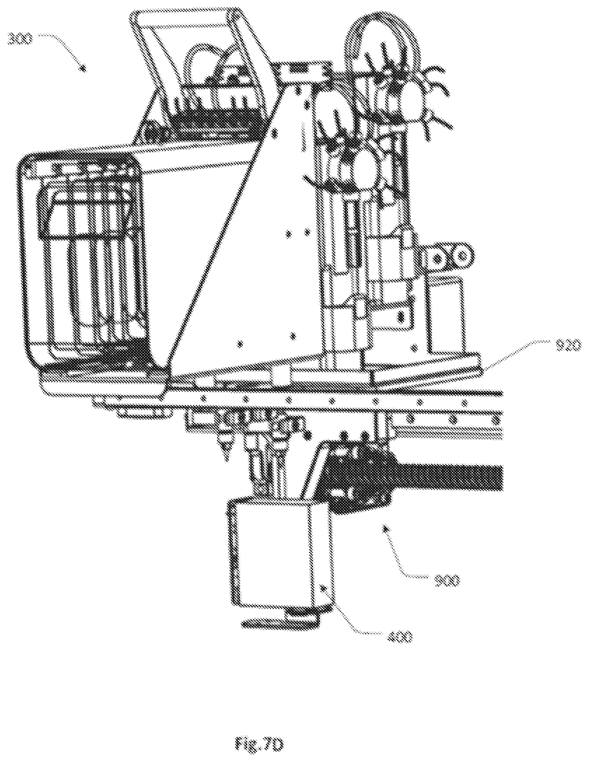

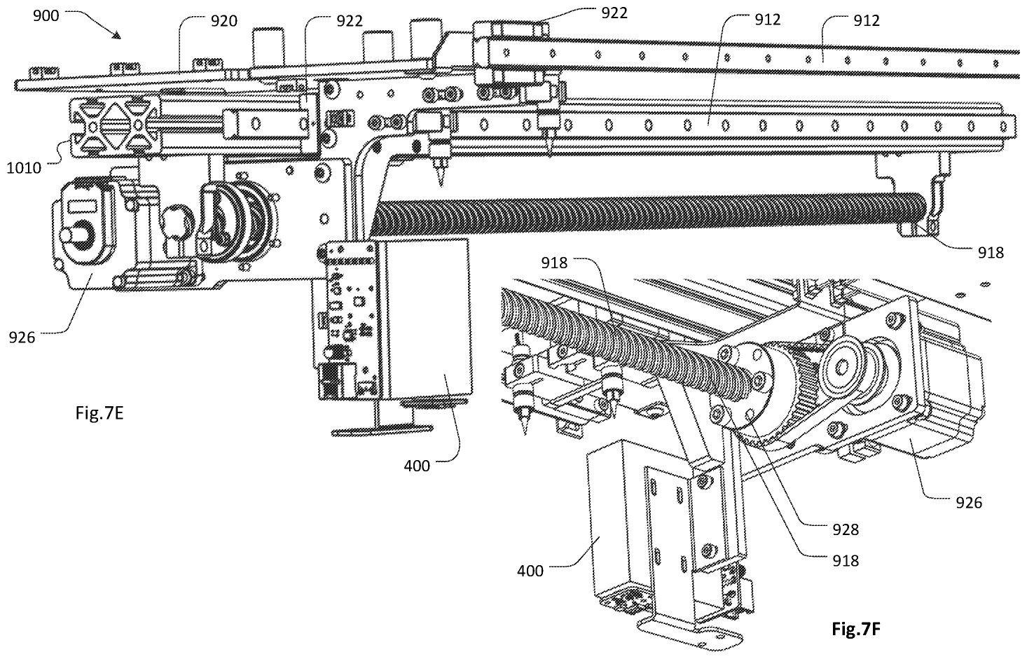

Referring to FIGS. 7A to 14K, an instrument 1000 is shown, according to some embodiments. The instrument 1000 may include any of the features described in relation to instrument 100 with reference to FIGS. 1 to 6, and similar features are indicated with like reference numerals.

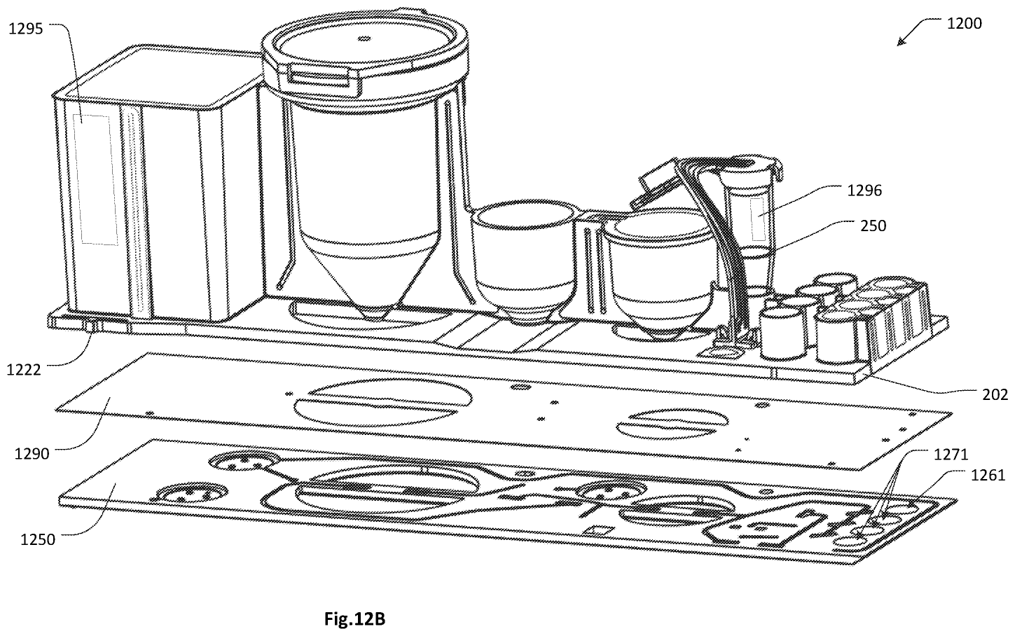

The instrument 1000 may be configured to receive one or more sample cartridges 200 or 1200 (e.g., see FIGS. 12A and 12B), each containing a sample for processing. The instrument 1000 may be configured to perform one or more operations on the sample, such as: chemical processing steps, heating, cooling, culturing, mixing, analysis or measurement, or nucleic acid extraction, as set out in relation to instrument 100.

The instrument 1000 may comprise similar modules as set out above, configured to perform the operations on the sample. These may include a reagent module 300, optics module 400, pneumatic module 500, thermal module 600, magnetic module 700, mixing module 800, motion module 900 and/or control module 101 to control the operations performed by the instrument 100. The instrument 1000 may have a power supply 102 or be connected to a power supply 102, as shown in FIG. 1A, to power the various modules.

Referring to FIG. 7A, the various modules of the instrument 1000 may be supported by a frame or chassis 1010. The frame 1010 may include viewing windows 1011 to allow viewing of instrument operations. In some embodiments, the instrument 1000 may comprise an opaque external housing covering most or all of the instrument modules when in operation. The following figures illustrate certain parts of the instrument 1000 with other parts (e.g., the frame 1010) omitted for clarity.

FIGS. 7A and 7B show the general arrangement of the reagent module 300, pneumatic module 500, motion module 900, and control module 101, according to some embodiments. The optics module 400 may be mounted on a carriage under the reagent module 300; hidden from view in FIGS. 7A and 7B, but visible in FIGS. 7C to 7F.

The instrument 1000 may comprises one or more core units 1100, for example, two core units 1100 are shown in the instrument 1000 in FIGS. 7A and 7B. Each core unit 1100 is configured to engage with a plurality of sample cartridges 200, 1200, such as 4 cartridges at once, for example. Each core unit 1100 may comprise an independent thermal module 600, magnetic module 700 and/or mixing module 800, while the reagent module 300, pneumatic module 500, motion module 900, and/or control module 101 may be shared between the core units 1100 and are configured to perform operations on cartridges 200, 1200 in each core unit 1100.

In some embodiments, each core unit 1100 may include other ones of the modules 300, 400, 500, 600, 700, 800, 900, which may be independent of other modules in other core units 1100. In some embodiments, other ones of the modules 300, 400, 500, 600, 700, 800, 900 may be shared between multiple core units 1100.

FIGS. 7C to 7F show the reagent module 300, optics module 400 and part of the motion module 900 in further detail, according to some embodiments.

The motion module 900 comprises a track 910 extending across the instrument 1000 supported by the frame 1010, and a carriage 920 (FIG. 7E) configured to move along the track 910. In some embodiments, as illustrated, the track 910 comprises rails, for example two rails 912, and the carriage 920 comprises corresponding sliders 922, for example, two corresponding sliders, configured to engage and slide along the rails 912 while supporting the carriage 920.

A suitable rail and carriage assembly is Linear rail—L1010.15.790 and Linear carriage L1010.C15 from Automotion components, for example.

The motion module 900 comprises a drive motor 926 mounted on the carriage 920 and configured to rotate a leadscrew nut 928 around a leadscrew 918. The leadscrew 918 may be fixed to the frame 1010 substantially parallel to the track 910. The leadscrew nut 928 may be rotatably mounted on the carriage 920 so that, as the leadscrew nut 928 is rotated, it progresses along the leadscrew 918 and moves the carriage 920 along the track 910.

A suitable leadscrew and leadscrew nut assembly is Leadscrew M18×24 mm pitch (e.g., Igus—DST-LS-18X24-R-ES) and Leadscrew nut M18×24 mm pitch (e.g., Igus—DST-JFRM-2835DS18X24). The leadscrew nut 928 may be mounted to the carriage via a Roller bearing—ID30 OD42×7 (e.g., Simply Bearings 561806-2RS) and rotation of the leadscrew nut 928 may be driven by Stepper Motor—PKP266D14A2—NEMA 24+LC2B06E cable from Oriental Motors, via a Pulley—T5 14Teeth 10 mm belt width with boss (14T 5-15-14) and Belt T5/245 49Teeth—10 mm wide (BT5/245/10) from HPC Gears, for example.

The optics module 400 is mounted to a lower bracket of the carriage 920 and is configured to be positioned below the cartridges 200, 1200 for quality control operations, in some embodiments.

The reagent module 300 may be mounted to an upper surface of the carriage 920, with outlet nozzles positioned below the carriage for dispensing reagents into the cartridges 200, 1200, as described in further detail below.

In some embodiments, the motor 926, reagent module 300 and optics module 400 are all connected to the control module 101 and power supply 102 via cables accommodated in a cable chain 121 (FIG. 7C), which allows for movement of the motor 926, reagent module 300 and optics module 400 along the track 910 with the carriage 920 while the control module 101 is fixed to the frame 1010.

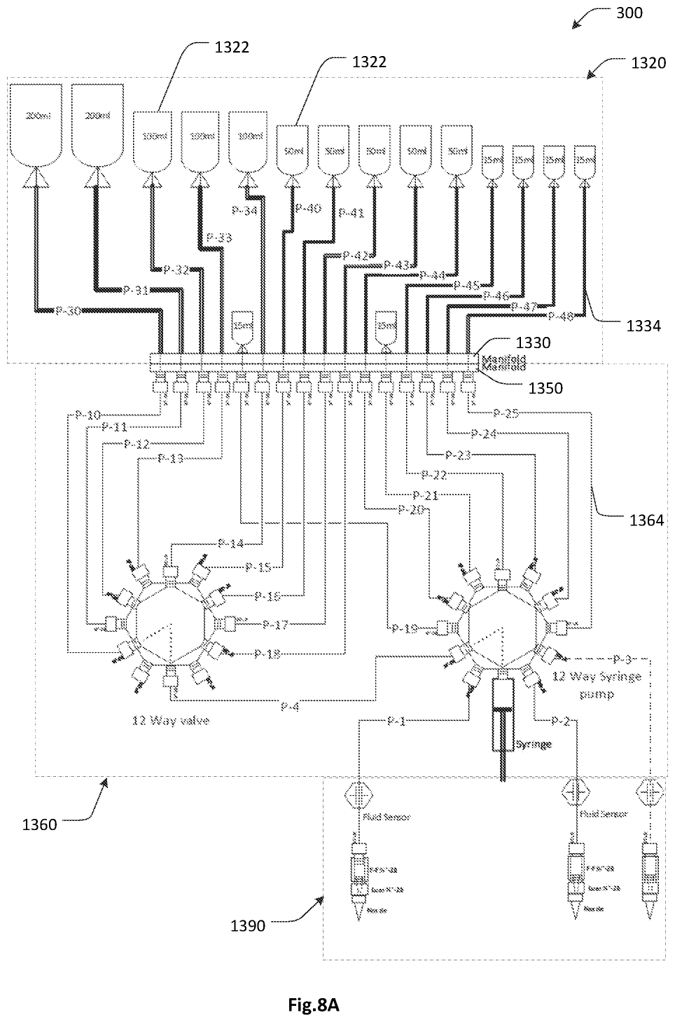

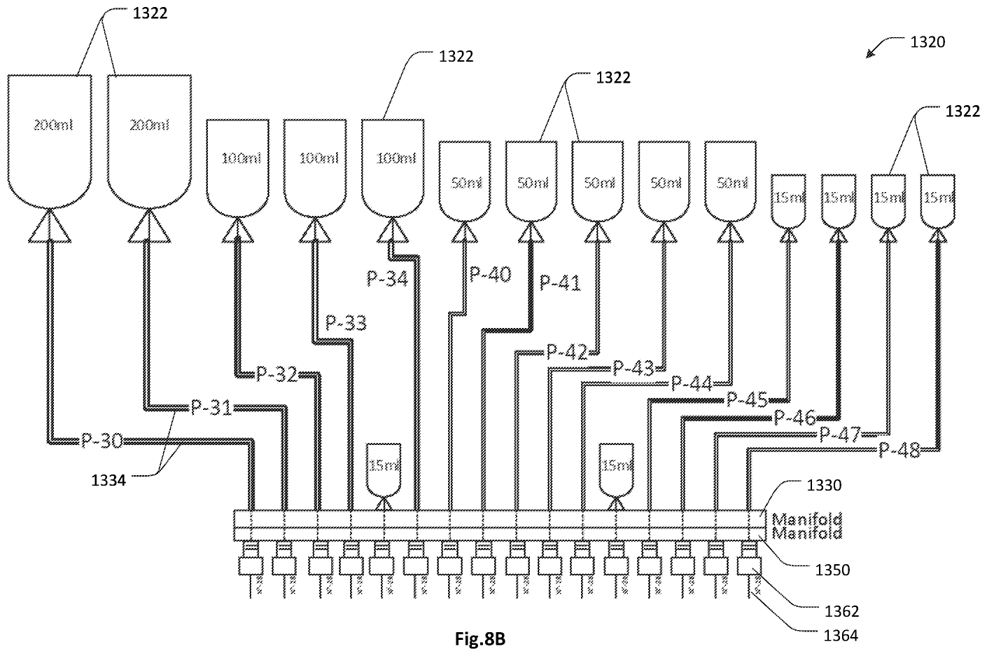

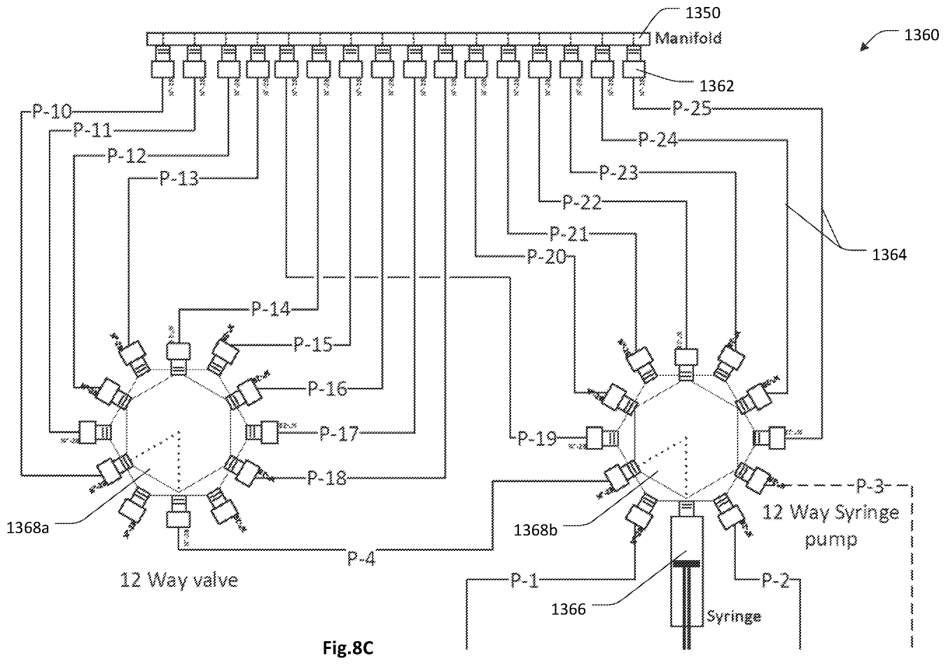

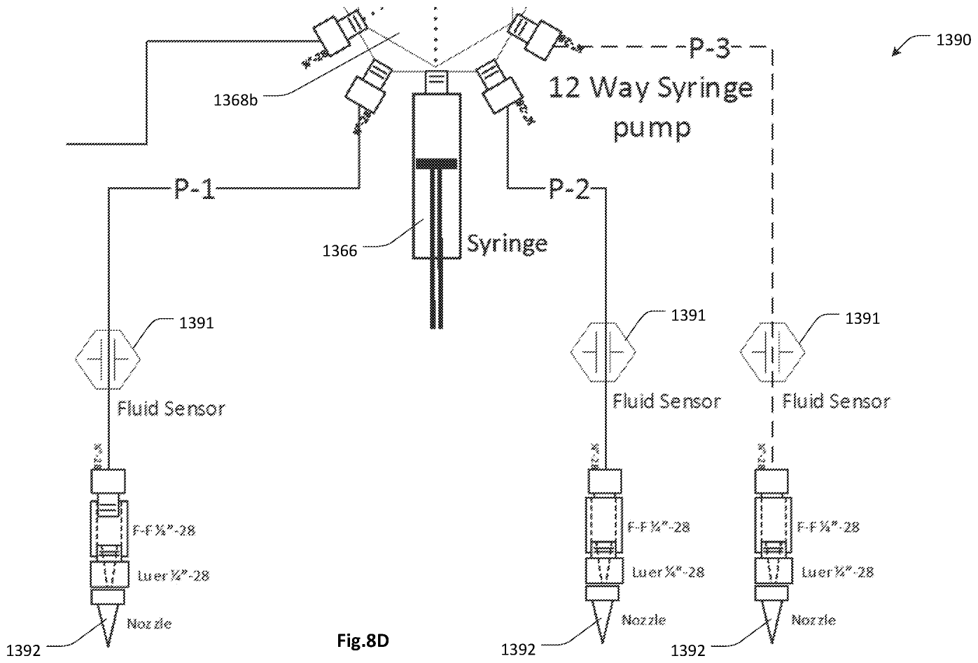

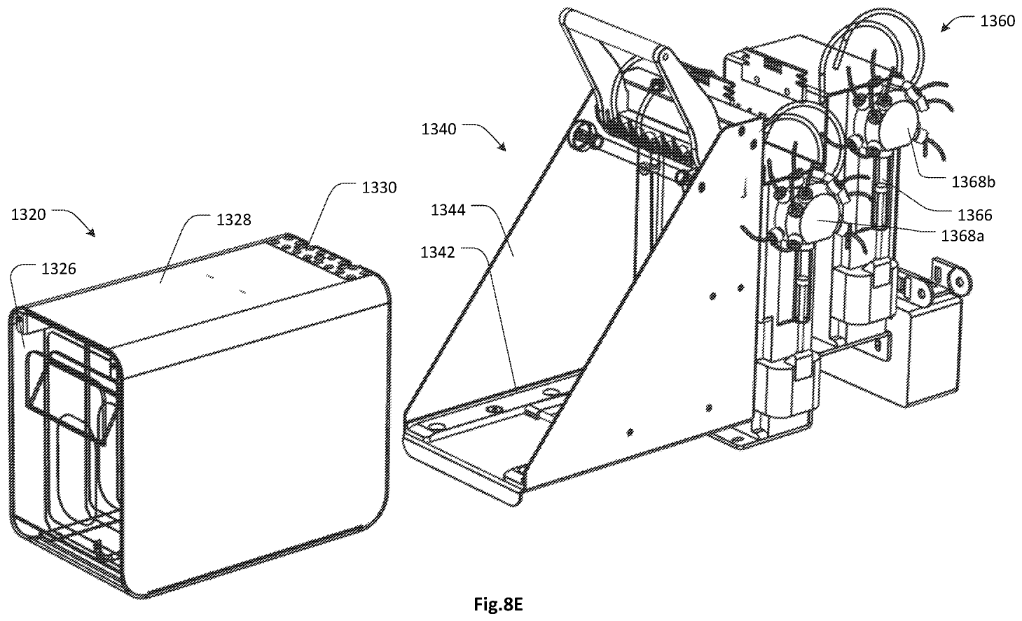

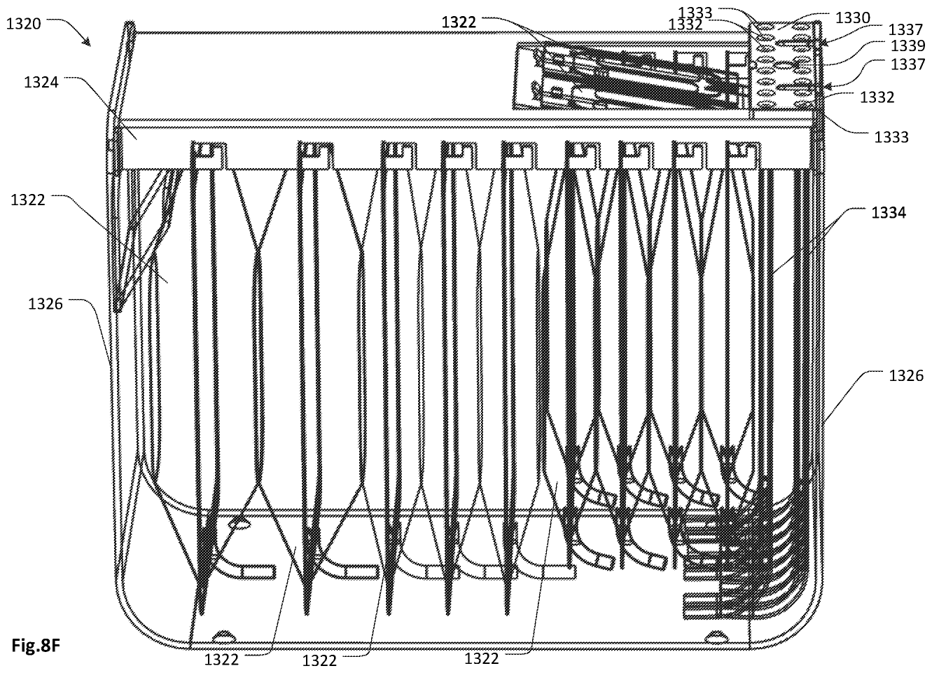

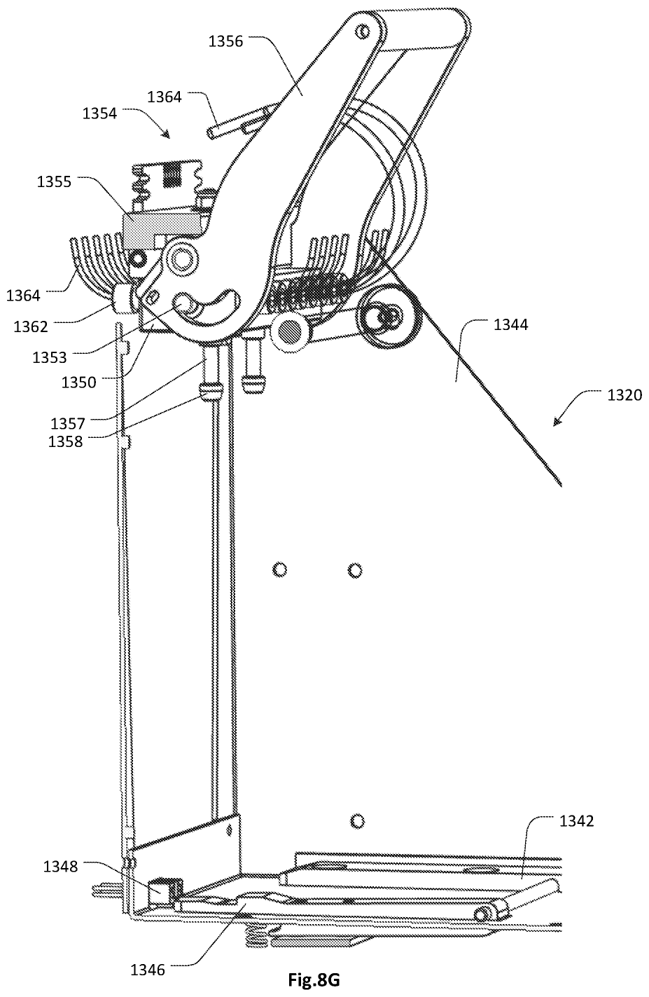

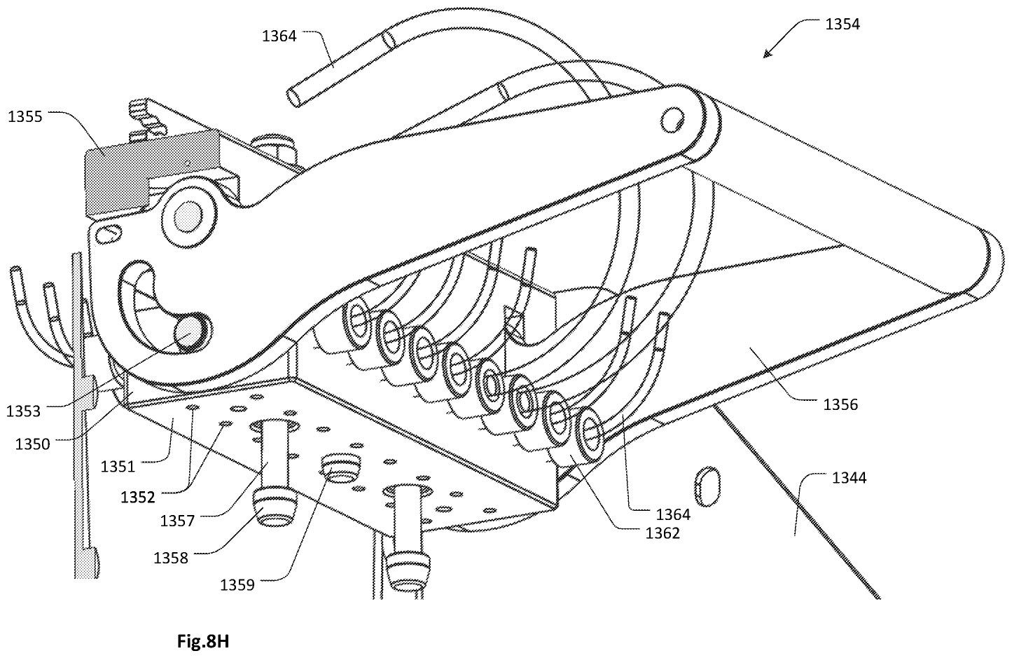

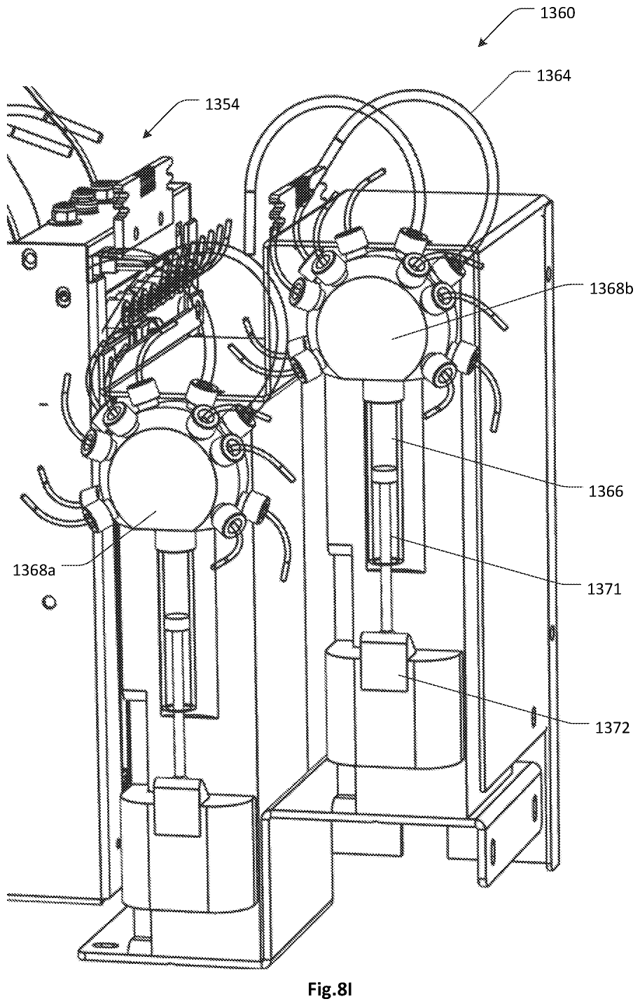

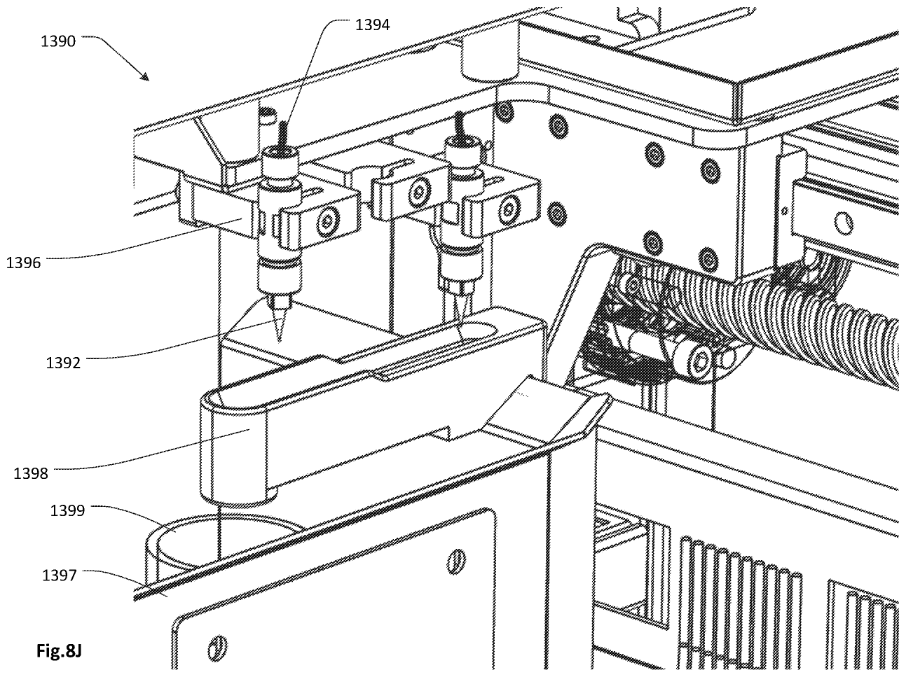

Referring to FIGS. 8A to 8J, the reagent module 300 is shown in further detail, according to some embodiments. The reagent module 300 comprises a reagent cartridge 1320, a pump portion 1360 and dispensing portion 1390. A schematic diagram of the reagent module 300 is shown in FIG. 8A with close-ups of each portion in FIGS. 8B, 8C and 8D, respectively. Perspective views of the reagent cartridge 1320 are shown in FIGS. 8E and 8F; the connection between the reagent cartridge 1320 and pump portion 1360 is shown in FIGS. 8G and 8H; a perspective view of the pump portion 1360 is shown in FIG. 8I and the dispensing portion 1390 is shown in FIG. 8J.

The reagent cartridge 1320 may comprise a removable reagent store that can be removed from the instrument 1000 to be replaced or refilled when the reagents are depleted. The reagent cartridge 1320 may be configured to be received in a reagent store support 1340 which is mounted on the carriage 920 along with the pump portion 1360.

The reagent cartridge 1320 may comprise a plurality of reagent reservoirs 1322 configured to accommodate various reagents to be dispensed into the sample cartridges 200, 1200 for processing. Any suitable number of reagent reservoirs 1322 may be provided depending on the number of different reagents required for a given process. The reagent cartridge 1320 shown includes 16 reagent reservoirs 1322, for example. Each reagent reservoir 1322 may comprise any suitable volume for a given application. Different ones of the reagent reservoirs 1322 may have different volumetric capacities to account for different reagents being consumed at different rates in instrument processes.

The reagent reservoirs 1322 may comprise any suitable form in any suitable arrangement within the reagent cartridge 1320. The reagent cartridge 1320 shown in FIG. 8F includes flexible bag reagent reservoirs 1322 arranged to hang from a support frame 1324 disposed near a top of the reagent cartridge 1320. The support frame 1324 defines a plurality of hooks configured to engage a top portion of each of the reagent reservoirs 1322 so that they hang down within an internal volume of the reagent cartridge 1320.

The reagent cartridge 1320 may be substantially rectangular (though could define other shapes) and comprises end walls 1326 and in some embodiments, an outer casing 1328 (FIG. 8E) to cover the top and sides of the reagent cartridge 1320.

The reagent cartridge 1320 may comprise a cartridge connection block 1330 or manifold, configured to fluidly connect the reagent reservoirs 1322 to the pump portion 1360. The cartridge connection block 1330 defines a flat surface 1331 defining a plurality of connection ports 1332 corresponding to each of the reagent reservoirs 1322. The reagent reservoirs 1322 may be fluidly connected to the connection ports 1332 by channels or tubes 1334. (note: parts of the tubes 1334 are omitted from FIG. 8F for clarity)

The cartridge connection block 1330 may define locating slots or recesses 1337, 1339 configured to receive corresponding locating pins 1357, 1359 to facilitate connection to the pump portion 1360.

Referring to FIGS. 8E and 8G, the reagent store support 1340 may comprise support rails 1342 configured to support the reagent cartridge 1320. the reagent store support 1340 may comprise a housing 1344 configured to surround part of the reagent cartridge 1320. The reagent cartridge 1320 can be slid into the housing 1344 on the rails 1342 to install the reagent cartridge 1320 in the reagent store support 1340.

The reagent store support 1340 further comprises a spring-loaded retention clip 1346 biased to a retention position such that as the reagent cartridge 1320 is installed in the reagent store support 1340, the clip 1346 is depressed by part of the reagent cartridge 1320 and then returns to the retention position once the reagent cartridge 1340 is fully installed to restrict removal of the reagent cartridge 1320. The retention clip 1346 may also be manually depressed with a side tab in order to allow removal of the reagent cartridge 1320. Alternatively, an automatic or electronically activated retention mechanism may be used to hold the reagent cartridge 1320 in place.

The reagent store support 1340 may further comprise a sensor 1348 coupled to the control module 101, such as an optical sensor, for example, to indicate when the reagent cartridge 1320 is properly installed in the reagent store support 1340 with the retention clip 1346 engaged.

The pump portion 1360 comprises a pump connector block 1350 or manifold configured to connect with the cartridge connection block 1330 to fluidly connect the reagent cartridge 1320 with the pump portion 1360.

The pump connector block 1350 defines a flat surface 1331 defining a plurality of connection ports 1352 corresponding to connection ports 1332 of the cartridge connection block 1330, as shown in FIG. 8H.

The reagent module 300 comprises a connector clamp mechanism 1354. The connector clamp mechanism 1354 may be mounted on the reagent store support 1340 and may be configured to clamp the pump connector block 1350 and cartridge connector block 1330 together with the connection ports 1332, 1352 aligned to fluidly connect each corresponding pair of connection ports 1332, 1352. The one or both of the connector blocks 1330, 1350 may comprise gaskets 1333 configured to seal around the connection between each pair of corresponding connection ports 1332, 1352. For example, the gaskets 1333 may comprise o-rings set in gasket seats around each of the connection ports 1332 of the cartridge connector block 1330, as shown in FIG. 8F.

The clamp mechanism 1354 may comprise a stationery block 1355 and a mechanical linkage 1356 rotatably coupled to the stationery block 1355. The mechanical linkage 1356 may also comprise a handle for operating the clamp mechanism 1354. Alternatively, the clamp mechanism may be controlled electronically with an actuator, such as a motor, for example, which may be operated automatically or via the user interface to fluidly connect the reagent cartridge 1320 to the pump portion 1360 when the reagent cartridge 1320 is installed.

In some embodiments, the clamp mechanism 1354 may further comprise two protrusions 1357 that extend away from the stationery block 1355 and through holes in the pump connector block 1350, such that the pump connector block 1350 can slide along the protrusions 1357. The mechanical linkage 1356 may be slidably coupled to side pins 1353 extending from either side of the pump connector block 1350, such that as the mechanical linkage 1356 is rotated relative to the stationery block 1355, the pump connector block 1350 slides up and down along the protrusions 1357.

This movement can be seen when comparing FIG. 8G, showing the clamp mechanism 1354 and pump connection block 1350 in a raised or disconnected configuration, and 8H, showing the clamp mechanism 1354 and pump connection block 1350 in a lowered configuration for connection to the cartridge connection block 1330.

The protrusions 1357 of the clamp mechanism 1354 may also serve as locating pins which are received in the locating slots 1337 in the cartridge connector block 1330 when the reagent cartridge 1320 is installed in the reagent store support 1340. Each of the protrusions 1357 may comprise a head 1358 which is relatively wider in diameter than part of the locating slots 1337 such that, when the clamp mechanism 1354 is operated to clamp the connector blocks 1330, 1350 together, the cartridge connector block 1330 is clamped between the protrusion heads 1358 and the pump connector block 1350.

The pump connector block 1350 may further comprise one or more surface locating pins 1359 configured to be received vertically in a corresponding locating recess 1339 in the surface 1331 of the cartridge connector block 1330 to assist in aligning the corresponding pairs of connection ports 1332, 1352.

The pump connector block 1350 defines a plurality of tube outlets 1362 to fluidly connect the connection ports 1352 to corresponding tubes 1364 of the pump portion 1360.

Referring to FIGS. 8C and 8I, the pump portion 1360 comprises a system of one or more pumps 1366 and one or more valves 1368 configured to allow dispensing of selected reagents from the reagent cartridge 1320. Any suitable arrangement of pumps and valves may be used for a given application. In the illustrated embodiment, the tubes 1364 connect the connection ports 1352 of the pump connector block 1350 to two dispensing tubes 1394 (optionally 3 or more dispensing tubes) via two 12-way valves 1368 and a pump 1366.

For example, the pump 1366 and valves 1368 may comprise two Tecan Centris pumps (CG CM 30063057 or 30039102) with Tecan 12-way ceramic valves (12+1/4-28 CM 30038192 or 30077366) and a Tecan Ball end Syringe (1.0 ml 20728662). The first syringe pump 1368a is configured to operate only as a valve, while the second syringe pump 1368b is configured to operate as a combined valve and pump. The syringe pump 1366 comprises a syringe 1371 and linear actuator 1372 connected to the control module 101 and configured to move the plunger of the syringe 1371 to draw precise volumes of reagents into the syringe and then pump them out again to dispense the reagents into the sample cartridges 200, 1200. The control module 101 is also configured to operate the valves 1368 to connect any two of the valve ports.

As shown in FIG. 8C, nine of the connection tubes 1364 (P-10 to P-18) connect the connection ports 1352 from the pump connector block 1350 to the first valve 1368a, and the remaining seven connection tubes 1364 (P-19 to P-25) connect the connection ports 1352 from the pump connector block 1350 to the second valve 1368b, with an additional connection tube P-4 connecting the first valve 1368a to the second valve 1368b. Two dispensing tubes 1394 (P-1, P-2 and optionally P-3) connect the second valve 1368b to dispensing nozzles 1392 in the dispensing portion 1390.

This arrangement allows any of the reagents in the reagent reservoirs 1322 to be selected by operating the valves 1368 to select the corresponding connection tube 1364, which is connected to the reagent reservoir 1322 via the corresponding reagent cartridge tube 1334 and corresponding connected connection ports 1332, 1352. The syringe pump 1366 can then be operated to draw a precise volume of reagent into the syringe, according to operating instructions from the control module 101. The second valve 1368b can then be adjusted to connect the pump 1366 to a selected one of the dispensing nozzles 1392 and the pump 1366 can be operated to dispense the reagent through the selected dispensing nozzle 1392.

The dispensing nozzles 1392 are shown in FIGS. 8D and 8J. The nozzles 1392 may comprise Preci-tip nozzle (IDMSPREC30-PB-EN), for example, connected to the dispensing tubes 1394 via a ¼″-28 straight adaptor and ¼″-28 Luer fitting, for example.

The nozzles 1392 may be connected to the carriage 920 by nozzle clamps 1396 and positioned below (or to the side of) the reagent store support 1340 such that the carriage 920 can be moved to position the nozzles 1392 over the reagent vessel 230 of a sample cartridge 200, 1200 for reagent dispensing.

In the illustrated embodiment, one of the nozzles 1392 may be configured to dispense reagents into the reagent vessel 230, and the other nozzle 1392 may be configured to dispense buffer solution into the QC buffer vessel 265 and the three QC reference buffer vessels 275.

The dispensing portion 1390 may further comprise a fluid sensor 1391 associated with each one of the nozzles 1392. The fluid sensors 1391 may be connected to the control module 101 and configured to indicate when fluid (or an air bubble) is present in the dispensing tube 1394 adjacent the nozzle 1392. This may be useful as a signal to the control module 101 that the dispensing of a particular reagent has commenced or has been completed. The fluid sensors 1391 may comprise optical sensors with a light source disposed on one side of the tube 1394 and a light detector disposed on an opposite side of the tube 1394, such that the presence of fluid in the tube 1394 reduces the intensity of light detected by the light detector. For example, one suitable optical sensor for this purpose is Optek Technology Optical Sensor Liquid 0.125″ (3.18 mm) Phototransistor Module (OPB350W125Z).

The illustrated embodiment includes two nozzles 1392 with provision for an optional third nozzle 1392 for applications which require it. In other embodiments, only one dispensing nozzle 1392 may be required, or additional nozzles 1392, such as 3, 4, 5, 6 or more may be included depending on the application. In some embodiments, different dispensing nozzles may be used for different reagents being dispensed into a single reagent vessel of a cartridge 200, 1200, or different dispensing nozzles 1392 may be arranged to dispense reagents into a plurality of different vessels on a sample cartridge.

The reagent reservoirs 1322 and connection tubes 1334, 1364, 1394 may be formed of any suitable material for the reagents to be used, such as polytetrafluoroethylene (PTFE) or silicone, for example, or other suitable polymers. In some embodiments, different materials and/or tube sizes may be required for different reagents in the system. For example, some reagents may require particular non-reactive materials, or may have a particular viscosity that requires a particular inner diameter to avoid leaving a residue or to reduce flow resistance.

Materials and tube dimensions for the illustrated embodiment are shown in the table below for exemplary purposes only.

| | OD | ID | | | OD | ID | |
|---|---|---|---|---|---|---|---|
| Tube | (mm) | (mm) | Material | Tube | (mm) | (mm) | Material |
| P-1 | 1.6 | 0.8 | PTFE | P-25 | 1.6 | 0.8 | PTFE |
| P-10 | 3.2 | 1.6 | PTFE | P-3 | 1.6 | 0.8 | PTFE |
| P-11 | 3.2 | 1.6 | PTFE | P-30 | 4 | 2 | Silicone |
| P-12 | 3.2 | 1.6 | PTFE | P-31 | 4 | 2 | Silicone |
| P-13 | 3.2 | 1.6 | PTFE | P-32 | 4 | 2 | Silicone |
| P-14 | 3.2 | 1.6 | PTFE | P-33 | 4 | 2 | Silicone |
| P-15 | 3.2 | 1.6 | PTFE | P-34 | 4 | 2 | Silicone |
| P-16 | 3.2 | 1.6 | PTFE | P-4 | 1.6 | 0.8 | PTFE |
| P-17 | 3.2 | 1.6 | PTFE | P-40 | 3 | 1 | Silicone |
| P-18 | 1.6 | 0.8 | PTFE | P-41 | 3 | 1 | Silicone |
| P-19 | 1.6 | 0.8 | PTFE | P-42 | 3 | 1 | Silicone |
| P-2 | 1.6 | 0.8 | PTFE | P-43 | 3 | 1 | Silicone |
| P-20 | 1.6 | 0.8 | PTFE | P-44 | 3 | 1 | Silicone |
| P-21 | 1.6 | 0.8 | PTFE | P-45 | 3 | 1 | Silicone |
| P-22 | 1.6 | 0.8 | PTFE | P-46 | 3 | 1 | Silicone |
| P-23 | 1.6 | 0.8 | PTFE | P-47 | 3 | 1 | Silicone |
| P-24 | 1.6 | 0.8 | PTFE | P-48 | 3 | 1 | Silicone |

Referring to FIG. 8J, the instrument 1000 may further comprise a reagent waste receptacle 1397. For example, the waste receptacle 1397 may comprise a drip tray fixed to the instrument frame 1010 and positioned under a rest position of the dispensing nozzles 1392 (for when dispensing operations are not occurring) to catch any drips from the dispensing nozzles 1392.

The waste receptacle 1397 may further comprise a gutter 1398 configured to catch drips from the dispensing nozzles 1392 and direct the reagents into a bottle or other container 1399 in the drip tray which can be removed periodically by a user to discard the waste reagents. This may also be useful for flushing reagents from the dispensing tubes 1394 and nozzles 1392 with a buffer solution, for example, if contamination of subsequent reagents is to be avoided.

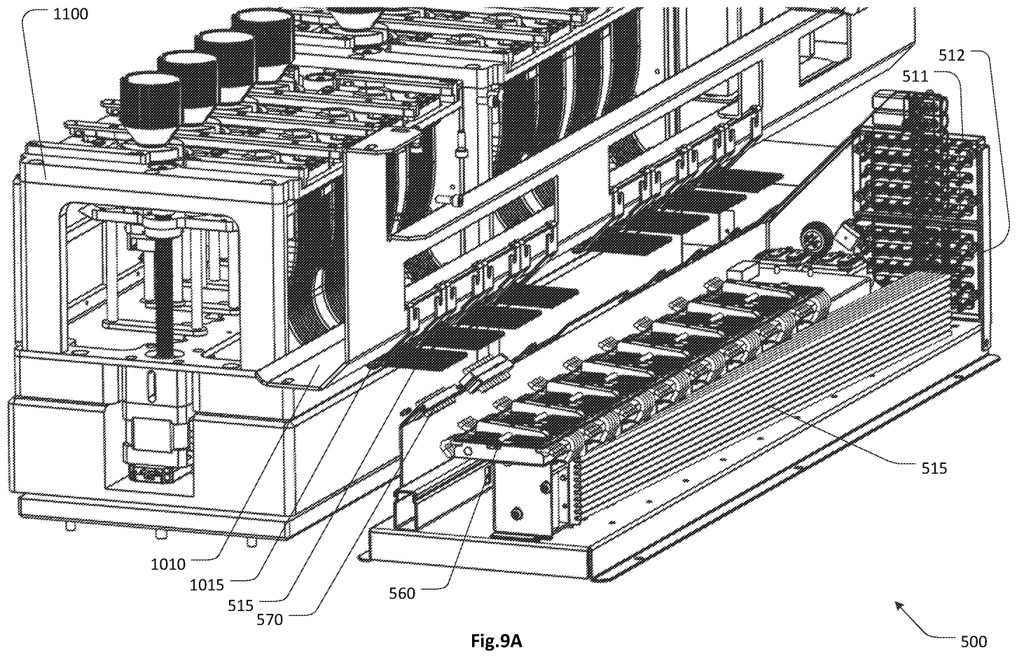

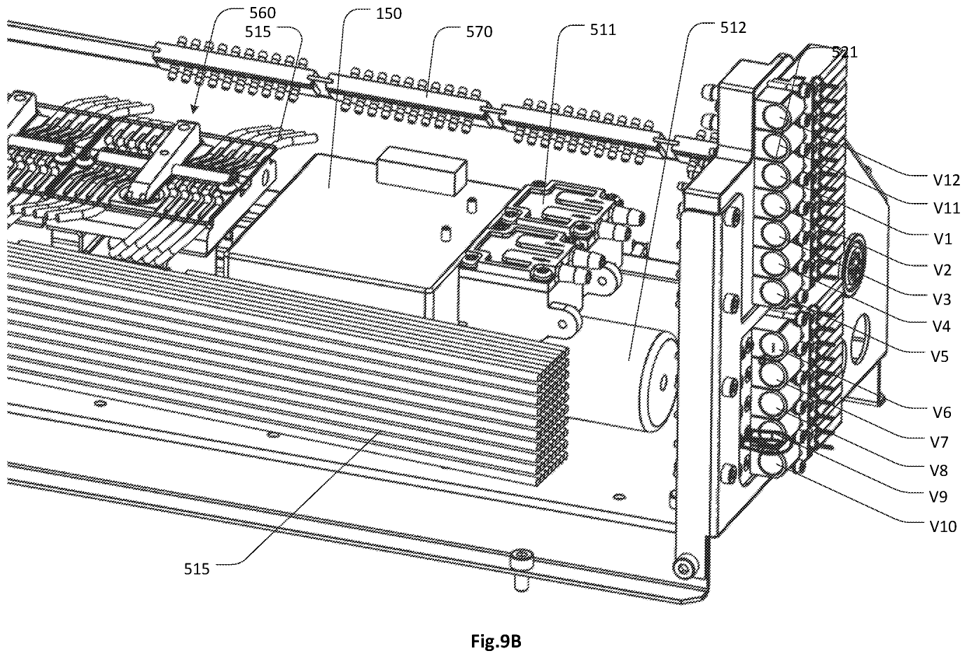

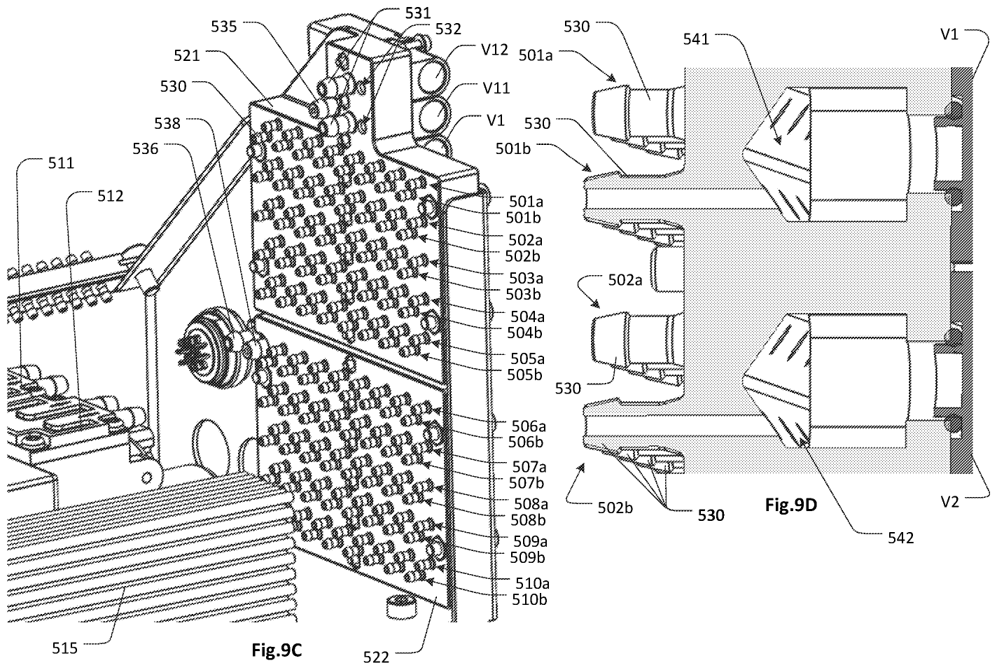

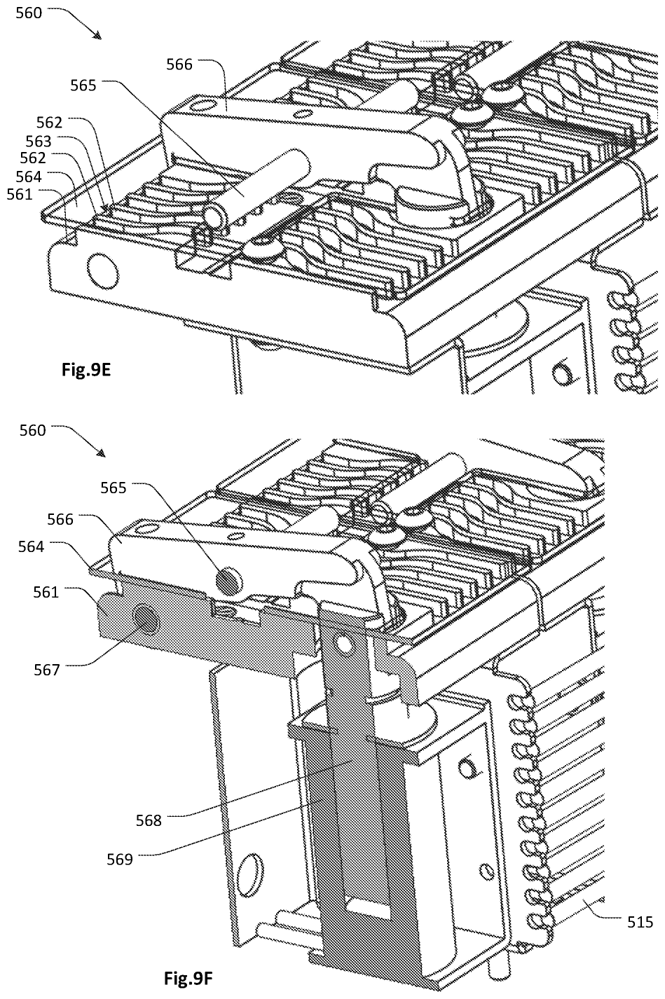

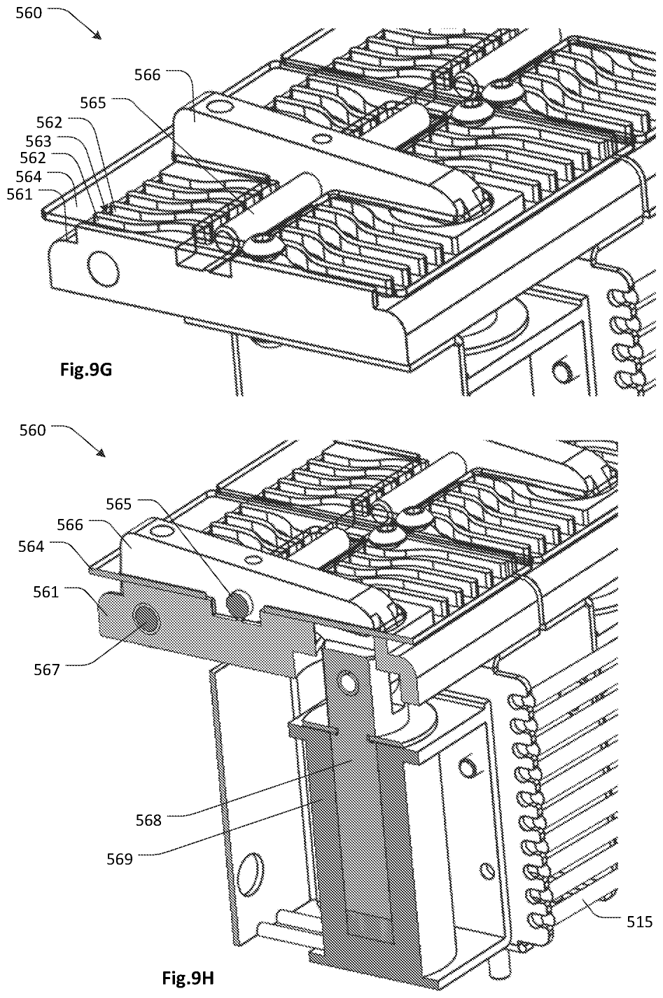

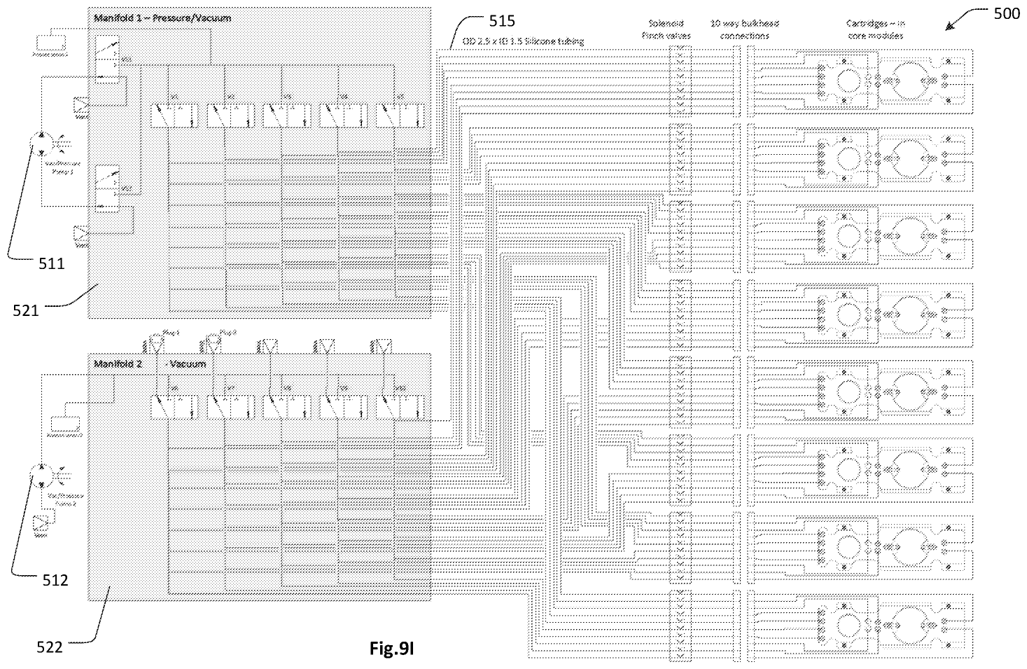

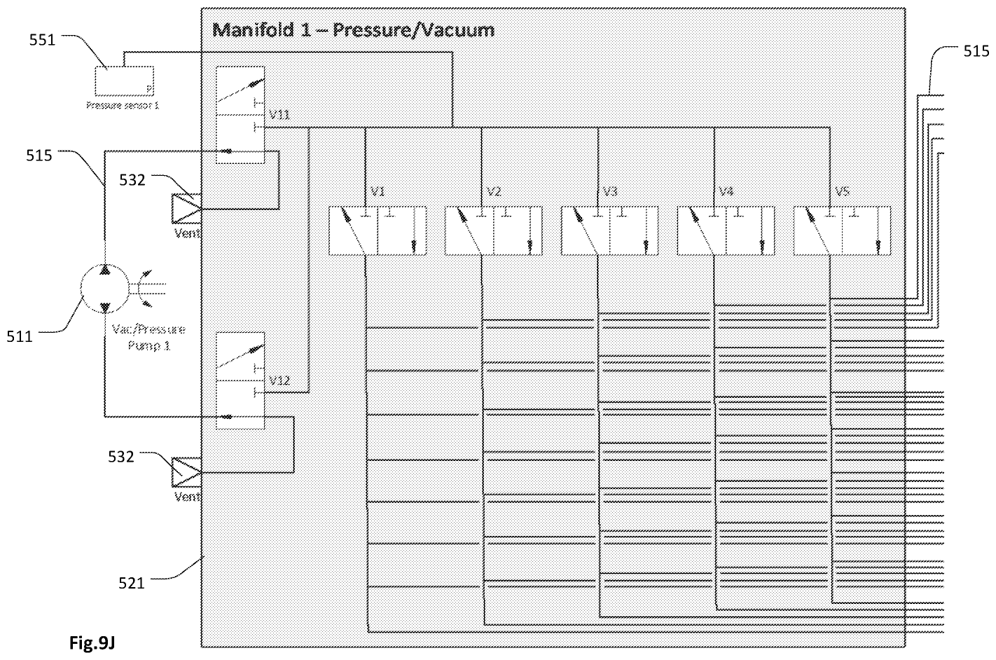

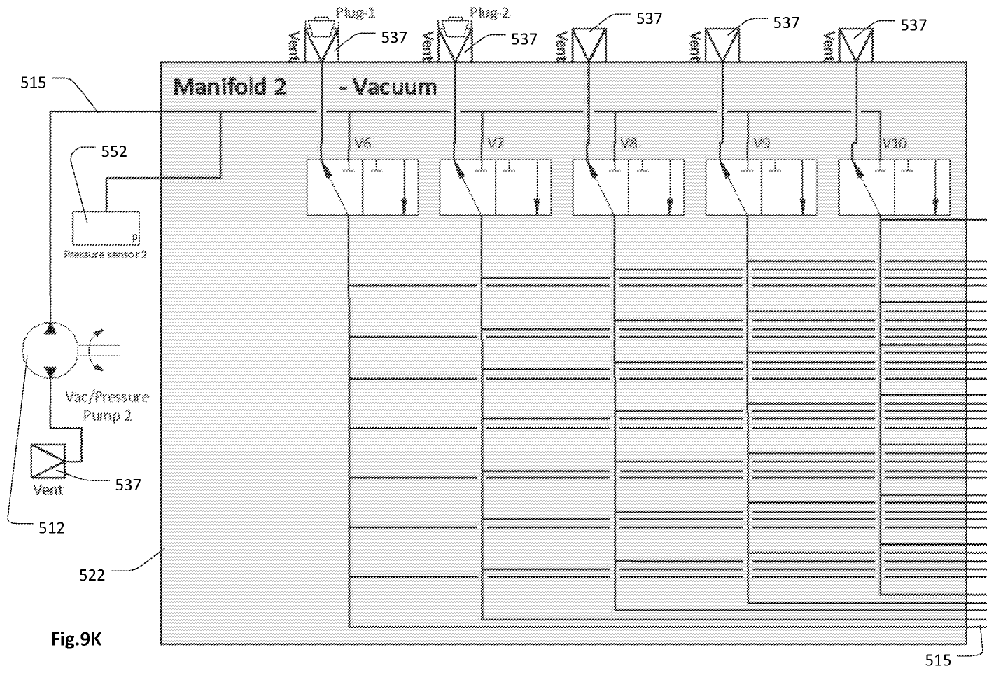

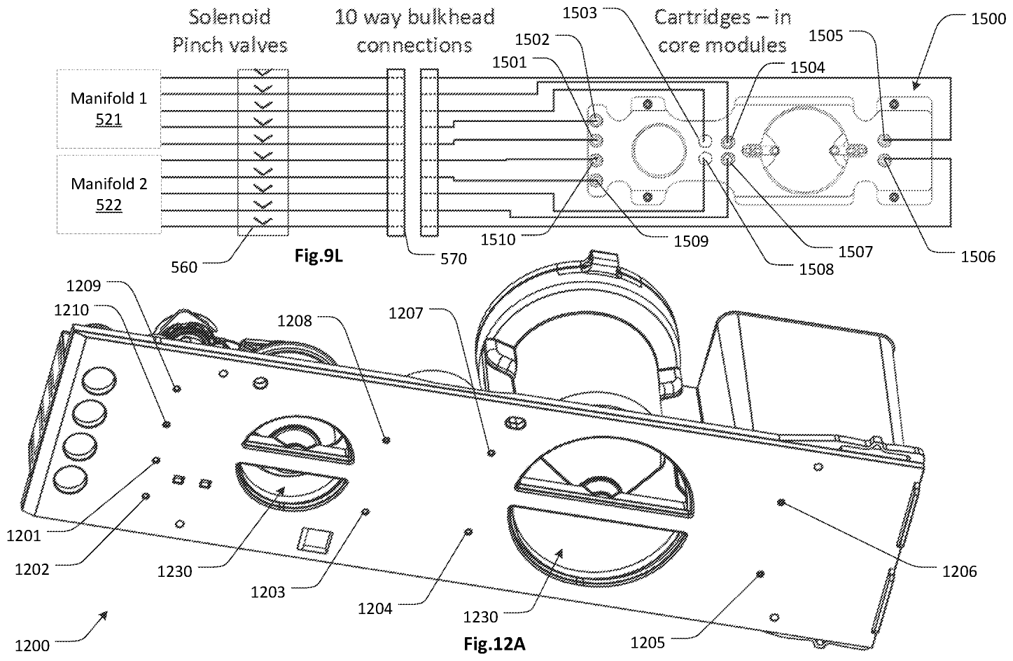

Referring to FIGS. 9A to 9L, the pneumatic module 500 is shown in further detail. The pneumatic module 500 comprises one or more compressors or vacuum pumps, and a network of pneumatic lines (or tubes) and valves configured to connect the one or more compressors to the sample cartridges 200, 1200 to adjust the pressure in different channels and vessels of the sample cartridges 200, 1200 to control fluid flow therein.

Different numbers of tubes may be required for different embodiments depending on the number of cartridges 200, 1200 that the instrument 1000 is configured to accommodate, as well as the layout of the cartridges 200, 1200 and number of pneumatic ports requiring pressure control.

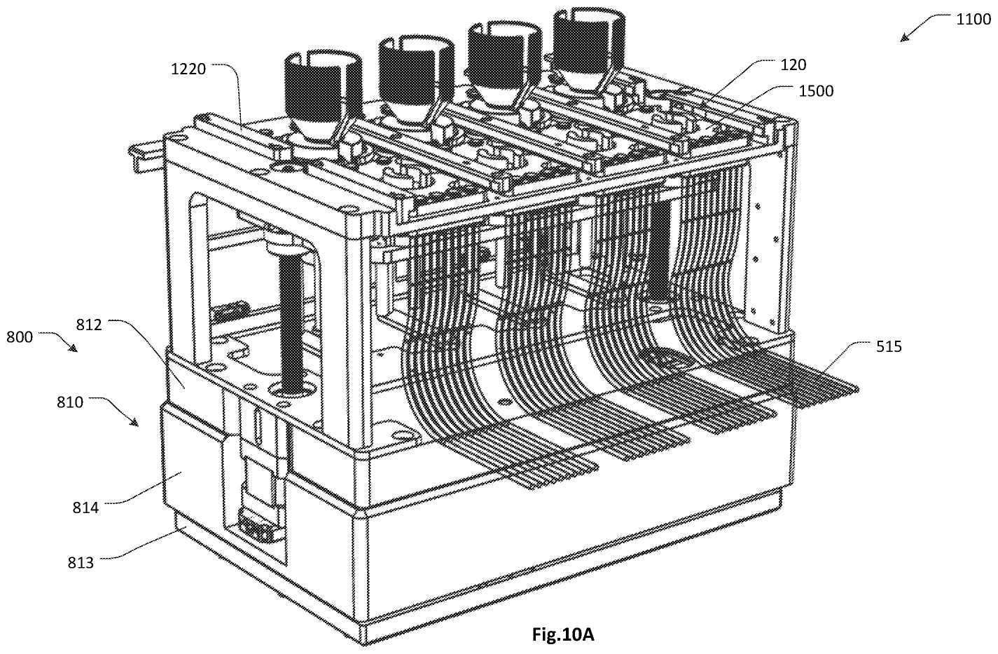

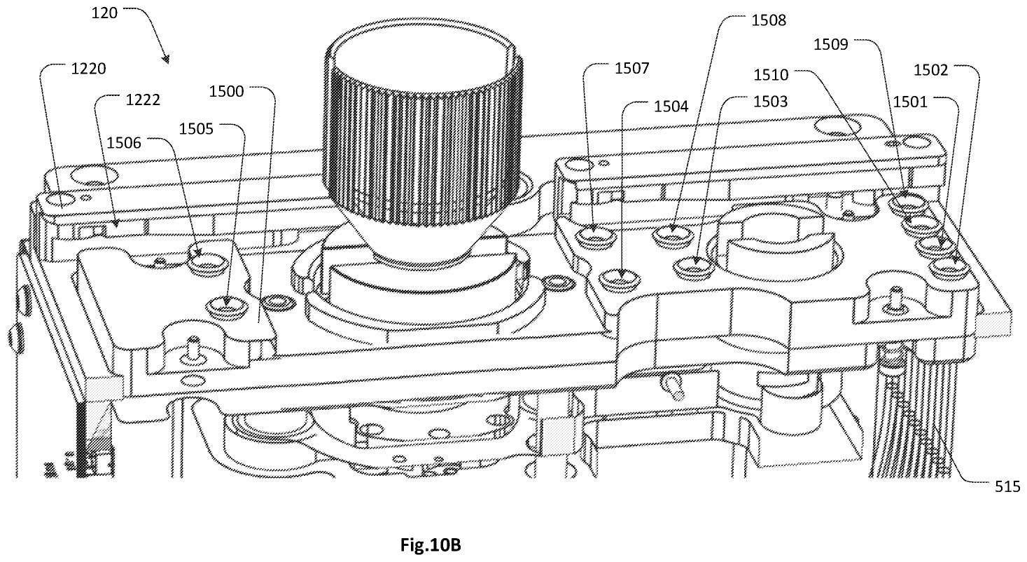

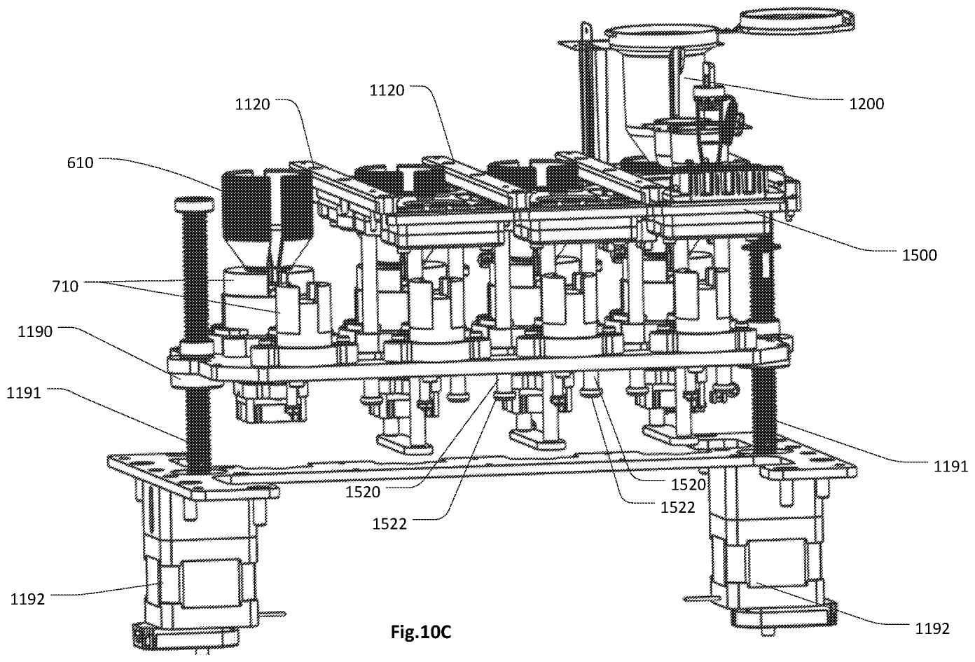

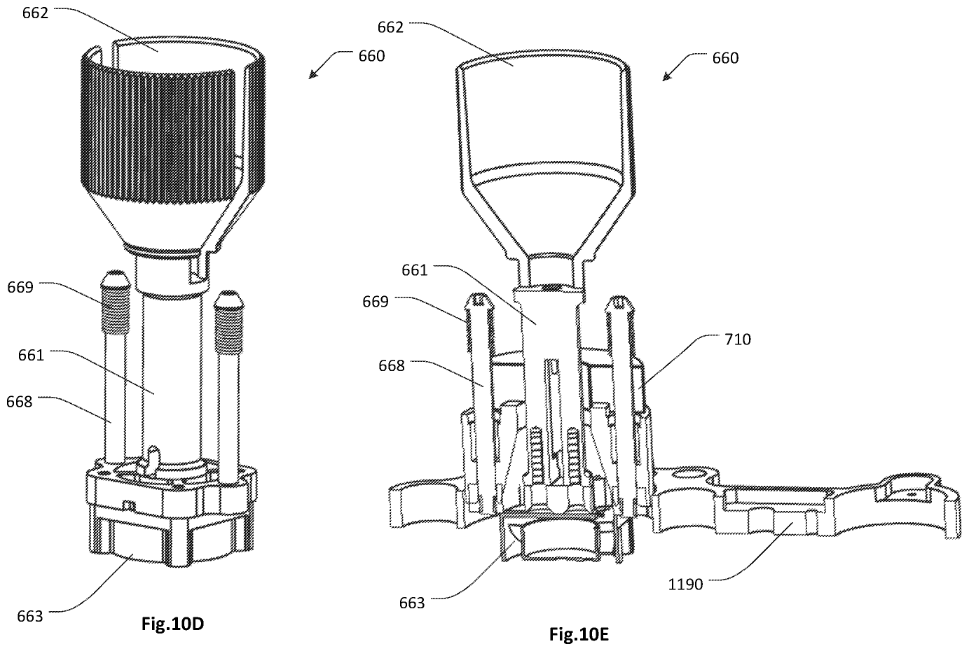

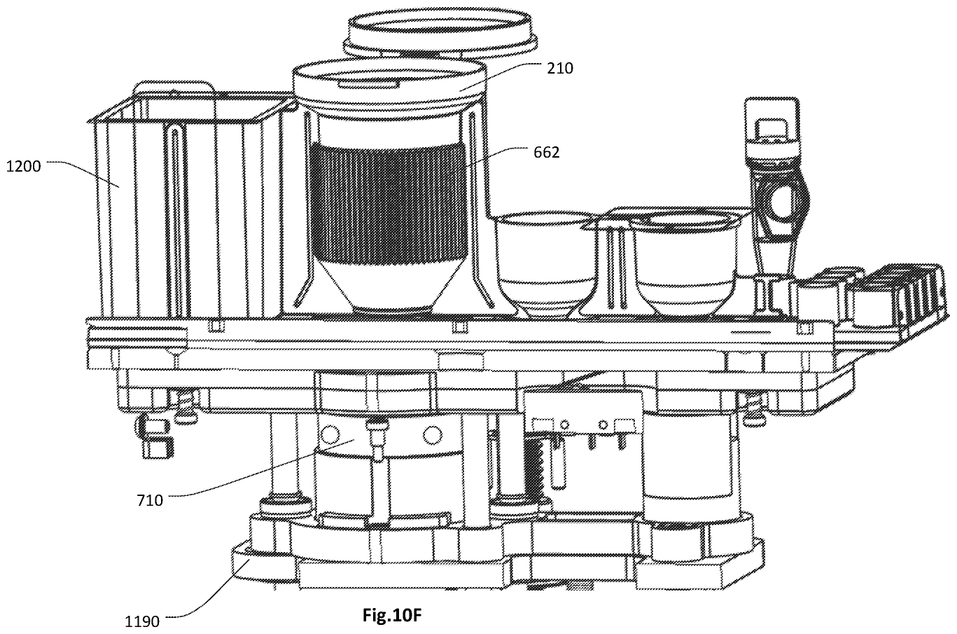

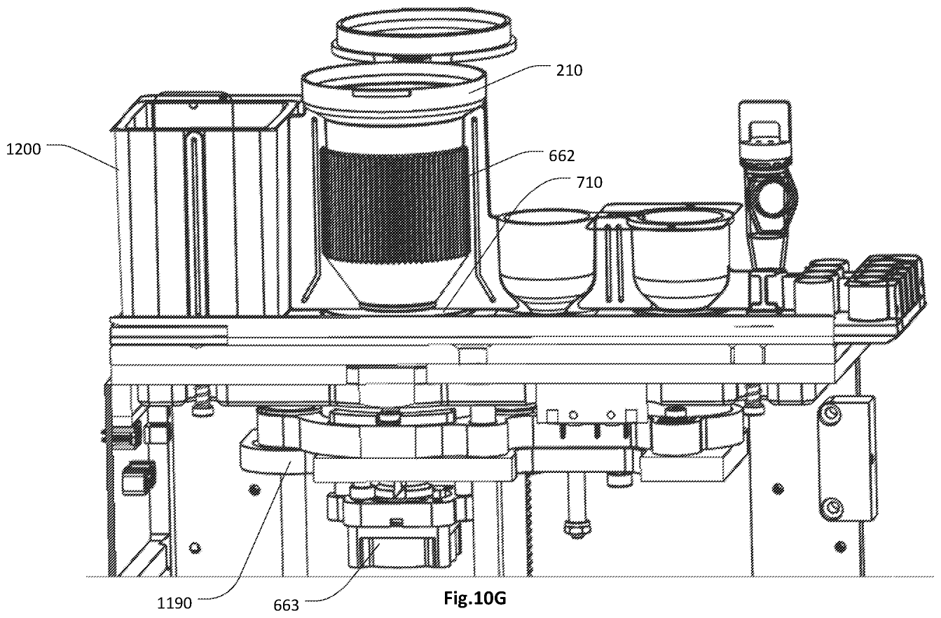

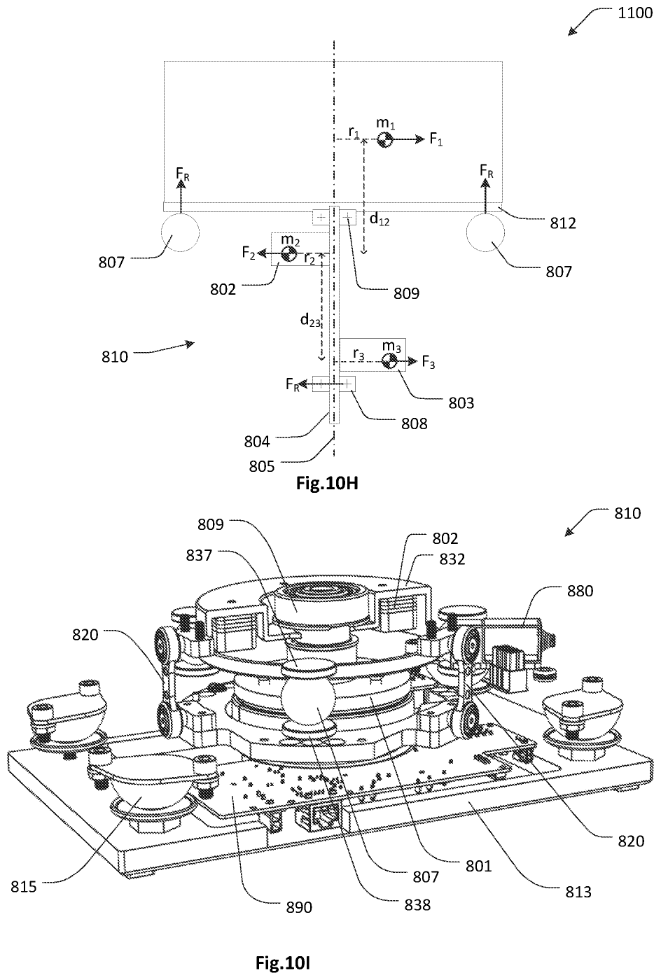

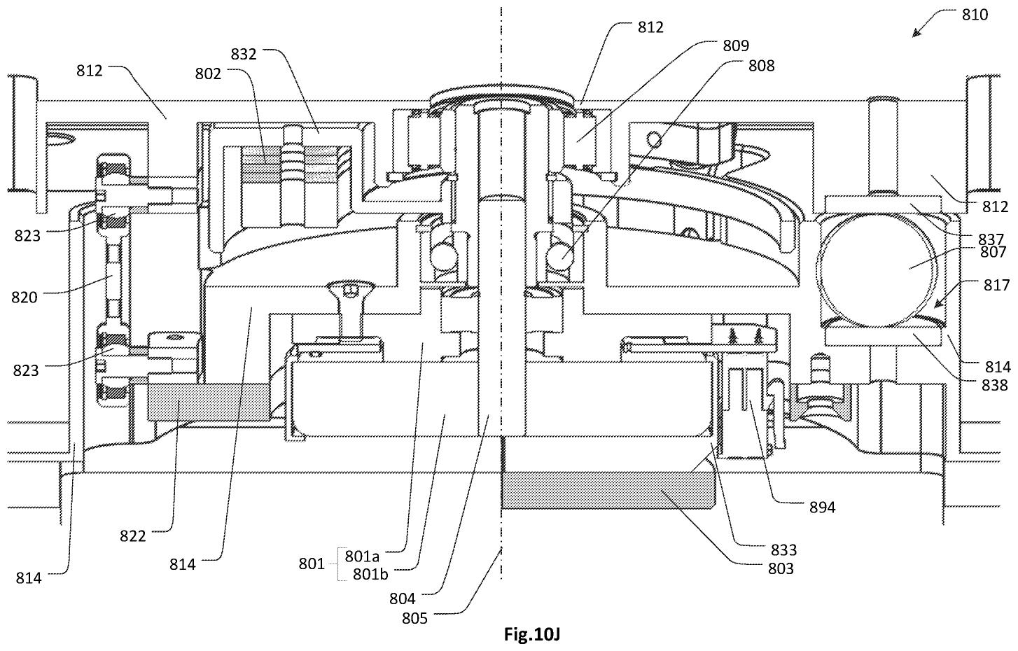

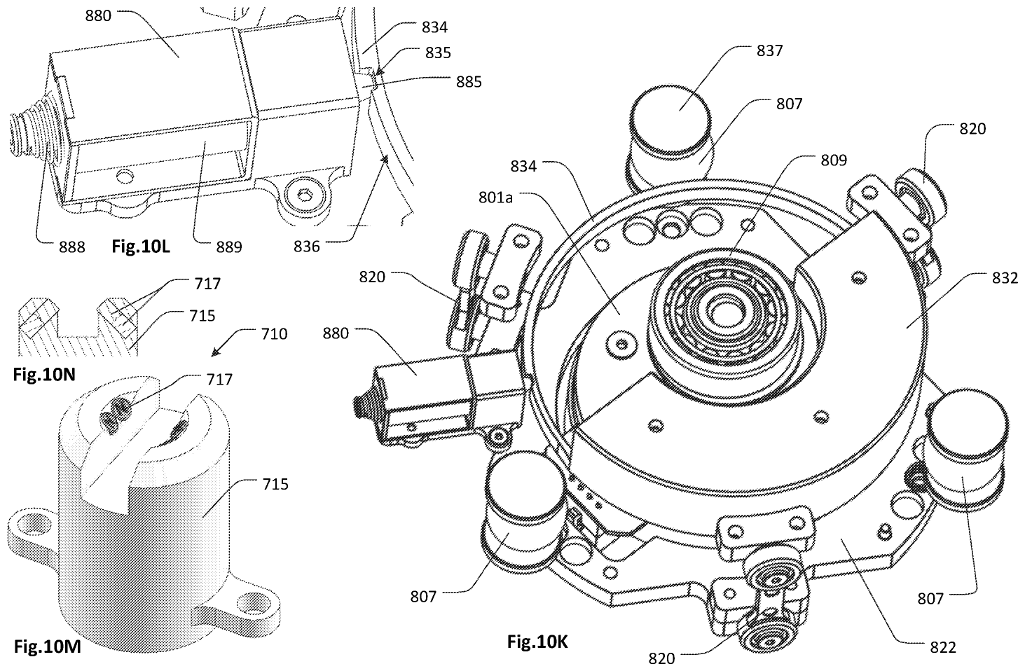

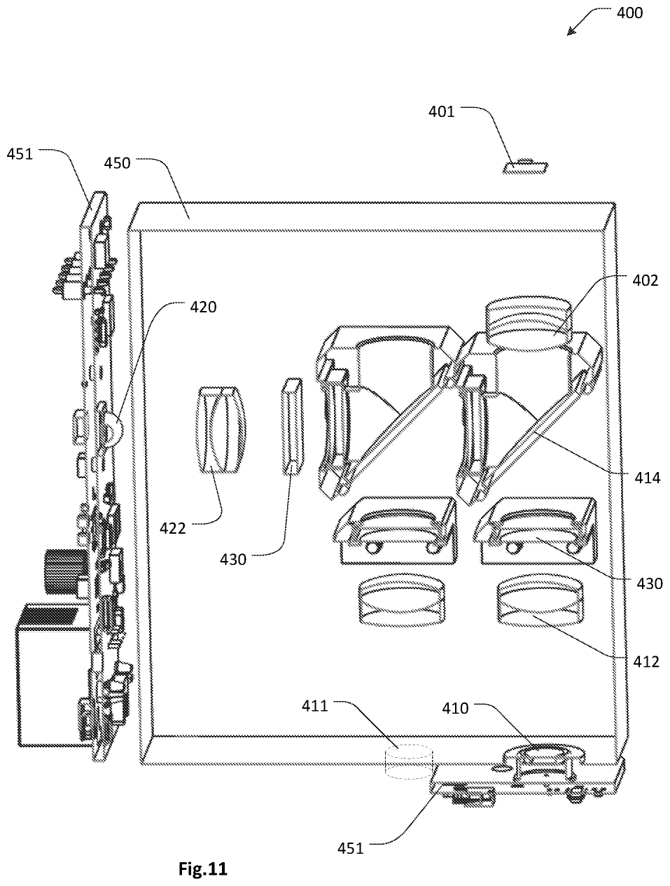

The illustrated embodiment of the instrument 1000 includes two core units 1100, each configured to receive four sample cartridges 1200, and each sample cartridge 1200 defining 10 pneumatic ports configured to be connected to the pneumatic module 500 to control fluid movement within the cartridge 1200. (see FIGS. 12A and 10B)

This corresponds to 80 pneumatic lines or tubes which can be divided into 8 groups of 10 lines for each cartridge 1200, as shown schematically in FIGS. 9I to 9L. Again, the perspective views omit some of the tubes for clarity.

In some embodiments, all of the pneumatic lines may be connected to a single compressor if only one pressure difference is required at any one time. For example, passive valves may be used in some cases where the driving pressure can be high enough to overcome a cracking pressure of the valves. For the processing of nucleic acid, or other proteins or biological materials, it may be necessary to avoid high shear rates in fluid flows within the cartridge 1200, so the pressure differences may be relatively low. In this application, and some others, it may be necessary to include active valves so that the relatively high cracking pressures aren't required, in which case pressure actuated valves may be used.

In the illustrated embodiment of the instrument 1000, configured to perform operations on the illustrated sample cartridge 1200, two different pressure levels are required to endure that the driving pressure for moving fluids through channels in the cartridge 1200 doesn't disrupt the control of the pressure actuated valves in the cartridge 1200 in situations where the two pressures are acting in competition. Therefore, the pneumatic lines are connected to two compressors via two manifolds and a plurality of valves, as shown in FIGS. 9I to 9L.

In some embodiments, the compressors, valves and pneumatic lines are arranged behind the two core units 1100, as shown in FIGS. 9A and 9B. The pneumatic module 500 comprises a first compressor 511 and a second compressor 512. The compressors 511, 512 may also be referred to as vacuum pumps or pressure pumps, configured to draw air from the pneumatic lines to selectively reduce pressure in particular channels or vessels of the cartridge 1200.

The compressors 512, 512 may be configured to create any suitable selected pressure difference depending on the application, including positive pressure (above atmospheric or ambient pressure) or negative pressure (below atmospheric or ambient pressure), at a magnitude suitable for the particular application.

For example, the first compressor 511 may be configured to provide a relatively high magnitude negative pressure in the range of 180 mBar to 500 mBar, 190 mBar to 350 mBar, or about 200 mBar, and the second compressor 512 may be configured to provide a relatively low magnitude negative pressure in the range of 50 mBar to 200 mBar, 80 mBar to 150 mBar, 100 mBar to 120 mBar or about 120 mBar. The difference between the two pressure levels may be in the range of 20 mBar to 200 mBar, 50 mBar to 100 mBar, at least 20 mBar, at least 50 mBar or at least 100 mBar, for example. Any suitable compressors 511, 512 may be used, such as a Diaphragm pump (4.3 l/min-600 mb)—(1410-VD-0-D-24V-BLDC-4600-15-EEE-PAA part no. 14100217) from Garner Denver Thomas GMBH, for example. Other pumps with higher or lower pressure delivery may be used for other applications, if necessary. In some embodiments, the pressure module 500 may comprise one or more variable pressure compressors configured to selectively draw different operating pressures for different operations during processing. In some embodiments, the compressors may be configured to alternate between negative and positive pressure at different times. For example, positive pressure may be provided to close valves in the cartridge, or maintain them in a closed position against channel pressure gradients which might otherwise cause leakage through the valves.

The first compressor 511 is connected to a first manifold 521, and the second compressor 512 is connected to a second manifold 522, for example, by pneumatic lines or tubes 515, as shown in FIGS. 9I, 9J, 9K. The manifolds 521, 522 are shown in perspective view in FIG. 9C and in partial cross-section in FIG. 9D. The pneumatic lines 515 are omitted from FIGS. 9C to 9H for clarity.

The manifolds 521, 522 define a plurality of barbed connectors 530 configured to connect to pneumatic lines 515 (e.g., silicone tubing) to fluidly connect the various components of the pneumatic module 500, as shown in FIGS. 9I to 9L.

The first manifold 521 includes two compressor connectors 531 to connect to the first compressor 511 via pneumatic lines 515. The connectors 531 are each in fluid communication with a control valve, V11 and V12, respectively, which control the pressure delivered to the rest of the first manifold 521 by the compressor 511—either positive or negative pressure, depending on the valve V11, V12—and allow selective venting through corresponding vents 532 to equalise the pressure in the manifold 521 and return it to ambient pressure.

The valves V11 and V12 are also configured to selectively allow fluid communication between the first compressor 511 and a first group of valves V1, V2, V3, V4, V5, which are configured to selectively allow fluid communication with corresponding pneumatic ports in the sample cartridge 1200 to create a pressure difference to drive flow in the cartridge 1200 or control flow by opening or closing valves in the cartridge 1200.

The first manifold 521 may also define a sensor connector 535 in fluid communication with all of the first group of valves V1, V2, V3, V4, V5 and control valves V11 and V12 and configured to connect to a first pressure sensor 551 configured to measure the pressure in the first manifold 521.

The second manifold 522 includes one compressor connector 536 to connect to the second compressor 512 via pneumatic lines 515. The connector 536 is in fluid communication with a second group of valves V6, V7, V8, V9, V10 which are configured to selectively allow fluid communication with corresponding pneumatic ports in the sample cartridge 1200 to create a pressure difference to drive flow in the cartridge 1200 or control flow by opening or closing valves in the cartridge 1200.

The second manifold 522 may also define a sensor connector 538 in fluid communication with all of the second group of valves V6, V7, V8, V9, V10 and configured to connect to a second pressure sensor 552 configured to measure the pressure in the second manifold 522. The valves of the second manifold 522 as well as the second compressor 512 are also configured to selectively vent or release pressure through vents 537. In some embodiments, some of the vents 537 may be closed with a plug, for example, the vents 537 corresponding to valves V6 and V7, as shown in FIG. 9K. In some embodiments, the second manifold 522 may be set up similarly to the first manifold 521 with two additional valves to select positive pressure or negative pressure from the compressor (as per V11 and V12 on the first manifold 521).

Any suitable pneumatic valves may be used for valves V1, V2, V3, V4, V5, V6, V7, V8, V9, V10, V11, V12 such as Genvi solenoid valve assembly (LEE PRODUCTS LIMITED—LFKX0503050A), for example.

Any suitable pressure sensors may be used, including Honeywell Piezoresistive Pressure Sensor (SSCDANN015PD2A5), for example.

The first and second manifolds 521, 522 may each include a plurality of connectors 530 in fluid communication with each valve V1, V2, V3, V4, V5, V6, V7, V8, V9, V10 to fluidly connect to corresponding pneumatic ports in multiple cartridges 1200. For example, FIGS. 9I, 9J and 9K show connections for 8 cartridges 1200. The first and second manifolds 521, 522 illustrated in FIG. 9C include 16 connectors 530 for each valve to provide for connection to 16 cartridges 1200. Some of the connectors 530 may be blocked if not required.

The connectors 530 are arranged in pairs of rows corresponding to each valve: the connectors 530 of rows 501a and 501b are in fluid communication with valve V1; the connectors 530 of rows 502a and 502b are in fluid communication with valve V2; the connectors 530 of rows 503a and 503b are in fluid communication with valve V3; the connectors 530 of rows 504a and 504b are in fluid communication with valve V4; the connectors 530 of rows 505a and 505b are in fluid communication with valve V5; the connectors 530 of rows 506a and 506b are in fluid communication with valve V6; the connectors 530 of rows 507a and 507b are in fluid communication with valve V7; the connectors 530 of rows 508a and 508b are in fluid communication with valve V8; the connectors 530 of rows 509a and 509b are in fluid communication with valve V9; the connectors 530 of rows 510a and 510b are in fluid communication with valve V10.

Each pair of rows is connected to the corresponding valve by a sub-manifold within the first or second manifold 511, 522. For example, FIG. 9D shows a partial cross-section illustrating part of a first sub-manifold 541 in fluid communication with the connectors 530 of rows 501a and 501b and with valve V1, and a second sub-manifold in fluid communication with the connectors 530 of rows 502a and 502b and with valve V2.

A plurality of pneumatic lines 515 extend away from the first and second manifolds 511, 512, to the connectors 530 to the cartridges 1200. As mentioned, 80 connecting lines 515 are shown corresponding to 8 cartridges 1200, but any suitable number may be provided depending on the number of cartridges and the number of pneumatic ports for each cartridge.

The 80 pneumatic lines 515 are arranged into bundles of 10, with each bundle including one pneumatic line 515 for each of the pneumatic ports of the cartridge 1200 corresponding to each of the valves V1, V2, V3, V4, V5, V6, V7, V8, V9, V10. In some embodiments, the pneumatic lines 515 may connect the manifolds 511, 512 directly to the core units 1100. In other embodiments, the pneumatic module 500 may comprise intermediate shut-off valves 560 configured to selectively block some of the pneumatic lines 515. Each bundle of pneumatic lines 515 associated with a corresponding cartridge 1200 may be selectively opened or closed depending on operating requirements, such as if one or more of the cartridge slots 120 are not in use while others are, or if operations are required to be performed on one or more particular cartridges 1200 and not others, for example.

The illustrated embodiment includes pinch valves or tube clamps 560 configured to selectively block each bundle of 10 tubes associated with a corresponding cartridge 1200. One of the pinch valves 560 is shown in more detail in FIGS. 9E to 9H.

The pinch valve 560 comprises a base plate 561 with fins 562 projecting away from the base plate 561 to define channels 563 between adjacent fins 562, and a cover plate 564 to at least partially cover the channels 563. The channels 563 are configured to receive the pneumatic line tubes 515. The tubes 515 are omitted from FIGS. 9E to 9H, but can be seen in the channels 563 in FIG. 9B.

The pinch valve 560 further comprises a pinch bar 565 extending across the channels 563 and configured to be moved towards and away from the base plate 561 to compress the tubes 515 accommodated in the channels 563 to block them. The cover plate 564 and fins 562 include an open portion to receive the pinch bar 565.

Any suitable mechanism may be provided for moving the pinch bar 565 relative to the base plate 561. In the illustrated embodiment, the pinch valve 560 comprises a lever 566 rotatably coupled to the base plate 561 via an axle 567 at one end of the lever 566. The other end of the lever 566 is coupled to a shaft 568 of a linear actuator 569 configured to raise and lower the lever 566, thereby raising and lowering the pinch bar 565 to selectively compress and block the tubes 515. This movement can be seen by comparing FIGS. 9E and 9F (showing an open configuration) and FIGS. 9G and 9H (showing a closed configuration).

Any suitable actuators may be used to operate the pinch valves 560, such as RS PRO Linear Solenoid, 24 V, 40×24×29 mm, Male (177-0117), for example.

One other alternative, rather than the mechanism described above is a motor-driven cam to provide a clamping force on the tubes 515 with a mechanical advantage, for example.

The compressors 511, 512, and valves, 560, V1, V2, V3, V4, V5, V6, V7, V8, V9, V10, may be electrically connected to and operated by a pneumatic module controller 150, which forms part of the control module 101. The pressure sensors 551, 552 may also be connected to the pneumatic module controller 150, to indicate changes in pressures. For example, sudden changes in pressure may indicate that a liquid has been completely aspirated through a channel in the cartridge 1200, or may confirm that a valve is open or closed. Certain signals from the pressure sensors 551, 552 may be used to trigger certain operations in an instrument process, for example.

The pneumatic lines 515 then continue from the pinch valves 560 to pneumatic ports in the core units 1100. In the illustrated embodiment the tubes 515 connect via direct connection bulkheads 570 to corresponding tubes 515 connected to the core units 1100, which allows the core units 1100 to be assembled separately and then installed in the instrument 1000 and connected to the pneumatic module 500. The instrument frame 1010 also includes brackets 1015 to hold the tubes 515 in place.

Referring to FIGS. 10A and 10B, one of the core units 1100 is shown in more detail, illustrating the connection of the pneumatic lines 515 to the core unit 1100 according to some embodiments. The core unit 1100 defines cartridge slots or sockets 120 each configured to receive a cartridge 1200. Each cartridge socket 120 has an associated pneumatic interface plate 1500 configured to engage and connect the cartridge 1200 to the pneumatic module 500.

The pneumatic plate 1500 defines pneumatic plate ports 1501, 1502, 1503, 1504, 1505, 1506, 1507, 1508, 1509, 1510 in fluid communication with the corresponding valves V1, V2, V3, V4, V5, V6, V7, V8, V9, V10 via the pneumatic lines 515. The pneumatic plate ports are in turn configured to connect with corresponding cartridge pneumatic ports 1201, 1202, 1203, 1204, 1205, 1206, 1207, 1208, 1209, 1210 in the cartridge 1200. The arrangement of and connection between the corresponding pneumatic plate ports and cartridge pneumatic ports on the underside of the sample cartridge 1200 can be understood by comparing FIGS. 9L, 10B and 12A (on pages 35 and 37):
cartridge port 1201 is configured to connect to pneumatic plate port 1501 and valve V1;
cartridge port 1202 is configured to connect to pneumatic plate port 1502 and valve V2;
cartridge port 1203 is configured to connect to pneumatic plate port 1503 and valve V3;
cartridge port 1204 is configured to connect to pneumatic plate port 1504 and valve V4;
cartridge port 1205 is configured to connect to pneumatic plate port 1505 and valve V5;
cartridge port 1206 is configured to connect to pneumatic plate port 1506 and valve V6;
cartridge port 1207 is configured to connect to pneumatic plate port 1507 and valve V7;
cartridge port 1208 is configured to connect to pneumatic plate port 1508 and valve V8;
cartridge port 1209 is configured to connect to pneumatic plate port 1509 and valve V9;
cartridge port 1210 is configured to connect to pneumatic plate port 1510 and valve V10.

The socket 120 comprises parallel rails 1120 defining grooves configured to slidably accommodate edges of the cartridge base 202 when inserted in the socket 120. The rails 1120 may include recesses 1122 configured to receive a resilient clip 1222 integrally formed with the cartridge base 202. The rails 1120 are fixed to a core unit frame 1110.

In some embodiments, the instrument 1000 may comprise a sensor or switch associated with each of the sockets 120 and configured to indicate when the sample cartridge 1200 is correctly installed in the socket 120.

In some embodiments, the pneumatic interface plate 1500 is positioned below the socket 120 and biased to an engaged position by springs. The core unit 1100 may comprise a core carriage 1190 which is configured to move up and down a pair of lead screws 1191 operated by motors 1192, which form part of the motion module 900. The core carriage 1190 can be seen in FIG. 10C which omits some of the components of the core unit 1100 to better visualise the internal components. Suitable motors 1192 include STEPPER MOTOR—NEMA 17 (ST4118M1206-B) from NANOTEC, for example.

In some embodiments, the pneumatic plates 1500 are connected to retraction rods 1520, which pass through the core carriage 1190 such that it can slide up and down the retraction rods 1520, and the lower ends of the retraction rods 1520 comprise stops 1522 positioned below the core carriage 1190. When the core carriage 1190 is lowered relative to the beyond engagement with the stops 1522, the retraction rods 1520 and pneumatic interface plates 1500 are lowered along with the core carriage 1190 relative to the core unit frame 1110.

The retraction of the interface plates 1500 allows the cartridges 1200 to be inserted into the sockets 120. The motion module 900 can be operated to raise the core carriage 1190 allowing the springs to raise the interface plate 1500 and urge it against the base 202 of the cartridge 1200, clamping it between the interface plate 1500 and the rails 1120. The pneumatic interface plates 1500 may comprise gaskets or sealing portions 1530 surrounding each of the pneumatic plate ports 1501, 1502, 1503, 1504, 1505, 1506, 1507, 1508, 1509, 1510, which are configured to be compressed and deformed between the pneumatic plate 1500 and the cartridge 1200 to provide a seal around the connection between the corresponding pneumatic ports 1501, 1201. The gaskets 1530 may be formed of any suitable elastomeric material, such as rubber, silicone, or other polymers, for example.

The magnetic module 700 may comprise permanent magnets 710 which are mounted on and move with the carriage 1190 and are configured to engage the primary and secondary reaction vessels 210, 220 for each cartridge 1200 when raised into position adjacent the reaction vessels 210, 220.

The thermal module 600 comprises separate thermal sub-assemblies 660 corresponding to each cartridge socket 120. Referring to FIGS. 10D and 10E, each thermal sub-assembly 660 comprises an elongate heating element 661 connected to a radiator 662 at one end and a cooling fan 663 at an opposite end. For example, Thorlabs Cartridge Heater (HT15W).

In some embodiments, the thermal sub-assemblies 660 are each mounted to the carriage 1190 and configured to move with the carriage 1190. In order to allow for heating of the primary reaction vessel 210 without engagement of the magnetic module 700, each thermal sub-assembly 660 may be mounted to the carriage 1190 via sprung connection rods 668, which are slidably mounted to the carriage 1190 and biased to an extended position by compression springs 669, as shown in FIG. 10E.

When the core carriage 1190 is raised relative to the core unit frame 1110 to engage the extended thermal sub-assemblies 660 with the cartridges 1200, the magnets 710 are positioned lower down, out of the way, as shown in FIG. 10F. When the core carriage 1190 is raised further to engage the magnets 710 with the reaction vessels 210, 220, the thermal sub-assemblies 660 are compressed to a retracted state closer to the magnets 710 as shown in FIG. 10G, to allow simultaneous heating and magnetic engagement.

In some embodiments, radiator 662 and magnets 710 define a slit, as shown in FIGS. 10C and 10D, to allow them to extend through apertures 1230 in the base of the cartridge 1200, as shown in FIG. 12A, allowing closer proximity between the radiator 662, magnets 710 and reaction vessels 210, 220.

The magnet 710 associated with the primary reaction vessel 210 is shown in further detail in FIGS. 10M and ION, according to some embodiments. The magnet 710 may comprise a magnet holder 710 configured to support a plurality of magnets 717 arranged at various angles to direct an axis of each magnet 717 towards the primary reaction vessel 210. For example, the magnets 717 may be arranged with the north pole of each magnet 717 directed towards the primary reaction vessel 210. The angle of the magnets 717 in the magnet holder 715 are illustrated in cross-section in FIG. 10N. In some embodiments, the magnets 717 may be arranged in stacks in the magnet holder 715. For example, four stacks of two magnets 717. The magnets 717 may comprise cylindrical neodymium magnets, for example, which may have a diameter of 3 mm and a length of 4 mm. The magnet holder 715 may be formed of ASLS, for example, or any other suitable material. The magnets 717 may be adhesively bonded or otherwise fastened in the magnet holder 715.

Referring to FIGS. 10H to 10L, the mixing module 800 is shown, according to some embodiments. The mixing module 800 comprises an orbital shaker 810 positioned in the base of each core unit 1100.

The orbital shaker 810 may comprise an upper mount plate 812, a base 813 and a lower housing 814, as shown in FIG. 10A. The upper mount 812 may support the core unit frame 1110 which is fixed to the mount plate 812.

Together, the mount plate 812, core frame 1110 and attached components (including core carriage 1190, motors 1192, thermal module 600, magnetic module 700, pneumatic plates 1500 and sample cartridges 1200 accommodated in the sockets 120), define a core mass m₁, as shown in FIG. 10H.

The orbital shaker 810 comprises a motor 801 configured to rotate a shaft 804 and an eccentric shaft extension 806, described below, which is configured to move the upper mount plate 812 and attached components in an orbital motion, including the cartridges 1200 and reaction vessels 210, 220, thereby mixing the liquid reagents and sample in the primary or secondary reaction vessel 210, 220 depending on the process step.

The orbital motion of the upper plate 812 causes significant out-of-balance forces which are balanced, at least to some extent, by counterweights, as set out below.

FIG. 10H is a force diagram illustrating a simplified view of the core unit 1100 and orbital shaker 810. The orbital shaker 810 comprises a first counterweight 802 and a second counterweight 803 coupled to the shaft 804. The centre of mass of each of the first and second counterweights 802, 803 is offset from a central axis of rotation 805 of the shaft 804,

The motor 801 and shaft 804 are positioned such that the centre of mass m₁ is radially offset from the axis 805 by a first radius r₁. The centre of mass m₂ of the first counterweight 802 is radially offset from the axis 805 by a second radius r₂ and axially offset from the core mass m₁ by a first distance d₁₂. The centre of mass m₃ of the second counterweight 803 is radially offset from the axis 805 by a third radius r₃ and axially offset from centre of mass m₂ by a second distance d₂₃.

When the motor 804 is operated to rotate the counterweights 802, 803 at a given angular velocity ω, centrifugal forces F₁, F₂, F₃, act on each of the masses m₁, m₂, m₃, (where Fₙ=mₙrₙ ω), as shown in FIG. 10H.

Considering masses m₁, m₂, m₃ alone, a static balance of centrifugal forces gives: m₁r₁+m₃r₃=m₂r₂

And the dynamic balance for zero moment gives: m₁r₁d₁₂=m₃r₃d₂₃

Using these equations, for a given core mass m₁, the orbital shaker can be designed with counterweights and offset distances to balance the equations to avoid unstable vibrations during operation.

For example, for the illustrated embodiment, the orbital radius r₁ is 1.6 mm, operating at 2000 rpm (ω), m₁=4200 g, r₁=1.6 mm, d₁₂=94 mm, m₂=582 g, r₂=27.3 mm, m₃=484 g, r₃=19 mm. Any other suitable parameters may be chosen according to the equations set out above. However, it is not necessarily essential that the counterweights 802, 803 be balanced precisely.

In practice, there may be small imbalances which may lead to undesirable vibrations. Therefore, the orbital shaker 810 may comprise bearing features to provide restoring forces. For example, bearing balls 807 may be positioned immediately below the upper mount plate 812 to provide a restoring force F_{R} to the mounting plate 812 in the case of a dynamic imbalance (causing rotation of the core mass m₁ in a direction away from the axis 805), and ball bearings 808, 809 may be configured to support the shaft 804 and provide a restoring force F_{R} to the shaft 804 in the case of a static imbalance (causing a moment on the shaft 804 in a direction away from the axis 805).

Referring to FIGS. 10I to 10K, the orbital shaker 810 is shown in further detail, according to some embodiments. The upper mount plate 812 and lower housing 814 are omitted from FIG. 10I to better visualise the internal components of the shaker 810.

The lower housing 814 may be connected to the base 813 by a plurality, such as four, anti-vibration mounts or dampeners 815 to dampen vibrations transmitted to the base 813. For example, the dampeners 815 may comprise Round M6 Anti Vibration Mount 53364145 19 mm diameter (255-3118) from RS.

The motor 801 comprises a stator 801a, which is mechanically fastened to the lower housing 814, and a rotor 801b, which is connected to the shaft 804 and configured to rotate about axis 805 together with the shaft 804. For example, one suitable motor is BRUSHLESS DC MOTOR (EXTERNAL ROTOR) from NANOTEC (DFA90S024027-A).

The first counterweight 802 may be positioned above the motor 801 and connected to the shaft 805 by a first clamp 832, which itself forms part of the first counterweight 802. The second counterweight 803 may be positioned below the motor 801 and connected to the rotor 801b by a second clamp 833, which itself forms part of the second counterweight 803.

A first ball bearing 808 may be positioned on the shaft 805 between the motor 801 and the first clamp 832. The first ball bearing 808 may be housed in and supported by the lower housing 814 allowing the shaft 805 to rotate within the housing 814.

A second ball bearing 809 may be positioned on a shaft extension 806 (connected to the shaft 805) between the first clamp 832 and the upper mount plate 812. The second ball bearing 809 may be housed in and supported by the mount plate 812 allowing the shaft extension 806 and shaft 805 to rotate within the mount plate 812.

The shaft extension 806 may be acentric (or eccentric) such that the central axis of an outer cylindrical surface of the shaft extension 806 is radially offset from the central axis of an internal cylindrical surface of the shaft extension 806 (which is connected concentrically with the shaft 805 and centred on axis 805). The radial offset of the shaft extension 806 may be in the range of 0.5 mm to 5 mm, 0.7 mm to 3 mm, 1 mm to 2 mm, about 1 mm, or about 1.6 mm, for example. In other embodiments, the shaft extension 806 may comprise any suitable radial offset for a given application. Suitable orbital motion characteristics for particular mixing requirements are discussed at www.qinstruments.com/knowledge/.

The upper mount plate 812 may be coupled to the lower housing 814, for example, via connecting rods 820 and a tie plate 822. The lower housing 814 may be mechanically fastened to the tie plate 822, which surrounds the motor 801 but may not come into contact with the motor 801. The connecting rods 820 may comprise a plurality of connecting rods 820, such as three connecting rods 820, which may be spaced equidistantly (and/or equi-azimuthally) around the axis 805.

The connecting rods 820 may be coupled to the tie plate 822 and upper mount plate 812 by spherical bearings 823, such as EGLM-05 from Igus, for example. The spherical bearings 823 allow the connecting rods 820 to support the upper mount plate 812 while allowing it to move in a small orbit in the horizontal plane.

There may be some flexibility in the mechanical connections allowing small out of plane movements of the upper mount plate 812. In order to mitigate against this, the orbital shaker 810 may comprise a plurality of bearing balls 807 (e.g., 3, 4 or more) positioned around the motor 801 and counterweights 802, 803. For example, the bearing balls 807 may comprise three bearing balls 807 spaced equidistantly (and/or equi-azimuthally) around the axis 805. Each bearing ball 807 may be spaced equidistantly between two of the connecting rods 820.

Each bearing ball 807 may be housed in a cavity 817 defined by the lower housing 814 and may be sandwiched between an upper bearing disc 837 coupled to the upper mount plate 812 and a lower bearing disc 838 coupled to the lower housing 814, as shown in FIG. 10J. Suitable bearing balls include 25 mm Diameter Delrin (Acetal) Plastic Balls with

The orbital shaker 810 may comprise a stop mechanism 880, as shown in FIGS. 10K and 10L, for example. The first counterweight clamp 832 may comprise an outer annular ring 834 defining a notch 835 configured to receive a locking member 885 of the stop mechanism 880. Stop mechanism 880 may be coupled to the lower housing 814 and configured to move the locking member 885 into the notch 835 to stop rotation of the counterweights 802, 803 or out away from the notch 835 to allow rotation of the counterweights 802, 803. For example, the locking member 885 may be arranged substantially radially with respect to the axis 805 and configured to move in and out of the notch 835.

The stop mechanism 880 may comprise a spring 888 to bias the locking member 885 to a non-locking position, and an actuator 889 to selectively move the locking member 885 into the locking position in the notch 835. For example, the actuator 889 may comprise a linear solenoid actuator.

The ring 834 may define a lead-in portion 836 adjacent the notch 835 allowing for the locking member 885 to begin moving radially inward (once the locking mechanism 880 is activated) before being aligned with the notch 835. The lead in portion 836 may have a lesser radial extent than the rest of the ring 834, as shown on the other side of the notch 835.

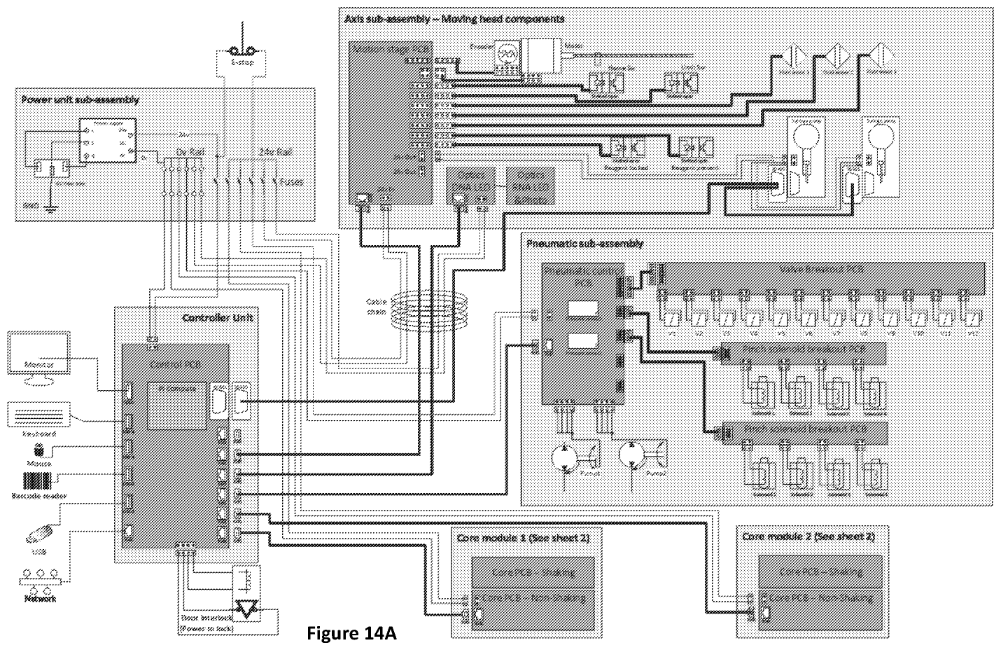

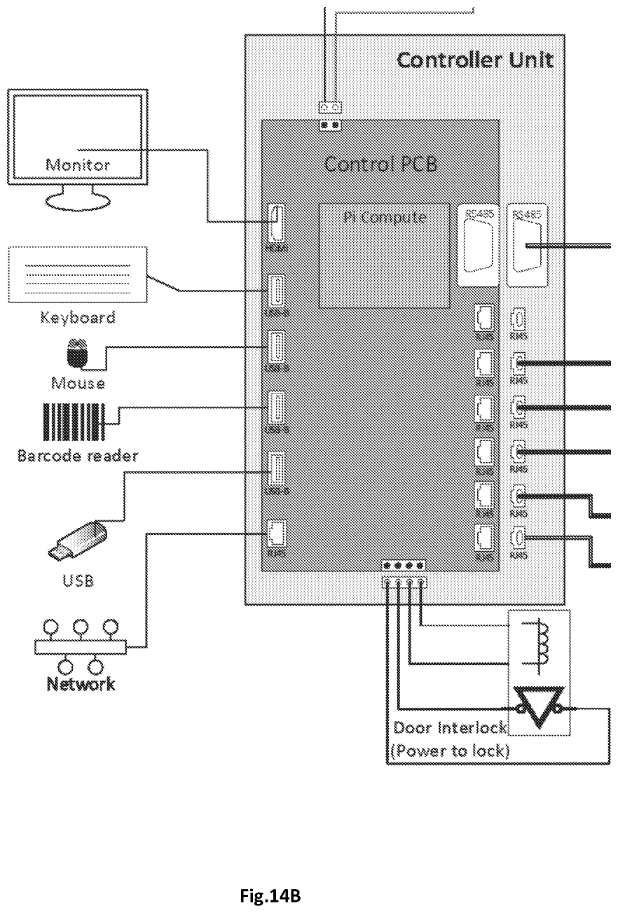

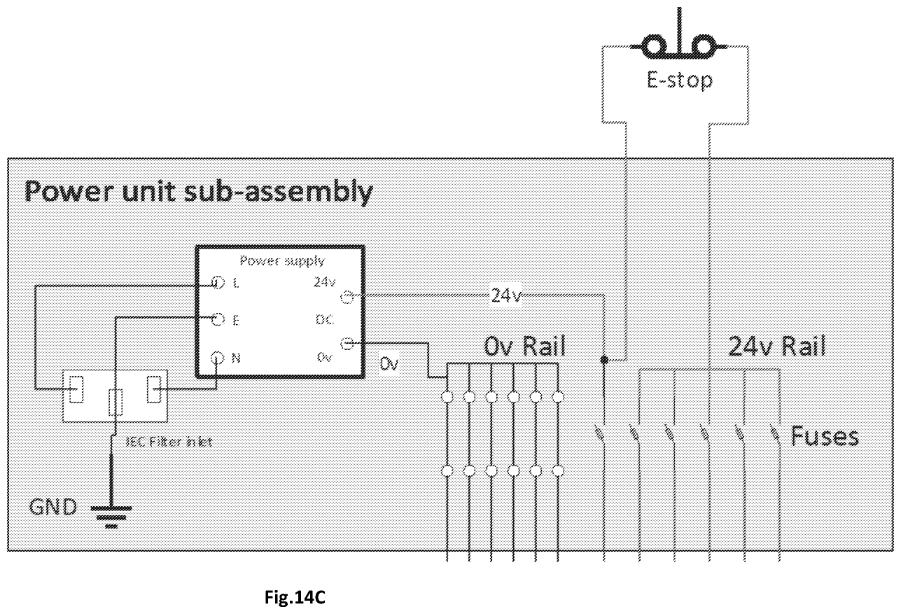

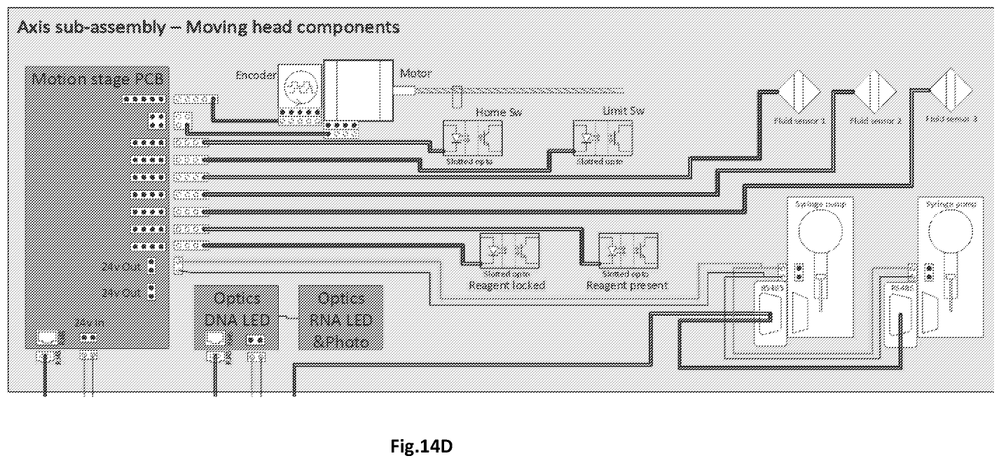

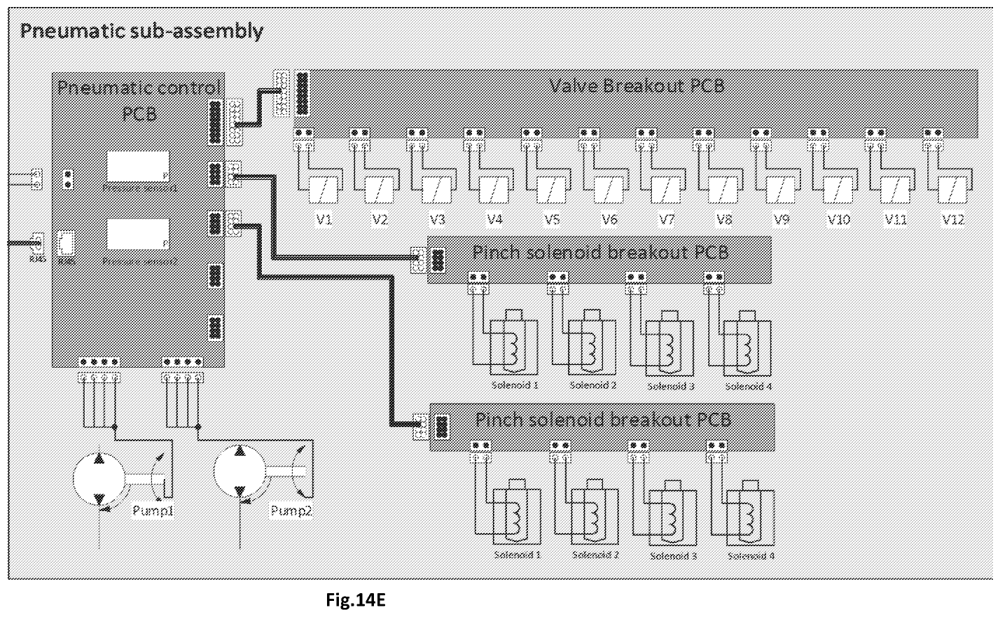

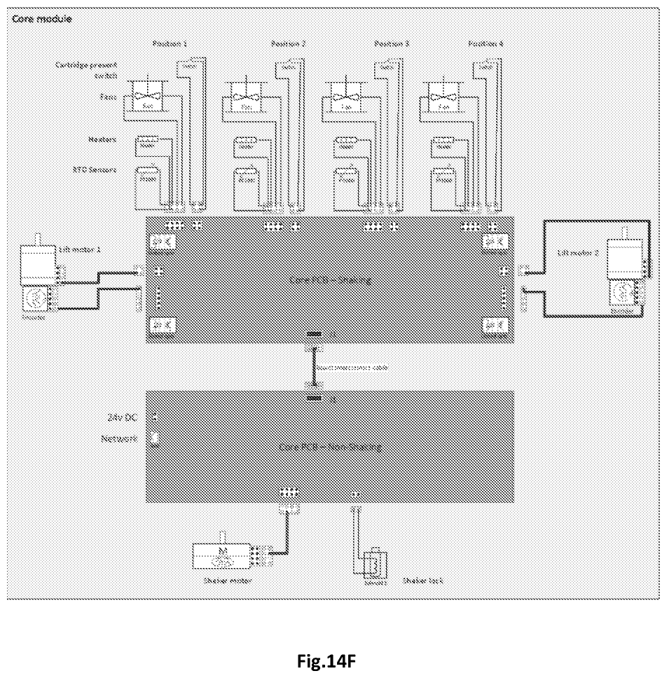

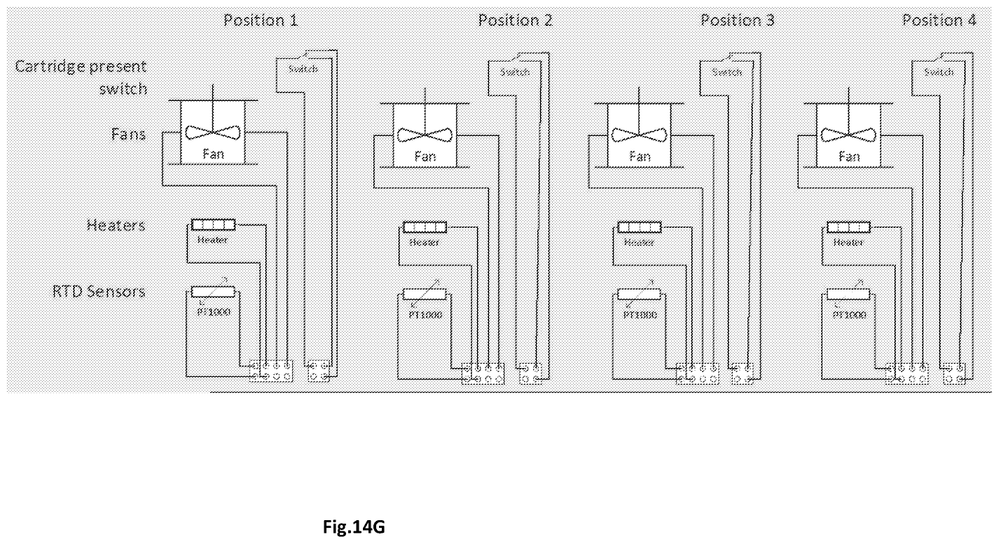

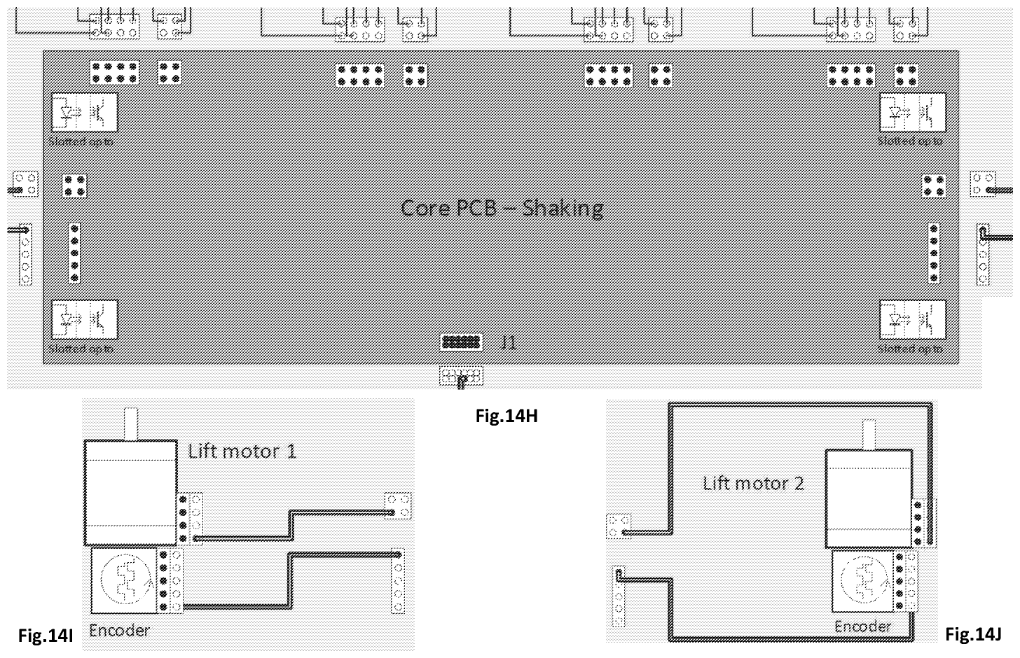

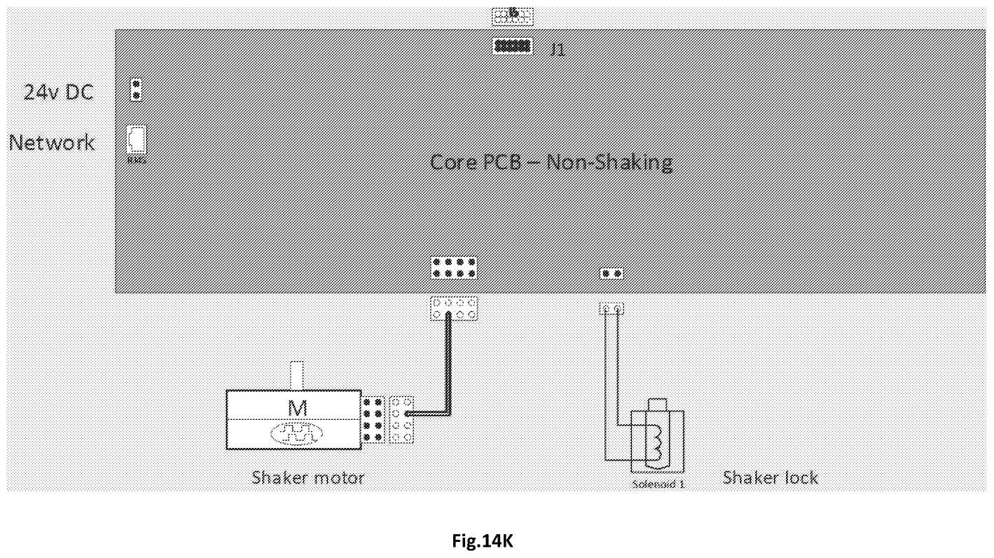

The core unit 1100 may also comprises a circuit board 890 fixed to the base 813 and connected to the control module 101 to control operation of the orbital shaker motor 804 and core carriage motors 1192, which may be both connected to the circuit board 890, for example, via flexible cables, to allow for relative movement between the orbital shaker 810, core frame 1110 and base 813. The cables are not shown in the perspective drawings, but a motor connection terminal 894 is shown in FIG. 10J and the various electrical connections are shown in FIGS. 14A to 14K.

Referring to FIG. 11, the optics module 400 is shown in further detail, according to some embodiments. As described in relation to FIGS. 4A and 4B, the optics module 400 comprises a source lens 412 to focus light from the source 410; a beam splitter 414 to redirect light from the source 410 towards the QC sample 404; a sample lens 402 to focus the source light onto the QC sample 404 and refocus light transmitted from the QC sample 404; a detector lens 422 to focus the light transmitted from the QC sample 404 onto the detector 420; and one or more filters 430 disposed in the detector path and/or the source path to filter certain frequencies of light.

These components are mounted in a housing 450 as shown in cross-section in FIG. 11, with circuit boards 451 mounted to outer surfaces of the housing 450 to position the source 410 and detector 420 in alignment with optical components. In some embodiments, the positions of the source and detector may be exchanged.

In some embodiments, the optical module 400 may optionally comprise a second light source 411 and corresponding lens 412, beam splitter 414 and filter 430, as shown in FIG. 11. The second light source 411 may be configured to produce light at a different wavelength to that of the first source 410 which is suitable for analysing a the concentration of a different dye, for example. The second light source 411 and beam splitter 414 may be configured for use with the same detector 420 or a different detector, for example.

Any suitable optical components may be used, for example:
the source 410 may be Inolux—6868 high power UV LED;
the lenses 402, 412, 422 may be 12.5 mm Dia.×25 mm EFL, UV-VIS Coated, Near UV Achromatic Lens from Edmund Optics;
the source filter 430 may be Shemrock—BrightLine—FF01-433/530-13x13;
the beam splitter 414 may be Shemrock—BrightLine—FF414-Di01-20x20;
the detector filter 430 may be Shemrock—BrightLine—Hg01-365-13x13; and
the detector 420 may be Photodiode—S1223 from Hamamatsu.

The optics module 400 is configured to analyse the sample and reference fluids at a target location 401, and the optics module 400 is moved along the instrument 1000 under the QC vessel 261 and reference vessels 271 to sequentially analyse and measure the signal strength (e.g., fluorescence intensity) from each vessel corresponding to a particular property of the sample, such as the concentration of a particular component in the liquid, such as a target nucleic acid (NA), for example.

The measurement of the property of interest (e.g., concentration) of the sample may be determined by interpolating or extrapolating from corresponding measurement values of the reference vessels, with known concentrations, using a linear regression, or a quadratic regression, for example, or another technique suitable for the relationship between the measured signal and the property of interest. The concentration (or other property) of the undiluted output fluid may then be determined by

Referring to FIG. 12B, the sample cartridge 1200 is shown in further detail, according to some embodiments. The cartridge 1200 includes similar features as those described in relation to sample cartridge 200 and like features are indicated with like reference numerals.

As discussed in relation to the cartridge sockets 120, the cartridge 1200 may comprise resilient clips 1222 configured to engage recesses 1122 in the rails 1120 of the sockets 120 to locate the cartridge 1200 in the correct position in the socket 120 so that the pneumatic ports are aligned with the pneumatic interface plate 1500. The clips 1222 may be integrally formed with an edge of the base 202 of the cartridge 1200, for example.

The cartridge 1200 comprises a pneumatic channel plate 1250, which defines the plurality of cartridge pneumatic ports 1201, 1202, 1203, 1204, 1205, 1206, 1207, 1208, 1209, 1210 and includes pneumatic channels connecting various portions of the cartridge 1200 and operating the valves. The base 202 defines fluid channels and also some pneumatic channels. A polypropylene membrane 1290 may be sandwiched between the base 202 and the pneumatic channel plate 1250 which separates some channels in the other two layers, and/or provides a flexible membrane to form valves in cooperation with the other layers, as shown in and described in relation to FIG. 2K.

The pneumatic channel plate 1250 defines a QC aperture 1261 aligned with the QC vessel 261 and a plurality, such as three, QC reference apertures 1271 aligned with the QC reference vessels 271. The polypropylene membrane 1290 forms the bottom of each of the QC vessel 261 and reference vessels 271, and may provide a transparent viewing window allowing optical access for the optics module to analyse the contents of the QC vessel 261 and reference vessels 271 through the QC aperture 1261 and QC reference apertures 1271.

In some embodiments, the cartridge 1200 may comprise an indicia 1295, such as a barcode, for example, to identify a sample stored within. The cartridge 1200 may be provided with an output vessel 250 which may comprise a corresponding indicia 1296 or barcode, which may be the same as or associated with the indicia 1295. Alternatively, the cartridge 1200 may comprise one or more peel off labels with corresponding indicia 1296 which may be removed from the cartridge 1200 and applied to a suitable output vessel 250 in which the output fluid is to be accommodated in once the sample has been processed.

The indicia 1295, 1296 may be scanned or otherwise have the data input into the laboratory information system or similar so that it is associated with data produced by the instrument 1000 in processing the sample.

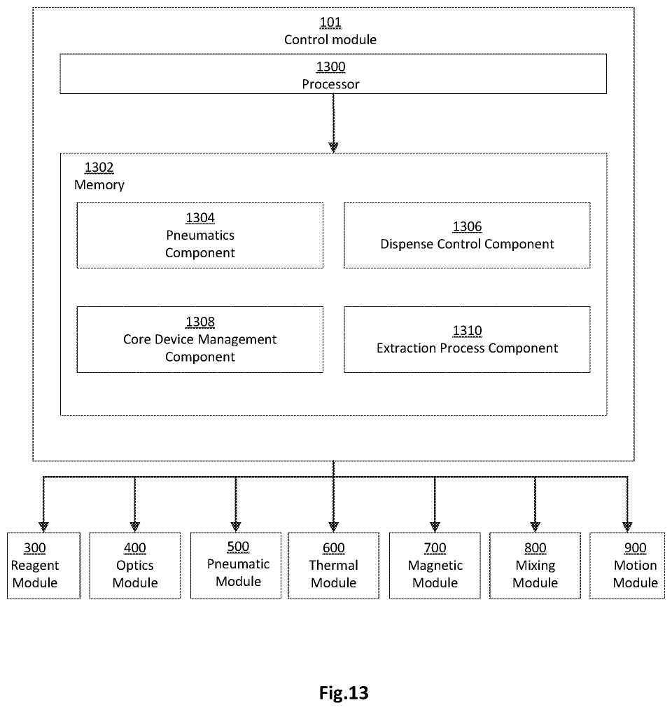

Referring to FIG. 13, the control module 101 may comprise one or more processors 1300 and memory 1302. The processor(s) 1300 may include an integrated electronic circuit that performs the calculations such as a microprocessor, graphic processing unit, for example. Memory 1302 may comprise both volatile and non-volatile memory for storing executable program code, or data. Memory 1302 comprises program code which when executed by the processor 1300, provides the functionality of the control module 101.

The block diagram of FIG. 13 illustrates some of the software modules or components stored in memory 1302, which when executed by the processor(s) 1300, perform the functionality of the control module 101 as described.

As shown, memory 1302 may comprise a pneumatics component 1304, which when executed by the processor(s) 1300, is configured to cause the pneumatic module 500 to perform the functionality described. For example, the pneumatics component 1304 may be configured to cooperate with or control the pumps, valves and/or pressure sensors of the instrument.

Memory 1302 may comprise a dispense control component 1306, which when executed by the processor(s) 1300, is configured to cause the reagent module 300 and/or the optics module 400 to perform the functionality described. For example, dispense control component 1306 may be configured to cooperate with or control the reagent module 300 and/or the optics module 400.

Memory 1302 may comprise a core device management component 1308, which when executed by the processor(s) 1300, is configured to cooperate with or control the thermal module 600, magnetic module 700, mixing module 800, and/or motion module 900.

Memory 1302 may comprise an extraction process component 1310, which when executed by the processor(s) 1300, is configured to cause the instrument 100 to function according to the described embodiments. For example, the extraction process component 1310 may communicate with the pneumatics component 1304, the dispense control component 1306 and the core device management component 1308 to cause each respective component to perform operations cause the instrument 100 to function according to the described embodiments. In some embodiments, the extraction process component 1310 may comprise computer code for executing the workflow programs of the list of workflow programs.

FIGS. 14A to 14K illustrate the electrical layout of the instrument 1000, according to some embodiments.

### Example 1

An example of an instrument workflow will now be described, for the purposes of illustration only. In some embodiments, the instrument 100 may be configured to perform a nucleic acid extraction workflow, for example.

Before the instrument workflow begins, a user may pipette a fluid sample, such as a biological specimen, into the primary reaction vessel 210 of a sample cartridge 200. For example, 0.2 to 5 mL of blood or bone marrow taken from a patient.

The user may then close the lid 211 of the primary reaction vessel 210, then record or scan a serial number or other indicia of the sample cartridge 200 and record corresponding patient details, for example from a vial previously containing the sample. This information may be recorded in a LIMS system or Laboratory information system, for example.

The user may then insert the cartridge 200 into one of the cartridge slots 120 in the instrument 100.

The user may then select a workflow program for the instrument using the user interface. Then the instrument workflow may begin, with instrument functions controlled by the control module 101 under instructions recorded on a computer readable storage media. For example, a nucleic acid extraction workflow described below.

The motion module is operated to engage the pneumatic module with the pneumatic ports on the sample cartridge and clamp the cartridge to restrict removal of the cartridge 200 from the cartridge slot 120.

The motion module is then operated to move the reagent module to a position over the sample cartridge and the reagent module is operated to dispense Proteinase K into the reagent vessel 230. For example, in the range of 50 to 100 μg of Proteinase K per mL volume of the specimen.

The pneumatics module is operated to transfer the reagent to the primary reaction vessel 210 with the specimen.

The orbital shaker of the mixing module is operated to promote mixing of the reagent with the specimen in the primary reaction vessel.

The motion module and thermal module are operated activate and raise the heater to heat the primary reaction vessel and incubate at 62 C for 10 min to digest the proteins within the blood. The heater may then be lowered and deactivated.

The motion module and reagent module are then operated to dispense Lysis buffer (e.g., 5M Guanadinium HCl, 0.25% Tween-20) into the reagent vessel 230.

The pneumatic module is then operated to transfer the Lysis buffer to the primary reaction vessel.

The motion module and reagent module are then operated to dispense functionalised magnetic beads (e.g., carboxyl COOH Magbeads) into the reagent vessel.

Any suitable type of functionalized bead may be used, including: solid phase reversible immobilization (SPRI) functionalised beads, carboxylated beads, or other magnetic functionalised beads, for example.

The pneumatic module is then operated to transfer the beads to the primary reaction vessel.

The orbital shaker is operated to promote mixing of the contents of the primary reaction vessel.

The motion and thermal modules are operated to heat the primary reaction vessel and incubate the contents at 62 C for 15 minutes to lysis the blood and bind the nucleic acid (NA) to the beads.

The heater is then deactivated and the cooling fan operated to cool the primary reaction vessel 210.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel including the lysate into the waste vessel 240.

The magnets 710 are then disengaged from the primary reaction vessel.

The motion module and reagent module are then operated to dispense Wash 1 buffer into the reagent vessel (e.g., 3M Guanadinium HCl, 30% Ethanol).

The pneumatic module is then operated to transfer the Wash 1 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Wash 2 buffer into the reagent vessel (e.g., 20 mM Glycine. HCl (pH 3.0) 80% Ethanol).

The pneumatic module is then operated to transfer the Wash 2 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Wash 3 buffer into the reagent vessel (e.g., 20 mM Glycine. HCl (pH 3.0)+0.1% Tween 20).

The pneumatic module is then operated to transfer the Wash 3 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Wash 4 buffer into the reagent vessel (e.g., 20 mM Glycine. HCl (pH 3.0)+0.1% Tween 20).

The pneumatic module is then operated to transfer the Wash 4 solution to the primary reaction vessel.

The orbital shaker is operated to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240.

The magnets 710 are then disengaged from the primary reaction vessel.

The motion module and reagent module are then operated to dispense Elution buffer into the reagent vessel (e.g., 1×TE, pH8.0).

The pneumatic module is then operated to transfer the elution buffer to the primary reaction vessel.

The orbital shaker is operated to promote mixing of the contents of the primary reaction vessel.

The heater is raised and activated to heat the primary reaction vessel to 74 C for 15 minutes to release the DNA from the beads into the elution buffer.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel (the eluate) into the secondary reaction vessel 220.

The magnets 710 are then disengaged from the primary reaction vessel.

The motion module and reagent module are then operated to dispense COOH (carboxyl) beads into the reagent vessel as well as a binding buffer (e.g., 0.8 M NaCl+11% PEG8000).

The pneumatic module is then operated to transfer the contents of the reagent vessel to the secondary reaction vessel.

The orbital shaker is operated to promote mixing of the contents of the secondary reaction vessel and binding of the extracted DNA to the COOH beads.

The motion module and magnetic module are operated to engage the magnets 710 and hold the magnetic beads to one or more sides of the secondary reaction vessel.

The beads are held in place for 1 to 5 minutes while the pneumatic module is operated to transfer the liquid contents of the secondary reaction vessel into the waste vessel 240.

The magnets 710 are then disengaged from the primary reaction vessel.

The motion module and reagent module are then operated to dispense COOH bead Wash 1 into the reagent vessel (e.g., 85% ethanol).

The pneumatic module is then operated to transfer the contents of the reagent vessel to the secondary reaction vessel.

The contents of the secondary reaction vessel are then allowed to incubate for 30 seconds

The motion module and magnetic module are operated to engage the magnets 710 and hold the magnetic beads to one or more sides of the secondary reaction vessel.

The beads are held in place for 1 to 5 minutes while the pneumatic module is operated to transfer the liquid contents of the secondary reaction vessel into the waste vessel 240.

The magnets 710 are then disengaged from the primary reaction vessel.

The motion module and reagent module are then operated to dispense COOH bead Wash 2 into the reagent vessel (e.g., 85% ethanol).

The pneumatic module is then operated to transfer the contents of the reagent vessel to the secondary reaction vessel.

The contents of the secondary reaction vessel are then allowed to incubate for 30 seconds

The motion module and magnetic module are operated to engage the magnets 710 and hold the magnetic beads to one or more sides of the secondary reaction vessel.

The beads are held in place for 1 to 5 minutes while the pneumatic module is operated to transfer the liquid contents of the secondary reaction vessel into the waste vessel 240. The magnets 710 are then disengaged from the primary reaction vessel.

The motion module and reagent module are then operated to dispense COOH Elution buffer (e.g., 10 mM Tris, pH 8.0) into the reagent vessel.

The pneumatic module is then operated to transfer the elution buffer to the secondary reaction vessel.

The orbital shaker is operated to promote mixing of the contents of the secondary reaction vessel to release DNA from the COOH beads into the Elution buffer.

The motion module and magnetic module are operated to engage the magnets 710 and hold the magnetic beads to one or more sides of the secondary reaction vessel.

The pneumatic module is then operated to draw the liquid contents of the secondary reaction vessel (the eluate) up to the air permeable membrane to fill the metering channel.

The motion module and reagent module are then operated to dispense neutral buffer into the QC buffer vessel 265, as well as the three QC reference buffer vessels 275.

The pneumatic module is then operated to draw the buffer solution from the QC buffer vessel through the metering channel and into the QC vessel along with a an aliquot of the eluate from the metering channel (e.g., 1 μL). And to transfer the buffer solution from the QC reference buffer vessels 275 to the corresponding QC reference vessels 271.

The pneumatic module is then operated to transfer the remainder of the eluate from the secondary reaction vessel to the output vessel 250.

The orbital shaker is operated to promote mixing of the contents of the QC vessel 261 and QC reference vessels 271, and resuspension of the preloaded dye and reference nucleic acid (NA) in the QC reference vessels.

The motion module is operated to move the optics module to a position corresponding to the sample cartridge and QC vessel containing the aliquot of eluate with buffer solution, and the optics module is operated to perform a fluorescence measurement on the contents of the QC vessel.

The motion module is further operated to move the optics module to three positions corresponding to three QC reference vessels, and the optics module is operated to perform a fluorescence measurement on the contents of each of the QC reference vessels.

Data from the fluorescence measurements is then used to determine the DNA concentration of the final eluate. The resulting data provides quantification and may be transmitted to a LIMS system for recording and/or capturing.

Finally the pneumatic module may be lowered and disengaged from the sample cartridge. This may comprise the end of the workflow program, according to some embodiments.

The sample cartridge 200 may then be removed from the instrument 100 by a user. The temporary lid 259 may be removed from the output vessel 250, and the main lid closed to seal the output vessel 250.

Then output vessel 250 may then be removed from the output vessel seat 254, and the rest of the sample cartridge 200 discarded.

### Example 2

Another workflow example is set out below according to some embodiments. The chemistry and operating parameters are suitable for gDNA extraction from a 0.5 mL sample of whole blood. The details of the instrument operation may also be suitable for other applications and processes.

Any suitable reagents may be used, including the following alternatives, for example only:
Proteinase K
Proteinase K support buffer (4.93M G-HCl, 67 mM maleic acid, 30% Tween-20 (v/v), pH 6)
Binding buffer (0.8M Guanadinium·HCl; 10 mM Tris pH8; 50% IPA; 2 mM EDTA; 1.2M NaCl; 0.25% Tween) Alternatively (5M Guanidine·HCl+0.25% Tween 20)
Beads (Silica coated paramagnetic beads) (Siemens Versant 50 μL, or alternatively, Magtivo Magsi-DNAmf MD020001)
Wash 1 (5.61M G·HCl, 0.28M LiCl, 1.12% Tw-20, 25.24% EtOH) Alternatively, (3M Guanidine·HCl pH 3.0+30% EtOH)
Wash 2 (19 mM Tris, 80% EtOH) Alternatively, (20 mM citric acid pH3.0, 80% ethanol)
Wash 3 (20 mM Hepes, pH 6.5) Alternatively, (20 mM glycine·HCl pH3.0, 0.1% Tw-20)
Elution buffer (1×TE, pH 8.0)

Incubation times and temperatures may be adjusted to suit a particular application, for example, the incubation temperature may be in the range of 21° C. to 72° C.

Before the instrument workflow begins, a user may pipette a fluid sample, such as a biological specimen, into the primary reaction vessel 210 of a sample cartridge 200. For example, 0.5 mL of blood taken from a patient.

The user may then close the lid 211 of the primary reaction vessel 210, then record or scan a serial number or other indicia of the sample cartridge 200 and record corresponding patient details, for example from a vial previously containing the sample. This information may be recorded in a LIMS system or Laboratory information system, for example.

The user may then insert the cartridge 200 into one of the cartridge slots 120 in the instrument 100.

The user may then select a workflow program for the instrument using the user interface. Then the instrument workflow may begin, with instrument functions controlled by the control module 101 under instructions recorded on a computer readable storage media. For example, a nucleic acid extraction workflow is described below.

The motion module is operated to engage the pneumatic module with the pneumatic ports on the sample cartridge and clamp the cartridge to restrict removal of the cartridge 200 from the cartridge slot 120.

The motion module is then operated to move the reagent module to a position over the sample cartridge and the reagent module is operated to dispense 50 μL of Proteinase K (Qiagen, as received from supplier) into the reagent vessel 230.

The pneumatics module is operated to transfer the reagent to the primary reaction vessel 210 with the specimen.

Then the reagent module is operated to dispense 120 μL of commercial support buffer AL into the reagent vessel 230, and the pneumatics module is operated to transfer the reagent to the primary reaction vessel 210 with the specimen.

Alternatively, the Proteinase K and buffer solution may be dispensed into the reagent vessel 230 together, or one after the other, and then transferred into the primary reaction vessel 210 together in a single transfer step.

The operation of the pneumatics module may comprise applying a vacuum pressure or negative pressure (relative to ambient pressure) in the range of 100 mBar to 120 mBar, for example.

The orbital shaker of the mixing module is operated for 10 seconds at 1100 rpm to promote mixing of the reagent with the specimen in the primary reaction vessel.

The motion module and thermal module are operated to activate and raise the heater to heat the primary reaction vessel and incubate at 25° C. for 10 min to digest the proteins within the blood. The heater may then be lowered and deactivated.

Alternatively, if the ambient temperature is close to 25° C., the heater may not be required for this step.

The motion module and reagent module are then operated to dispense 825 μL Lysis buffer (0.8M g·HCl, 0.01M Tris pH8, 50% 2-propanol, 1.2M NaCl, 2 mM EDTA, 0.25% Tween-20) into the reagent vessel 230.

The pneumatic module is then operated to transfer the Lysis buffer to the primary reaction vessel.

The motion module and reagent module are then operated to dispense functionalised magnetic beads (Siemens Versant 50 μL) into the reagent vessel.

The pneumatic module is then operated to transfer the beads to the primary reaction vessel.

In order to avoid or reduce the time available for the beads to precipitate or sediment in the reagent vessel (which may lead to blockages), the pneumatic module may be operated to transfer the beads into the primary reaction vessel before completion of the dispensing of the beads into the reagent vessel. For example, the transfer may begin during or part way through the dispensing, and may be done in stages. The dispensing may also be done in stages in some embodiments.

Alternatively, or additionally, part of the Lysis buffer solution (e.g., two thirds) may be held back and dispensed into the reagent chamber after dispensing and transfer of the beads, in order to flush any beads remaining in the reagent vessel or transfer channel into the primary reaction vessel.

The orbital shaker is operated to promote mixing of the contents of the primary reaction vessel for 10 seconds at 1100 rpm.

The motion and thermal modules are operated to heat the primary reaction vessel and incubate the contents at approximately 62° C. for 15 minutes to lysis the blood and bind the nucleic acid (NA) to the beads. The orbital shaker may also be operated at 1100 rpm during the incubation period to promote mixing.

The heater is then deactivated and the cooling fan operated to cool the primary reaction vessel 210 back to ambient temperature. For example, the cooling operation may have a duration in the range of 1 minute to 5 minutes, 2 minutes to 3 minutes, or about 2 minutes, depending on the cooling rate. In some embodiments it may be necessary to cool the reaction vessel so that the beads do not dry out. In other embodiments, if drying is not problematic, this step may be omitted.

The motion module and magnetic module are operated to engage the magnets 710 and hold the magnetic beads to one or more sides of the primary reaction vessel.

The magnets may be engaged during the cooling operation.

The beads are held in place for 1 to 5 minutes while the pneumatic module is operated to transfer the liquid contents of the primary reaction vessel including the lysate into the waste vessel 240. The magnets may be applied to engage the beads for approximately 1 minute before transferring the liquid in order to allow the beads to migrate towards the magnets to be held against the wall of the vessel with sufficient strength to resist flowing with the liquid during the transfer process. The length of time required may depend on the strength of magnetic attraction between the beads and the magnets, as well as the viscosity of the fluid. In some embodiments, a shorter settling time (less than 1 minute) may be sufficient or a longer settling time may be required (e.g., more than 1 minute, more than 2 minutes, more than 3 minutes, or more than 4 minutes).

The magnets 710 are then disengaged from the primary reaction vessel.

The motion module and reagent module are then operated to dispense 850 μL of Wash 1 buffer into the reagent vessel (e.g., 3M Guanadinium HCl (gHCl), 30% Ethanol).

The pneumatic module is then operated to transfer the Wash 1 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

In some embodiments, only one wash process may be required. In other embodiments, further wash steps may be required as set out below.

The motion module and reagent module are then operated to dispense 450 μL of Wash 2 buffer into the reagent vessel (e.g., 80% ethanol, 0.1M sodium citrate buffer, pH 3).

The pneumatic module is then operated to transfer the Wash 2 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 450 μL of Wash 3 buffer into the reagent vessel (e.g., 20 mM glycine·HCl, 0.1% Tw-20, pH3).

The pneumatic module is then operated to transfer the Wash 3 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 450 μL of Wash 4 buffer into the reagent vessel (e.g., 20 mM glycine·HCl, 0.1% Tw-20, pH3).

Wash 4 is completed using the same buffer solution as Wash 3 in order to flush out contaminants in the dispensing system from previous steps. This step may be repeated more than once if needed to ensure purity or further reduce the likelihood of contaminants appearing in the solution. Alternatively, if contaminants are not a concern, or if the dispense system includes independent channels which avoids potential contamination, then this step may be omitted.

The pneumatic module is then operated to transfer the Wash 4 solution to the primary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

The magnets 710 are then disengaged from the primary reaction vessel.

The motion module and reagent module are then operated to dispense 165 μL of Elution buffer into the reagent vessel (e.g., 1×TE, pH8.0).

The pneumatic module is then operated to transfer the elution buffer to the primary reaction vessel.

The heater is raised and activated to heat the primary reaction vessel to approximately 62° C. for 10 minutes to release the DNA from the beads into the elution buffer. The orbital shaker may be operated at 1100 rpm during the 10 minute incubation period to promote mixing of the contents of the primary reaction vessel.

The motion module and magnetic module are then operated to engage the magnets 710 and hold the magnetic beads to one or more sides of the primary reaction vessel.

The beads are held in place for 1 to 5 minutes while the pneumatic module is operated to transfer the liquid contents of the primary reaction vessel (the eluate) into the secondary reaction vessel 220. The magnets may be applied to engage the beads for approximately 1 minute before transferring the liquid. The used beads will then remain in the primary reaction vessel until the end of the process (during further processing of the eluate in the secondary reaction vessel) or when the cartridge is discarded.

The magnets 710 are then disengaged from the primary reaction vessel.

The motion module and reagent module are then operated to dispense COOH (carboxyl) beads into the reagent vessel as well as a binding buffer (e.g., 470 μL mastermix, 1.24M NaCl, 13.95% PEG8000, 0.78% w/v magnify (MFY0002 Bangslab beads)).

The pneumatic module is then operated to transfer the contents of the reagent vessel to the secondary reaction vessel.

The orbital shaker is operated for 10 seconds at 1100 rpm to promote mixing of the contents of the primary reaction vessel.

The motion module and magnetic module are operated to engage the magnets 710 and hold the magnetic beads to one or more sides of the primary reaction vessel.

The beads are held in place for 1 to 5 minutes while the pneumatic module is operated to transfer the liquid contents of the primary reaction vessel into the waste vessel 240. The magnets may be applied to engage the beads for approximately 1 minute before transferring the liquid.

In this example, the beads in the secondary reaction vessel beads have a weaker magnetic attraction to the magnets and are in a more viscous solution. Therefore a longer settling time may be required (e.g., 2 minutes). However, longer or shorter settling times from less than 1 minute to more than 2 minutes, 3 minutes or 4 minutes may be used if sufficient.

In some embodiments, the magnets may remain engaged during the subsequent wash stages. For example, as in this case, if there are relatively weak binding kinetics on the beads, holding the beads in position with the magnets may mitigate against DNA being washed off of the beads prematurely.

The motion module and reagent module are then operated to dispense 200 μL of COOH bead Wash 1 into the reagent vessel (e.g., 85% ethanol).

The pneumatic module is then operated to transfer the contents of the reagent vessel to the secondary reaction vessel.

The contents of the secondary reaction vessel are then allowed to incubate for 30 seconds at room temperature.

The pneumatic module is then operated to transfer the liquid contents of the secondary reaction vessel into the waste vessel 240, while the magnets (still engaged) hold the beads in place.

The motion module and reagent module are then operated to dispense 200 μL of COOH bead Wash 2 into the reagent vessel (e.g., 85% ethanol).

COOH bead Wash 2 is completed using the same buffer solution as COOH bead Wash 1 in order to flush out contaminants in the dispensing system from previous steps. This step may be repeated more than once if needed to ensure purity or further reduce the likelihood of contaminants appearing in the solution. Alternatively, if contaminants are not a concern, or if the dispense system includes independent channels which avoids potential contamination, then this step may be omitted.

The pneumatic module is then operated to transfer the contents of the reagent vessel to the secondary reaction vessel.

The contents of the secondary reaction vessel are then allowed to incubate for 30 seconds at room temperature.

The pneumatic module is then operated to transfer the liquid contents of the secondary reaction vessel into the waste vessel 240, while the magnets (still engaged) hold the beads in place.

The magnets 710 are then disengaged from the primary reaction vessel.

The motion module and reagent module are then operated to dispense 30 μL of COOH Elution buffer (e.g., 1× TE buffer pH8) into the reagent vessel.

The pneumatic module is then operated to transfer the elution buffer to the secondary reaction vessel.

The orbital shaker is operated for 10 seconds at 1100 rpm to promote mixing of the contents of the secondary reaction vessel to release DNA from the COOH beads into the Elution buffer.

The motion module and magnetic module are operated to engage the magnets 710 and hold the magnetic beads to one or more sides of the secondary reaction vessel. A settling time of approximately 1 minute may be allowed before the next step.

The pneumatic module is then operated to draw the liquid contents of the secondary reaction vessel (the eluate) up to the air permeable membrane to fill the metering channel.

The motion module and reagent module are then operated to dispense neutral buffer (e.g., 199 μL 1×TE buffer pH8) into the QC buffer vessel 265, as well as the three QC reference buffer vessels 275 (e.g., 200 μL 1×TE buffer pH8).

The pneumatic module is then operated to draw the buffer solution from the QC buffer vessel through the metering channel and into the QC vessel 265 along with an aliquot of the eluate from the metering channel (e.g., 1 μL) until air fills the channels. The pneumatic module is also operated to transfer the buffer solution from the QC reference buffer vessels 275 to the corresponding QC reference vessels 271.

Each of the QC vessel 265 and QC reference buffer vessels 275 contains a similar quantity (e.g., 0.2 μg) of a dried DNA dye and the QC reference buffer vessels 275 each contain a different reference quantity of gDNA for comparison (e.g., 4 ng gDNA, 60 ng gDNA, 500 ng gDNA, respectively).

The pneumatic module is then operated to transfer the remainder of the eluate from the secondary reaction vessel to the output vessel 250.

The orbital shaker is operated for 10 seconds at 1100 rpm to promote mixing of the contents of the QC vessel 261 and QC reference vessels 271, and resuspension of the preloaded dye and reference nucleic acid (NA) in the QC reference vessels.

The motion module is operated to move the optics module to a position corresponding to the sample cartridge and QC vessel containing the aliquot of eluate with buffer solution, and the optics module is operated to perform a fluorescence measurement on the contents of the QC vessel.

The motion module is further operated to move the optics module to three positions corresponding to three QC reference vessels, and the optics module is operated to perform a fluorescence measurement on the contents of each of the QC reference vessels.

Data from the fluorescence measurements is then used to determine the DNA concentration of the final eluate by fitting a curve between the measurements from the three reference vessels with known concentrations, and interpolating (or extrapolating) to determine the concentration of the eluate). The resulting data may be transmitted to a LIMS system for recording and/or capturing.

Finally the pneumatic module may be lowered and disengaged from the sample cartridge. This may comprise the end of the workflow program, according to some embodiments.

The sample cartridge 200 may then be removed from the instrument 100 by a user. The temporary lid 259 may be removed from the output vessel 250, and the main lid closed to seal the output vessel 250.

Then output vessel 250 may then be removed from the output vessel seat 254, and the rest of the sample cartridge 200 discarded.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A chemical processing instrument configured to receive one or more sample cartridges each containing a fluid sample for processing, each sample cartridge defining:
a primary reaction vessel configured to accommodate a fluid sample for processing and configured to receive a lid for closing an open top of the primary reaction vessel;
a reagent vessel configured to receive one or more fluid reagents via an open top of the reagent vessel, the reagent vessel being connected to the primary reaction vessel via a primary reagent channel with a reagent valve disposed in the reagent channel to control fluid flow through the primary reagent channel; and
a pneumatic port in fluid communication with the primary reaction vessel;
the chemical processing instrument comprising:
a reagent dispenser configured to dispense one or more fluid reagents into the reagent vessel via the open top of the reagent vessel; and
a pneumatic module configured to connect to the primary pneumatic port of the primary reaction vessel and selectively adjust a pressure within the primary reaction vessel when the lid is closed to draw fluid from the reagent vessel through the primary reagent channel into the primary reaction vessel.

2. The instrument of claim 1, wherein the reagent dispenser comprises a reagent cartridge comprising a plurality of reagent reservoirs, each accommodating a volume of a reagent in fluid communication with a dispensing pump via one or more valves, and
wherein the instrument is configured to operate the one or more valves to connect a selected one of the reagent reservoirs to the pump, and operate the pump to dispense a selected volume of reagent from the selected reagent reservoir into the reagent vessel of the sample cartridge.

3. The instrument of claim 2, wherein the reagent cartridge is removable from the dispensing pump and instrument to facilitate refilling or replacement of the reagent reservoirs.

4. The instrument of any one of claims 1 to 3, further comprising a heater mounted to a carriage assembly configured to selectively move the heater relatively close to the primary reaction vessel of the sample cartridge to heat a fluid sample in the primary reaction vessel and move the heater relatively further away from the sample cartridge when heating is not required.

5. The instrument of claim 4, wherein the heater comprises a radiator configured to pass through slots or apertures in the sample cartridge to partially surround the primary reaction vessel.

6. The instrument of claim 4 or 5, further comprising a magnet mounted on the carriage and configured to be moved relatively closer to the primary reaction vessel of the sample cartridge to apply a magnetic field to the fluid sample in the primary reaction vessel and to be moved relatively further away from the sample cartridge when the magnetic field is not required.

7. The instrument of claim 6, wherein the carriage is configured to allow independent movement of the heater relative to the magnet to allow heating of the fluid sample without applying the magnetic field.

8. The instrument of claim 7, wherein the heater is mounted to the carriage via sprung rods to bias the heater away from the carriage in a disengaged position, as well as a first heater engagement position, and allow the heater to move relatively closer to the carriage and magnet when the carriage is moved to a magnet engagement position.

9. The instrument of any one of claims 1 to 8, wherein the pneumatic module is configured to connect to a plurality of different pneumatic ports on each sample cartridge and apply a selected pressure level to each pneumatic port independently at selected times.

10. The instrument of any one of claims 1 to 9, further comprising an optics module configured to detect light transmitted from the fluid sample to determine a property of the fluid sample.

11. A chemical processing system comprising:
one or more sample cartridges, each sample cartridge defining:
a primary reaction vessel configured to accommodate a fluid sample for processing and configured to receive a lid for closing an open top of the primary reaction vessel;
a reagent vessel configured to receive one or more fluid reagents via an open top of the reagent vessel, the reagent vessel being connected to the primary reaction vessel via a primary reagent channel with a reagent valve disposed in the reagent channel to control fluid flow through the primary reagent channel; and
a pneumatic port in fluid communication with the primary reaction vessel; and
the chemical processing instrument of any one of claims 1 to 10.

12. The system of claim 11, wherein the sample cartridge further comprises a primary pneumatic channel extending between the primary pneumatic port and the primary reaction vessel,
wherein an opening of the primary pneumatic channel into the primary reaction vessel is located part way up a sidewall of the primary reaction vessel.

13. The system of claim 12, wherein the opening of the primary pneumatic port into the primary reaction vessel is located nearer to the top of the primary reaction vessel than the bottom of the primary reaction vessel.

14. The system of any one of claims 11 to 13, wherein an opening of the primary reagent channel into the primary reaction vessel is located part way up a sidewall of the primary reaction vessel.

15. The system of claim 13, wherein the opening of the primary reagent channel into the primary reaction vessel is located nearer to the top of the primary reaction vessel than to the bottom of the primary reaction vessel.

16. The system of any one of claims 11 to 15, wherein the sample cartridge further comprises a removable output vessel configured to receive a final output fluid from the primary reaction vessel via a final output channel.

17. The system of claim 16, wherein the sample cartridge further comprises an output vessel pneumatic port in communication with the output vessel via an output vessel pneumatic channel and configured to be connected to a pneumatic module to selectively adjust the pressure in the output vessel to draw the final output fluid into the output vessel from the primary reaction vessel via the final output channel, and
wherein the pneumatic module is further configured to connect to the output vessel pneumatic port and selectively adjust the pressure in the output vessel to draw the final output fluid into the output vessel from the primary reaction vessel via the final output channel.

18. The system of claim 17, wherein the sample cartridge further comprises a temporary lid configured to close the output vessel during processing, the temporary lid being connected to and defining openings for the final output channel and output vessel pneumatic channel into the output vessel.

19. The system of any one of claims 16 to 18, wherein the sample cartridge further comprises:
a quality control vessel configured to receive an aliquot of the output fluid for quality control analysis;
a quality control channel extending between the quality control vessel and a quality control junction with the final output channel; and
a quality control pneumatic port in fluid communication with the quality control vessel and configured to be connected to a pneumatic module to selectively adjust a pressure within the quality control vessel to draw the aliquot of final output fluid from the final output channel through the quality control channel and into the quality control vessel, and
wherein the pneumatic module is further configured to connect to the quality control pneumatic port and selectively adjust a pressure within the quality control vessel to draw the aliquot of final output fluid from the final output channel through the quality control channel and into the quality control vessel.

20. The system of claim 19, wherein the quality control vessel is preloaded with a dye to be mixed with the aliquot of final output fluid for quality control analysis.

21. The system of claim 19 or 20, wherein the sample cartridge further comprises:
a buffer solution vessel configured to receive a buffer solution through an open top of the buffer solution vessel for mixing with the final output fluid for quality control analysis;
a buffer channel extending between the buffer solution channel and a buffer junction with the final output channel between the quality control junction and the primary reaction vessel; and
a buffer channel valve disposed in the buffer channel to control flow of the buffer solution through the buffer channel, and
wherein the reagent module is configured to dispense buffer solution into the buffer solution vessel.

22. The system of any one of claims 19 to 21, wherein the sample cartridge further comprises:
an intermediate outlet from the final output channel between the quality control junction and the output vessel;
a sealed chamber into which the intermediate outlet opens;
an air-permeable liquid barrier membrane covering the outlet; and
an intermediate outlet pneumatic port in fluid communication with the sealed chamber and configured to be connected to a pneumatic module to selectively adjust a pressure within the sealed chamber to draw air through the air-permeable membrane from the final output channel, and
wherein the pneumatic module is further configured to connect to the intermediate outlet pneumatic port and selectively adjust a pressure within the sealed chamber to draw air through the air-permeable membrane from the final output channel.

23. The system of any one of claims 11 to 22, wherein the sample cartridge further comprises a sealed waste vessel configured to receive waste fluid from the primary reaction vessel via a waste channel; and
a waste pneumatic port in fluid communication with the waste vessel and configured to be connected to a pneumatic module to selectively adjust a pressure within the waste vessel to draw fluid from the primary reaction vessel through the waste channel and into the waste vessel, and
wherein the pneumatic module is further configured to connect to the waste pneumatic port and selectively adjust a pressure within the waste vessel to draw fluid from the primary reaction vessel through the waste channel and into the waste vessel.

24. The system of any one of claims 11 to 23, wherein the sample cartridge further comprises a secondary reaction vessel configured to receive a primary output fluid from the primary reaction vessel via a primary output channel fluidly connecting the primary reaction vessel to the secondary reaction vessel, and configured to receive one or more fluid reagents from the reagent vessel via a secondary reagent channel fluidly connecting the reagent vessel to the secondary reaction vessel;
a primary outlet valve disposed in the primary outlet channel to control flow through the primary outlet channel; and
a secondary reagent valve disposed in the secondary reagent channel to control flow through the secondary reagent channel.

25. The system of claim 24, wherein the secondary reaction vessel is sealed,
wherein the sample cartridge further comprises a secondary pneumatic port in fluid communication with the secondary reaction vessel and configured to be connected to a pneumatic module to selectively adjust a pressure in the secondary reaction vessel to draw fluid from the primary outlet channel or secondary reagent channel into the secondary reaction vessel, and
wherein the pneumatic module is further configured to connect to the secondary pneumatic port and selectively adjust a pressure in the secondary reaction vessel to draw fluid from the primary outlet channel or secondary reagent channel into the secondary reaction vessel.

26. The system of claim 25, wherein the sample cartridge further comprises a secondary pneumatic channel extending between the secondary pneumatic port and the secondary reaction vessel,
wherein an opening of the secondary pneumatic channel into the secondary reaction vessel is located part way up a sidewall of the secondary reaction vessel, nearer to a top of the secondary reaction vessel than a bottom of the secondary reaction vessel.

27. The system of any one of claims 24 to 26, wherein an inlet or inlets of the primary output channel and secondary reagent channel open into the secondary reaction vessel part way up a sidewall of the secondary reaction vessel, nearer to a top of the secondary reaction vessel than a bottom of the secondary reaction vessel.

28. The system of any one of claims 19 to 27 when directly or indirectly dependent on claims 10 and 19, wherein the optics module is configured to measure a property of an aliquot of output fluid accommodated in the quality control vessel.

29. The system of any one of claims 11 to 28, wherein the instrument is configured to receive a plurality of ones of the sample cartridge.

30. The system of claim 29, wherein the pneumatic module is configured to connect to all of the pneumatic ports of the plurality of sample cartridges and selectively apply pressure to selected ones of the pneumatic ports at selected times.

31. The system of claim 29 or 30, wherein the reagent module is configured to dispense selected volumes of reagents into each of the plurality of sample cartridges at selected times.

32. The system of claim 31, further comprising a mechanism and actuator configured to move the reagent module to various positions within the instrument, each position corresponding to a respective one of the plurality of sample cartridges, to allow the reagent module to dispense one or more reagents into each respective sample cartridge.

33. A method of operation of the chemical processing system of any one of claims 11 to 32 accommodating one or more of the sample cartridges, each containing a fluid sample in the primary reaction vessel, the method comprising:
connecting the pneumatic module to the primary pneumatic port of the or each sample cartridge;
operating the reagent module to dispense one or more reagents into the reagent vessel of the or each sample cartridge;
operating the pneumatic module to reduce the pressure in the primary reaction vessel of the or each sample cartridge to draw the fluid contents of the corresponding reagent vessel through the or each primary reagent channel and into the primary reaction vessel of the or each sample cartridge.

34. The method of claim 33, further comprising operating a shaker of the instrument to facilitate mixing of fluids in the primary reaction vessel of the or each sample cartridge.

35. The method of claim 33 or 34, further comprising operating a heater of the instrument to heat the primary reaction vessel of the or each sample cartridge to a predetermined temperature for a predetermined period of time.

36. The method of any one of claims 33 to 35, wherein reagents in the primary reaction vessel of the or each sample cartridge comprise functionalised magnetic beads, and the method further comprises operating or moving magnets to hold the magnetic beads in a selected position within the primary reaction vessel.

37. The method of any one of claims 33 to 35, when directly or indirectly dependent on claim 23, further comprising connecting the pneumatic module to the waste pneumatic port of the or each sample cartridge and reducing a pressure within the waste vessel to draw fluid from the primary reaction vessel through the waste channel and into the waste vessel.

38. The method of any one of claims 33 to 36, when directly or indirectly dependent on claim 25, further comprising connecting the pneumatic module to the secondary pneumatic port of the or each sample cartridge and reducing a pressure in the secondary reaction vessel to draw fluid from the primary outlet channel into the secondary reaction vessel.

39. The method of any one of claims 33 to 37, when directly or indirectly dependent on claim 25, further comprising connecting the pneumatic module to the secondary pneumatic port of the or each sample cartridge and reducing a pressure in the secondary reaction vessel to draw fluid from the secondary reagent channel into the secondary reaction vessel.

40. The method of claim 39, further comprising operating a shaker of the instrument to facilitate mixing of fluids in the secondary reaction vessel of the or each sample cartridge.

41. The method of claim 39 or 40, further comprising operating a heater of the instrument to heat the secondary reaction vessel of the or each sample cartridge to a predetermined temperature for a predetermined period of time.

42. The method of any one of claims 39 to 41, wherein reagents in the secondary reaction vessel of the or each sample cartridge comprise functionalised magnetic beads, and the method further comprises operating or moving magnets to hold the magnetic beads in a selected position within the secondary reaction vessel.

43. The method of any one of claims 39 to 41, when directly or indirectly dependent on claim 23, further comprising connecting the pneumatic module to the waste pneumatic port of the or each sample cartridge and reducing a pressure within the waste vessel to draw fluid from the secondary reaction vessel and into the waste vessel via a secondary waste channel extending between the secondary reaction vessel and the waste vessel.

44. The method of any one of claims 33 to 43, when directly or indirectly dependent on claim 17, further comprising connecting the pneumatic module to the output vessel pneumatic port of the or each sample cartridge and reducing the pressure in the output vessel to draw processed fluid into the output vessel from the primary reaction vessel via the final output channel.

45. The method of claim 44, wherein the processed fluid drawn from the primary reaction vessel of the or each sample cartridge is drawn into the secondary reaction vessel and processed with further reagents prior to being drawn into the final output vessel via the final output channel.

46. The method of claim 44 or 45, when directly or indirectly dependent on claim 20, further comprising connecting the pneumatic module to the quality control pneumatic port of the or each sample cartridge and, prior to reducing the pressure in the output vessel to draw processed fluid into the output vessel, reducing a pressure within the quality control vessel to draw an aliquot of processed fluid from the final output channel through the quality control channel and into the quality control vessel.

47. The method of claim 46, when directly or indirectly dependent on claim 21, further comprising:
operating the reagent module to dispense buffer solution into the buffer solution vessel of the or each sample cartridge; and
opening the buffer channel valve of the or each sample cartridge,
prior to reducing the pressure in the quality control vessel of the or each sample cartridge to draw buffer solution from the buffer solution vessel via the buffer channel, and via the final output channel and quality control channel, along with the aliquot of processed fluid, into the quality control vessel.

48. The method of claim 47, when directly or indirectly dependent on claim 22, further comprising connecting the pneumatic module to the intermediate outlet pneumatic port of the or each sample cartridge and, prior to reducing the pressure in the quality control vessel, reducing a pressure within the outlet chamber of the or each sample cartridge to draw air through the air-permeable membrane from the final output channel.

49. The method of any one of claims 46 to 48, when directly or indirectly dependent on claim 28, further comprising operating the optics module to measure a property of the aliquot of processed fluid accommodated in the quality control vessel of the or each sample cartridge.

50. The method of any one of claims 33 to 49, when directly or indirectly dependent on claim 32, wherein operating the reagent module to dispense reagents into the reagent vessel further comprises operating the mechanism and actuator to move the reagent module to various positions within the instrument, each position corresponding to a respective one of the one or more of sample cartridges.

51. A computer-readable storage medium storing instructions that, when executed by a computer, cause the computer to perform the method of any one of claims 33 to 50.

52. A method of use of the system of any one of claims 11 to 32, the method comprising:
depositing a fluid sample in the primary reaction vessel of the or each sample cartridge;
applying a lid to seal closed the open top of the primary reaction vessel of the or each sample cartridge;
inserting the or each sample cartridge into a corresponding cartridge slot in the instrument; and
operating the instrument to process the fluid sample.

53. The method of claim 52, further comprising removing the or each sample cartridge from the instrument once the fluid sample has been processed.

54. The method of claim 53, when dependent on claim 16, further comprising removing the output vessel containing the processed fluid sample from the sample cartridge.

55. The method of claim 54, when dependent on claim 18, further comprising removing the temporary lid from the output vessel.

56. A sample cartridge for use with a fluid analysis instrument, the cartridge comprising:
a sample vessel configured to accommodate a fluid sample for analysis;
a buffer solution vessel configured to accommodate a buffer solution;
an analysis vessel configured to accommodate a mixed fluid comprising an aliquot of the fluid sample mixed with at least some of the buffer solution for analysis;
a sample channel extending between the sample vessel and a first junction;
a sample channel valve disposed in the sample channel to control flow of the sample through the sample channel;
a buffer channel extending between the buffer solution vessel and the first junction;
a buffer channel valve disposed in the buffer channel to control flow of the buffer solution through the buffer channel;
a metering channel in fluid communication with the buffer channel and sample channel, the metering channel extending between the first junction and a second junction;
an analysis vessel channel in fluid communication with the metering channel and extending between the second junction and the analysis vessel; and
an analysis vessel pneumatic port in communication with the analysis vessel and configured to be connected to a pneumatic module to selectively adjust a pressure in the analysis vessel to draw fluid into the analysis vessel via the analysis vessel channel.

57. A fluid analysis instrument configured to receive a sample cartridge according to claim 56, the instrument comprising:
a pneumatic module configured to connect to the analysis vessel pneumatic port and to selectively adjust a pressure in the analysis vessel to draw fluid into the analysis vessel via the analysis vessel channel; and
an analysis module configured to measure a property of a fluid in the analysis vessel.

58. A fluid analysis system comprising:
the instrument of claim 57; and
one or more of the sample cartridge of claim 56.

59. A method of operation of the fluid analysis system of claim 58 containing a fluid sample in the sample vessel, the method comprising:
operating the pneumatic module to draw sample fluid from the sample vessel through the sample channel and into the metering channel up to the second junction without the sample fluid progressing into the analysis vessel channel; and
subsequently operating the pneumatic module to draw fluid from the buffer solution vessel through the buffer channel, metering channel and analysis channel into the analysis vessel along with an aliquot of the sample fluid from the metering channel.

60. The method of claim 59, further comprising:
operating the pneumatic module to reduce pressure in the analysis vessel during a predetermined period of time to draw sample fluid from the sample vessel through the sample channel and into the metering channel up to the second junction without the sample fluid progressing into the analysis vessel channel; and
operating the pneumatic module to reduce pressure in the analysis vessel after the predetermined period to draw fluid from the buffer solution vessel through the buffer channel, metering channel and analysis channel into the analysis vessel along with an aliquot of the sample fluid from the metering channel.

61. A computer-readable storage medium storing instructions that, when executed by a computer, cause the computer to perform the method of claim 60.

62. A method of use of the system of claim 59, the method comprising:
depositing a fluid sample in the sample vessel of the or each sample cartridge;
inserting the or each sample cartridge into a corresponding cartridge slot in the instrument; and
operating the instrument to analyse the fluid sample.

63. The method of claim 92, further comprising removing the or each sample cartridge from the instrument once the fluid sample has been processed.

64. A chemical processing instrument configured to receive a sample cartridge containing a volume of at least 0.2 mL of a fluid sample, wherein the instrument is configured to be operated according to instructions stored on a computer-readable storage medium to perform any two or more of the following processing steps on the sample:
processing the sample while maintaining the sample in isolation to avoid contamination of the instrument or cross-contamination with other samples;
selecting nucleic acid using specific chemistries, incubation conditions, bead selection and elution parameters;
selecting a desired range of nucleic acid sizes of a processed fluid product and discarding unwanted materials falling outside of the desired range;
increasing a concentration of a selected nucleic acid product; and
quantitating an aliquot of the processed fluid product, mixing with specific fluorochromes for the selected nucleic acid, and quantifying a property of the product, such as relative to a standard reference curve.

65. The system of any one of claims 11 to 32, wherein the instrument is configured to be operated according to instructions stored on a computer-readable storage medium to perform any two or more of the following processing steps on the sample:
processing the sample while maintaining the sample in isolation to avoid contamination of the instrument or cross-contamination with other samples;
selecting nucleic acid using specific chemistries, incubation conditions, bead selection and elution parameters;
selecting a desired range of nucleic acid sizes of a processed fluid product and discarding unwanted materials falling outside of the desired range;
increasing a concentration of a selected nucleic acid product; and
quantitating an aliquot of the processed fluid product, mixing with specific fluorochromes for the selected nucleic acid, and quantifying a property of the product, such as relative to a standard reference curve.

66. The system of claim 65, further comprising the computer-readable storage medium, which further includes operating instructions to operate the instrument to achieve the extraction, isolation, enrichment, concentration or quantification of nucleic acids from the sample, or the preparation of nucleic acid for manipulation, analysis, amplification, sequencing, PCR library preparation or insertion into a vector.

67. The instrument of claim 66, wherein the nucleic acids include one or more of the following classes of nucleic acid: naturally occurring, non-naturally occurring, DNA, genomic DNA, TCR DNA, cDNA, cfDNA, rearranged immunoglobulin, RNA, mRNA, primary RNA transcript, transfer RNA, microRNA, glycol nucleic acid, threose nucleic acid, locked nucleic acid and peptide nucleic acid.

68. The method of any one of claims 33 to 50, further comprising any two or more of the following processing steps on the sample:
processing the sample while maintaining the sample in isolation to avoid contamination of the instrument or cross-contamination with other samples;
selecting nucleic acid using specific chemistries, incubation conditions, bead selection and elution parameters;
selecting a desired range of nucleic acid sizes of a processed fluid product and discarding unwanted materials falling outside of the desired range;
increasing a concentration of a selected nucleic acid product; and
quantitating an aliquot of the processed fluid product, mixing with specific fluorochromes for the selected nucleic acid, and quantifying a property of the product, such as relative to a standard reference curve.

69. The method of any one of claims 33 to 50 or 68, further comprising operating the instrument to achieve the extraction, isolation, enrichment, concentration or quantification of nucleic acids from the sample, or the preparation of nucleic acid for manipulation, analysis, amplification, sequencing, PCR library preparation or insertion into a vector.

70. The method of claim 69, comprising operating the instrument to extract nucleic acid from the sample.

71. The method of claim 70, further comprising operating the instrument to increase the concentration of the nucleic acid extracted from the sample.

72. The method of claim 70 or 71, further comprising quantifying a property of the nucleic acid extracted from the sample.

73. The method of any one of claims 69 to 72, wherein the nucleic acids include one or more of the following classes of nucleic acid: naturally occurring, non-naturally occurring, DNA, genomic DNA, TCR DNA, cDNA, cfDNA, rearranged immunoglobulin, RNA, mRNA, primary RNA transcript, transfer RNA, microRNA, glycol nucleic acid, threose nucleic acid, locked nucleic acid and peptide nucleic acid.

74. An instrument comprising one or more fixed sample cartridge sockets, each configured to receive a sample cartridge containing a fluid sample in a reaction vessel for processing, the instrument further comprising:
a heater mounted to a carriage assembly configured to selectively move the heater relatively close to the reaction vessel of the sample cartridge to heat a fluid sample in the reaction vessel and move the heater relatively further away from the sample cartridge when heating is not required.

75. The instrument of claim 74, wherein the heater comprises a radiator configured to pass through slots or apertures in the sample cartridge to partially surround the reaction vessel.

76. The instrument of claim 74 or 75, further comprising a magnet mounted on the carriage and configured to be moved relatively closer to the reaction vessel of the sample cartridge to apply a magnetic field to the fluid sample in the reaction vessel and to be moved relatively further away from the sample cartridge when the magnetic field is not required.
